(19) United States
(12) Patent Application Publication
(10) Pub. No.: US 2010/0305873 A1
(43) Pub. Date: Dec. 2, 2010

(54) Method and Apparatus for Spectral Deconvolution of Detector Spectra

(76) Inventors: Glenn Sjoden, Gainesville, FL (US); Eric LaVigne, Gainsville, FL (US); James Baciak, Gainesville, FL (US); Rebecca Detwiler, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/677,987

(22) PCT Filed: Sep. 12, 2008
(86) PCT No.: PCT/US08/76254

§ 371 Date: Aug. 13, 2010

Related U.S. Application Data
(60) Provisional application No. 60/971,770, filed on Sep. 12, 2007.

(51) Int. Cl. G06F 19/00; G01N 21/00

(52) U.S. Cl. 702/30; 378/88; 250/370.01; 250/370.11

(57) ABSTRACT

Embodiments of the invention pertain to a method and apparatus for spectral deconvolution of detector spectra. In a specific embodiment, the method can be applied to sodium iodide scintillation detector spectra. An adaptive chi-processed (ACHIP) denoising technique can be used to remove the results of stochastic noise from low-count detector spectra. Embodiments of the ACHIP denoising algorithm can be used as a stand alone tool for rapid processing of one dimensional data with a Poisson noise component. In a specific embodiment, the denoising technique can be combined with the spectral deconvolution method. Embodiments of the denoising technique and embodiments of the deconvolution method can be applied to any detector material that provides a radiation spectrum. Specific embodiments can incorporate one or more of the following for spectral deconvolution: denoising, background subtraction, detector response function generation, and subtraction of detector response functions. Photopeaks can be rapidly identified, starting at the high-energy end of the spectrum. The detector response functions can be estimated for photopeaks with a combination of Monte Carlo simulations and simple transformations.

### CROSS-REFERENCE TO RELATED APPLICATION

The present application claims the benefit of U.S. Provisional Application Ser. No. 60/971,770, filed Sep. 12, 2007, which is hereby incorporated by reference herein in its entirety, including any figures, tables, or drawings.

### BACKGROUND OF INVENTION

Roughly half of all sea-borne containers entering the U.S. in May 2006 were screened for radiological weapons and materials [1]. Portal monitoring is an enormous task, requiring accurate nuclide identification. Costs per portal monitoring system should preferably be low, in order to allow inspections at many, if not all, entry points to the United States. Further analysis of results should preferably be fast enough to not impede traffic flow.

There is a growing demand for low cost, portable, high resolution gamma-ray detector systems that can operate at room temperature. Currently available sodium iodide (NaI) scintillators meet most of these requirements, but do not provide sufficient energy resolution. There have been many approaches investigated for post-processing of NaI scintillator output for synthetically enhanced resolution.

Spectral deconvolution for NaI(T1) scintillation detectors is a fifty-year-old problem. While NaI detectors are rugged, portable, relatively inexpensive, and have high detection efficiencies, their poor energy resolution complicates photopeak identification. Gamma detector response and analysis software (GADRAS) [2, 3] is currently the industry leader for nuclide identification, and a variety of other methods [4, 5] have been developed for resolution enhancement in support of photopeak identification.

GADRAS matches the detector with a parameterized template, then uses that model to construct a voluminous library of nuclide detector response functions. GADRAS then tries to represent the measured spectrum as a linear combination of nuclides and shielding effects from its library.

The maximum entropy method enhances the resolution of a detector spectrum by maximizing Equation 2-1, in which S is a measure of entropy, as defined in Equation 2-2, and λ is the smoothing/regularizing term. The functions ƒ and m represent the enhanced and measured detector responses, respectively, while ƒⱼ, and mⱼ represented the values of those functions at channel j in a detector with N channels.

$$\begin{matrix}L ( f , λ ) = λ S ( f , m ) - \frac{1}{2} {χ}^{2} & ( 2 \text{-} 1 ) \\ S ( f , m ) = {\sum }_{j = 1}^{N} {f}_{j} - {m}_{j} - {f}_{j} log \frac{{f}_{j}}{{m}_{j}} & ( 2 \text{-} 2 )\end{matrix}$$

The maximum entropy, as well as the maximum likelihood method that is described next, involve iterative convergence, and therefore require significant computation time [5].

The maximum likelihood method follows the iteration rule shown in Equation 2-3. I is an estimate of the incident radiation spectrum, and m is the measured absorption spectrum. R is a response function matrix, which maps incident source energies to measured responses in channels.

$${I}_{new} ( j ) = {I}_{old} ( j ) {\sum }_{i = 1}^{M} \frac{m ( i ) {R}_{ij}}{{\sum }_{j = 1}^{N} {I}_{old} ( j ) {R}_{ij}} \qquad ( 2 \text{-} 3 )$$

While the maximum likelihood method does an excellent job at identifying and characterizing photopeaks, this method is also very computationally intensive [5].

Spectral data denoising is essential to enhance radiation counting pulse height data collected using a detector and multi-channel analyzer system. Random variation in counts per channel, leading to jagged edges in spectral data, can be readily filtered by weighted averaging or polynomial fitting. Equation 3-1, for example, implements a form of weighted averaging which is commonly used for gamma detector spectra [9]. F(x) represents the spectrum after smoothing, while f(x) represents the original measured spectrum.

$$\begin{matrix}F ( x ) = \frac{3}{8} f ( x ) + \frac{1}{4} f ( x - 1 ) + \frac{1}{4} f ( x + 1 ) + \\ \frac{1}{16} f ( x - 2 ) + \frac{1}{16} f ( x + 2 )\end{matrix} \qquad ( 3 \text{-} 1 )$$

The weighted averaging process, however, may broaden or remove real features of interest from the spectrum. FIG. 5A shows an MCNP-generated detector response function with several real, sharp features, as well as noticeable stochastic noise. The Monte Carlo generated detector response function shown in FIG. 5A for a 350 keV gamma source and a sodium iodide scintillator with 1.2×10⁹ histories (plotted as counts vs deposited γ-ray energy has pulse height tallies that are sharper than experimental spectra because electronic broadening is not simulated. FIG. 5B shows the same detector response function after applying the weighted averaging technique for smoothing. The two x-ray escape peaks around 320 keV are so broadened that they are no longer distinguishable after smoothing. The K-shell edge around 40 keV, while still visible, is also broadened and reduced in prominence.

Accordingly, there is still a need for a low cost, portable, high resolution gamma-ray detector that can operate at room temperature, and techniques for spectral deconvolution that can assist to achieve the same.

### BRIEF SUMMARY

Embodiments of the invention pertain to a method and apparatus for spectral deconvolution of detector spectra. In a specific embodiment, the method can be applied to sodium iodide scintillation detector spectra. An adaptive chi-processed (ACHIP) denoising technique can be used to remove the results of stochastic noise from low-count detector spectra. Embodiments of the ACHIP denoising algorithm can be used as a stand alone tool for rapid processing of one dimensional data with a Poisson noise component. In a specific embodiment, the denoising technique can be combined with the spectral deconvolution method. Embodiments of the denoising technique and embodiments of the deconvolution method can be applied to any detector material that provides a radiation spectrum. Specific embodiments can incorporate one or more of the following for spectral deconvolution: denoising, background subtraction, detector response function generation, and subtraction of detector response functions. Photopeaks can be rapidly identified, starting at the high-energy end of the spectrum. The detector response functions can be estimated for photopeaks with a combination of Monte Carlo simulations and simple transformations.

Embodiments of the invention relate to a method and apparatus that can incorporate an advanced synthetically enhanced detector resolution algorithm (ASEDRA). The algorithm can utilize a method for identifying photopeaks, based on recognizing local maxima in a detector spectrum. For each identified photopeak, a corresponding detector response function is subtracted from the detector spectrum, revealing previously hidden photopeaks so that highly overlapping photopeaks can be separated. Despite its simplicity, embodiments of the subject method incorporating ASEDRA have demonstrated a capability for deconvolving intricate detector spectra.

The advanced synthetically enhanced detector resolution algorithm (ASEDRA) can use a detector model that is based on Monte Carlo N-particle transport (MCNP) [6] simulation, rather than on a parameterized template as in GADRAS. ASEDRA can also analyze detector spectra, without any knowledge of common nuclides, to identify and characterize photopeaks. One advantage of ASEDRA's approach, which relies on local analysis rather than global analysis, is that interference in one part of the spectrum should not prevent ASEDRA from correctly identifying photopeaks in another part of the spectrum. After ASEDRA identifies the photopeaks in a detector spectrum, another tool can be used to correlate those photopeaks with specific nuclides.

Embodiments of the advanced synthetically enhanced detector resolution algorithm (ASEDRA) can analyze detector spectra based on the actual physics and a simple heuristic algorithm, without using any information about nuclides of interest. Additionally, embodiments of ASEDRA can provide very fast spectral post-processing, suitable for real-time applications.

Time constraints often prevent us from taking thorough radiation measurements. In a portal screening system, short count times are necessary to avoid delaying traffic. Developing a suite of detector response functions, using a Monte Carlo based radiation simulator such as MCNP, may take days or weeks. When count times in such Poisson processes are too low, stochastic noise becomes problematic. Embodiments of the subject invention relate to an algorithm that addresses such noise reduction needs while minimizing the degradation of sharp features of interest in the spectrum.

Filtering white noise from spectral data, while preserving sharp peaks, is useful for visualization of noisy spectra, or as a preprocessing step for spectral analysis algorithms. Embodiments of the subject invention relate to smoothing and denoising techniques for Monte Carlo simulated and actual radiation detector spectral data.

Embodiments of the subject invention can distinguish noisy regions, in which stochastic fluctuation dominates and smoothing is essential, from regions with sharp, statistically significant features, in which smoothing attempts may be destructive. This determination is based on chi-squared analysis, a common technique from statistics.

Embodiments of the invention can generate response functions. The accurate generation of monoenergetic response functions is extremely useful for spectral deconvolution. ASEDRA's spectral deconvolution algorithm can start at the high energy end of a detector spectrum, so that it finds photopeaks before other components of the detector response function, such as Compton edges. As each photopeak is found, ASEDRA strips away the entire detector response function associated with each photopeak, so that a Compton edge is never found and mistakenly identified as a photopeak. In addition to its usefulness within ASEDRA, detector response generation is useful for detector calibration or for providing synthetic test cases for spectral analysis.

Detector response function generation provides a very precise method for calibrating detectors. A synthetically generated spectrum, based on an estimate of the calibration functions (both energy and resolution), can be overlaid on a measured calibration spectrum for comparison. Even slight differences between the two spectra are easily visible and suggest improvements to the calibration functions. This process can be repeated until a close match between synthetic and measured spectra indicates that calibration is finished.

Generating synthetic detector spectra is much faster and easier than measuring spectra in the lab. Additionally, the results are more controllable and repeatable. Such synthetic spectra provide useful test cases for a deconvolution algorithm.

### BRIEF DESCRIPTION OF DRAWINGS

FIGS. 1A and 1B show Ba-133 Test Spectra. FIG. 1A shows the original spectrum, and FIG. 1B shows a curve that indicates the original, denoised spectrum using the robust adaptive chi-square technique. The sharp peaks indicate unique photopeaks extracted from the spectrum by ASEDRA. Doublets are extracted from the spectrum with no prior knowledge of nuclides or photopeak energies.

FIGS. 2A-2B show WGPu gamma spectra from a 1 minute count of PuBe Source. FIG. 2A is the original NaI(T1) spectrum, and FIG. 2B shows a curve that indicates the denoised original spectrum. using the robust adaptive chi-square technique. The sharp peaks indicate unique photopeaks extracted from the spectrum by ASEDRA, rendered in 28 seconds of post processing.

FIGS. 3A-3B show GPu gamma spectra from a 1 minute count of PuBe Source. FIG. 3A shows the ASEDRA denoised and processed spectrum, and FIG. 3B shows the germanium detector (denoised) spectrum from the same source. The peaks that appear to be aliased are labeled alphabetically.

FIGS. 4A-4B show a WGPu gamma spectra from a 10 minute count of PuBe Source. FIG. 4A shows the ASEDRA (denoised by ACHIP) processed spectrum, and FIG. 4B shows the germanium (denoised by ACHIP) detector spectrum from the same source. Both detectors were carefully calibrated with a series of check sources, and placed in the same geometric configuration relative to the PuBe Source. The peaks that correlate between the two spectra are labeled alphabetically.

FIGS. 5A-5B show an MCNP-generated detector response function for a 350 keV gamma source and a NaI scintillator (FIG. 5A) with 1.2×10⁹ histories (plotted as counts vs deposited γ-ray energy). Pulse height tallies appear differently from experimental spectra because electronic broadening is not simulated. After applying weighted averaging (FIG. 5B), the stochastic noise is significantly reduced, but the two sharp features around 320 keV can no longer be resolved.

FIGS. 6A-6B show an MCNP-generated detector response function (FIG. 6A) repeated from FIGS. 5A-5B. Applying the CHIP algorithm (FIG. 6B) significantly reduces stochastic noise. Compare with weighted averaging result in FIG. 5A-5B.

FIGS. 7A-7B show an excerpt from a NaI scintillation spectrum of Ba-133 before (FIG. 7A) and after (FIG. 7B) applying the CHIP algorithm Note the peak at 276 keV, which is not only preserved but is also more visible with nearby stochastic noise removed.

FIG. 8 shows an NaI(T1) spectrum with photopeak output from ASEDRA, Eu-152, 300 s count.

FIG. 9 shows a Germanium detector with photopeak output, Eu-152, 600 s count.

FIG. 10A shows an excerpt from a measured detector spectrum for Ba-133.

FIG. 10B shows the excerpt of FIG. 10A after application of an adaptive chi-processed denoising algorithm in accordance with an embodiment of the invention.

FIG. 10C shows the excerpt of FIG. 10A after application of an adaptive chi-processed denoising algorithm, in accordance with an embodiment of the invention, applied to the measured Ba-133 detector response function.

FIG. 11A shows a Monte Carlo generated detector response function for a 350 keV gamma source and a sodium iodide scintillation detector.

FIG. 11B shows the Monte Carlo generated detector response function of FIG. 11A after the Chi-processed denoising algorithm is applied.

FIG. 11C shows the Monte Carlo generated detector response function of FIG. 11A after application of an adaptive chi-processed denoising algorithm.

FIG. 12A shows a Monte Carlo generated detector response function for a 350 keV gamma source and a sodium iodide scintillator with fewer histories.

FIG. 12B shows the Monte Carlo generated detector response function with fewer histories of FIG. 12A after the application of an adaptive chi-processed denoising algorithm.

FIG. 13 shows a Monte Carlo transport model of NaI scintillation detector system with a scattering plate.

FIG. 14A shows a Monte Carlo simulation of energy deposited per photon in a NaI(T1) scintillation detector from a 650 keV source.

FIG. 14B shows the result of applying an embodiment of the ACHIP denoising tool to the MCNP pulse height tally in FIG. 14A.

FIG. 15A shows an interpolated response function for a monoenergetic 662 keV source with a 1.4 million count photopeak.

FIG. 15B shows the absolute interpolation error for the interpolated response function in FIG. 15A when compared to a direct MCNP simulation for a 662 keV source.

FIG. 16 illustrates low-energy tailing in simulated electronic broadening.

FIG. 17 shows simulated detector response for Ba-133, combining detector response functions for eight emission energies.

FIG. 18 shows a measured detector response spectrum for Ba-133 obtained by combined detector response functions for eight emission energies.

FIG. 19 shows a flow diagram for an embodiment of an advanced synthetically enhanced detector resolution algorithm.

FIG. 20 shows a settings file for an embodiment of an advanced synthetically enhanced detector resolution algorithm.

FIG. 21 shows a detector resolution calibration file.

FIG. 22 shows a energy calibration file.

FIG. 23 shows a synthetically generated Ba-133 sample spectrum

FIG. 24 shows a remainder spectrum in blue and is identical to the original sample spectrum. The first identified peak is shown in red.

FIG. 25 shows an original sample spectrum is shown in blue. The remainder spectrum, after subtracting the first identified peak, is shown in red.

FIG. 26 shows a remainder spectrum in blue. The second identified peak is shown in red.

FIG. 27 shows an original sample spectrum in blue. The remainder spectrum, after subtracting the first two identified peaks, is shown in red.

FIG. 28 shows a remainder spectrum in blue. The third identified peak is shown in red.

FIG. 29 shows an original sample spectrum in blue. The remainder spectrum, after subtracting the first three identified peaks, is shown in red.

FIG. 30 shows a remainder spectrum in blue. The fourth identified peak is shown in red.

FIG. 31 shows an original sample spectrum in blue. The remainder spectrum, after subtracting the first four identified peaks, is shown in red.

FIG. 32 shows a remainder spectrum in blue. The fifth identified peak is shown in red.

FIG. 33 shows an original sample spectrum in blue. The remainder spectrum, after subtracting the first five identified peaks, is shown in red

FIG. 34 shows a remainder spectrum is shown in blue. The sixth identified peak is shown in red.

FIG. 35 shows an original sample spectrum in blue. The remainder spectrum, after subtracting all six identified peaks, is shown in red.

FIG. 36 shows an input file for generating a simulated Cs-137 detector response function.

FIG. 37 shows an input settings file for simulated Cs-137.

FIG. 38 shows detector resolution calibration data.

FIG. 39 shows advanced synthetically enhanced detector resolution algorithm results overlaid on the original simulated Cs-137 detector response function.

FIG. 40 shows an input file for generating a simulated Co-60 detector response function.

FIG. 41 shows an advanced synthetically enhanced detector resolution algorithm (ASEDRA) results overlaid on the original simulated Co-60 detector response function. ASE-DRA found both peaks: 1173 keV and 1332 keV.

FIG. 42 shows an input file for generating a simulated Ba-133 detector response function

FIG. 43 shows an advanced synthetically enhanced detector resolution algorithm (ASEDRA) results overlaid on the original simulated Ba-133 detector response function. ASEDRA found all of the photopeaks, including the overlapping peaks at 276/303 keV and 356/384 keV.

FIG. 44 shows an adaptive denoising is turned on by setting the chi-squared threshold to −1.

FIG. 45A shows a simulated, one-minute, Cs-137 detector response function with Poisson noise.

FIG. 45B shows an advanced synthetically enhanced detector resolution algorithm (ASEDRA) results overlaid on the denoised version of the simulated Cs-137 detector response function in FIG. 45A.

FIG. 46A shows a simulated, one-minute, Co-60 detector response function with Poisson noise.

FIG. 46B shows an advanced synthetically enhanced detector resolution algorithm (ASEDRA) results overlaid on the denoised version of the simulated Co-60 detector response function in FIG. 46A.

FIG. 47A shows a simulated, one-minute, Ba-133 detector response function with Poisson noise.

FIG. 47B shows an advanced synthetically enhanced detector resolution algorithm results overlaid on the denoised version of the simulated, one-minute Ba-133 detector response function in FIG. 47A.

FIG. 47C shows an advanced synthetically enhanced detector resolution algorithm results for the simulated, one-minute Ba-133 detector response function in FIG. 47A.

FIG. 48A shows a simulated, five-minute, Ba-133 detector response function with Poisson noise.

FIG. 48B shows an advanced synthetically enhanced detector resolution algorithm results overlaid on the denoised version of the simulated Ba-133 detector response function in FIG. 48A.

FIG. 48C shows an advanced synthetically enhanced detector resolution algorithm results for the simulated, five-minute Ba-133 detector response function in FIG. 48A.

FIG. 49A shows measured, one-minute, Cs-137 detector response function.

FIG. 49B shows an advanced synthetically enhanced detector resolution algorithm results overlaid on the denoised version of the measured, one-minute Cs-137 detector response function in FIG. 49A.

FIG. 50A shows an measured, one-minute, Co-60 detector response function.

FIG. 50B shows an advanced synthetically enhanced detector resolution algorithm results overlaid on the denoised version of the measured, one-minute Co-60 detector response function in FIG. 50A.

FIG. 51A shows a measured, one-minute, Ba-133 detector response function.

FIG. 51B shows an advanced synthetically enhanced detector resolution algorithm results overlaid on the denoised version of the measured, one-minute Ba-133 detector response function in FIG. 51A.

FIG. 52A shows a measured, one-minute, PuBe detector response function.

FIG. 52B shows an advanced synthetically enhanced detector resolution algorithm results overlaid on the denoised version of the measured, one-minute PuBe detector response function in FIG. 52A

FIG. 53 shows an advanced synthetically enhanced detector resolution algorithm results for a simulated PuBe spectrum with no stochastic noise.

### DETAILED DISCLOSURE

Embodiments of the invention relate to a method and device for processing a detected signal. Embodiments can provide a user with an improved interpretation of the detected signal. The subject method is advantageous for use with detectors that provide a radiation spectrum. An algorithm to effect an embodiment of the subject method can be encoded on a chip to create a post-processing filter device to post process radiation signals. Further embodiments can incorporate the method in the detector device for enhanced interpretation of the detected signal. Specific embodiments of the invention can be applied to detector spectrum from scintillator detectors, for NaI, LaBr₃(Ce), or CsI detectors, or from semiconductor detectors, such as Ge or Si detectors.

When used to post process sodium iodide radiation detector readings, the algorithm used to effect the method can be applied as a data post-processing tool (on the order of 20 seconds on a laptop, possibly faster if encoded on a device) to dramatically improve readings from, for example, a hand held border security detector application using sodium iodide and other room temperature detectors.

When implemented on a wide scale, this spectral post-processing tool can be used to keep low cost, room temperature detectors in service and forego more expensive higher service cost radiation detectors in use. Embodiments can provide resolution enhancement in low-cost scintillation detectors.

Another specific embodiment of the invention pertains to a method and apparatus for denoising a detector signal. The method can be implemented via a general algorithm. The method can prevent loss of resolution for the denoised data. Further, the subject method can operate rapidly on a given dataset, without the need for parallel computing. An algorithm to implement the denoising method can be encoded on a chip to create a post-processing filter device to post process signals. Further embodiments can incorporate the method in the detector device.

Specific embodiments can be used to post-process low-count radiation or poisson based image data, by being applied as a data post-processing tool. Such post-processing can take place in a period of time on the order of <1 second on a typical laptop, and faster if encoded on a device. The subject denoising methodology can rapidly perform denoising without loss of resolution based on a user specified chi-square significance parameter. Embodiments can be implemented without use of Fourier transforms, gradient searches, wavelet analysis, or Gaussian fits for white noise, all of which are computationally more expensive.

When implemented on a wide scale, this denoising tool can be used in simple devices for real time denoising and data reporting, particularly for radiation detectors in search and imaging applications.

There is a continuing need for low-cost, room temperature, high resolution gamma-ray detectors, and many approaches have been investigated in peak de-convolution methods. Embodiments of the subject invention may markedly improved resolution from a gamma ray spectrum, derived synthetically using data post-processing methods, and without prior knowledge of the spectrum. Embodiments of the subject method can be referred to as an Advanced Synthetically Enhanced Detector Resolution Algorithm (ASEDRA). ASEDRA can combine a suite of methodologies, including spectral denoising, Gaussian parameterization, use of Monte Carlo simulated detector response functions, and novel multi-sweep processing schemes to synthetically enhance the resolution of a characteristically poor resolution spectrum collected at room temperature from a scintillator crystal-photomultiplier detector, such as an NaI(T1) system. Embodiments can accomplish enhancement of the resolution of a spectrum without any a-priori information about the collected spectrum. In fact, the algorithm can synthetically extract photopeak doublets from unresolved, low resolution peaks possessing varying levels of skewness/kurtosis. ASEDRA can rapidly processes in seconds, the collected spectrum and synthetically render photo-peaks, which can be linked to nuclide identification software.

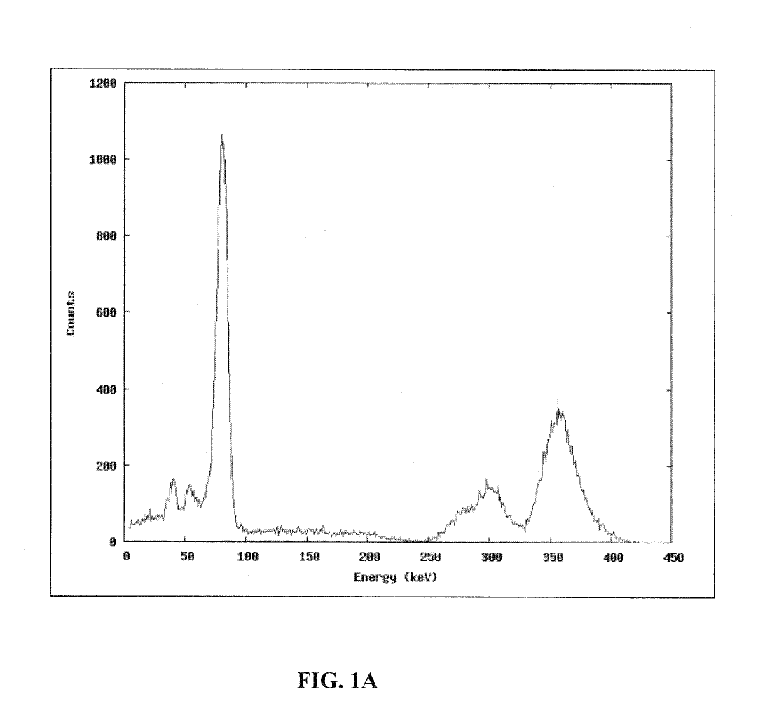

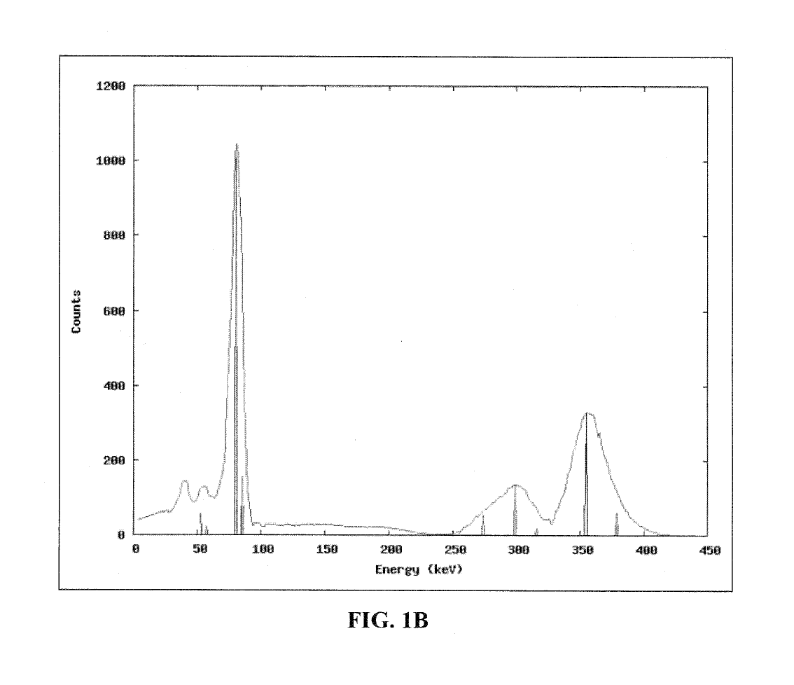

For example, the NaI(T1) spectrum in FIG. 1A-1B was collected using Ba-133. The sharp peaks in FIG. 1B are the result of post processing the spectra of FIG. 1A with ASEDRA. FIGS. 1A and 1B show Ba-133 Test Spectra. FIG. 1A shows the original spectrum, and FIG. 1B shows a curve that indicates the original, denoised spectrum (using the robust adaptive chi-square technique). The sharp peaks indicate unique photopeaks extracted from the spectrum by ASEDRA. Doublets are extracted from the spectrum with no prior knowledge of nuclides or photopeak energies.

ASEDRA can be utilized as a research tool. Embodiments of the subject invention can involve integration of ASEDRA into an operational system for nuclear monitoring applications. Embodiments of the subject invention may assess, refine, and enhance the performance of the ASEDRA algorithm when tied to a specific detector geometry, to yield an optimum peak rendering capability with synthetic resolution enhancement. This can involve generating detector response functions and reconstructing the exact detector geometry, shielding using Monte Carlo simulations, where the enhanced ASEDRA algorithm is tested against known spectra of the detector. In a specific embodiment, NaI(T1) and LaBr₃ detectors can be used validating the reliability of the synthetically enhanced resolution algorithm in moderate to strong radiation background environments among a variety of sampling times.

Embodiments of ASEDRA can also be leveraged to counter the self-activation of LaBr₃ detectors for low/short count screening applications. In addition, a nuclide identification library can be developed, which can contain up to 50 nuclides to identify photopeaks to be integrated with the ASEDRA data processing.

Implementation of an embodiment of ASEDRA can be accomplished with, for example, the following nominal detector information:
i) the detector energy calibration, which can usually be achieved from six points spanning the energy domain
ii) the detector Full Width Half Maximum behavior as a function of energy, which can usually be achieved from six points, spanning the energy domain.
iii) a library background spectrum for scaled subtraction, with no other a-priori detail

With this information, the system utilized can collect a spectrum, and in a specific embodiment, within less than 15 seconds the ASEDRA processing is complete. ASEDRA processing, in accordance with an embodiment, includes the following computations applied to any spectrum, such as a NaI(T1) spectrum, rendered using post data collection processing:
i) denoise background
ii) denoise Spectrum
iii) account for low energy tailing (optional)
iv) sweep from high energies to low energies
v) apply Monte Carlo detector response functions
vi) strip spectrum to reveal new detail beneath, identify peaks
vii) repeat iv), v), and vi) until no valid features remain

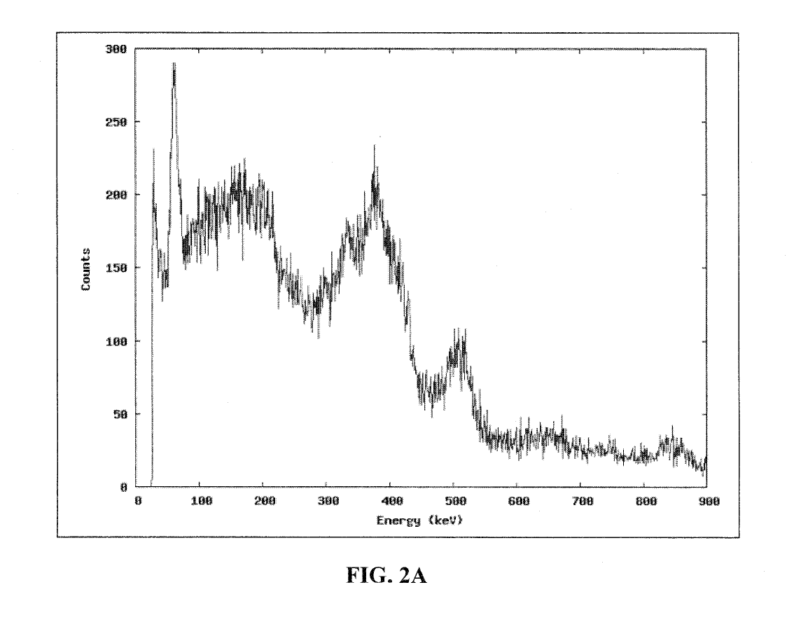

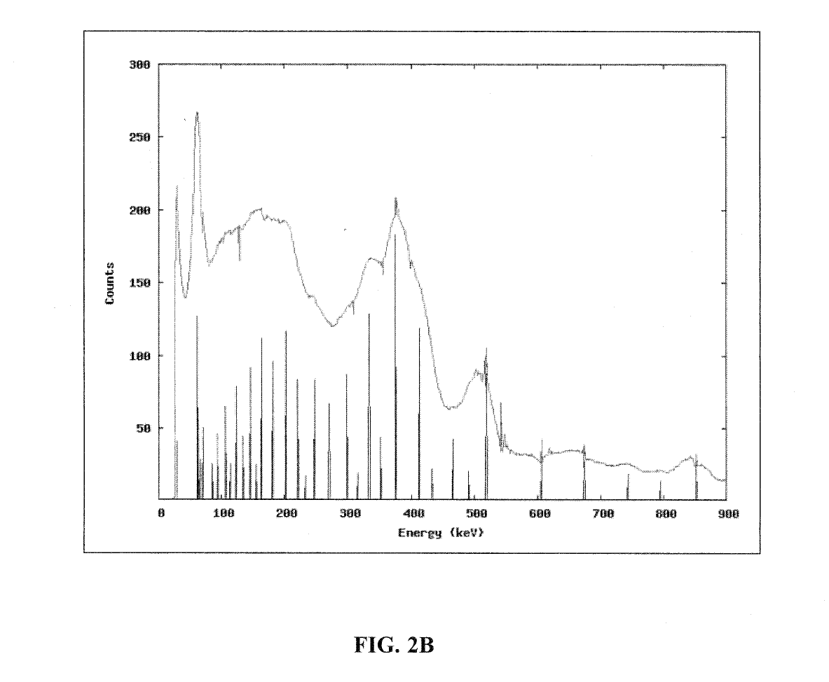

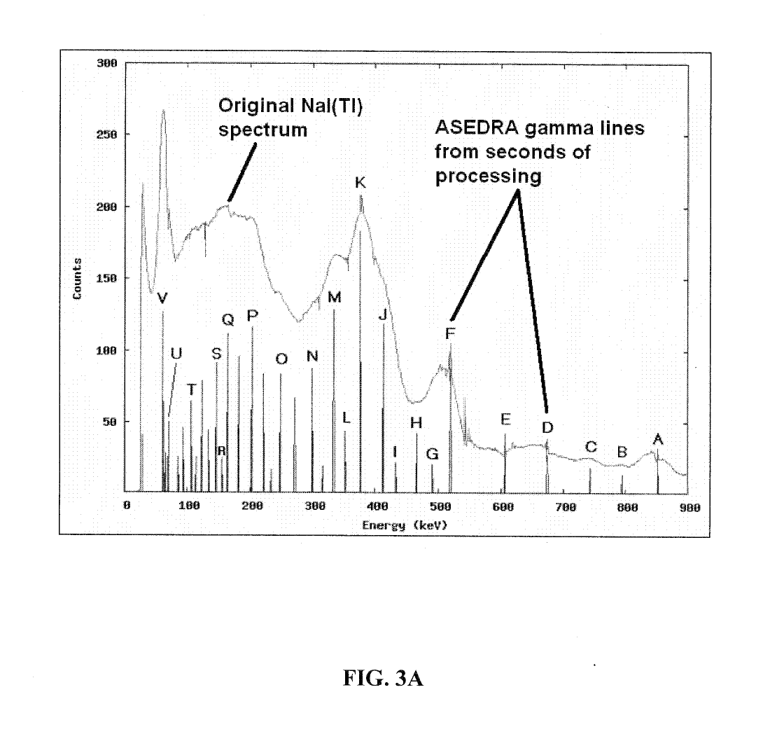

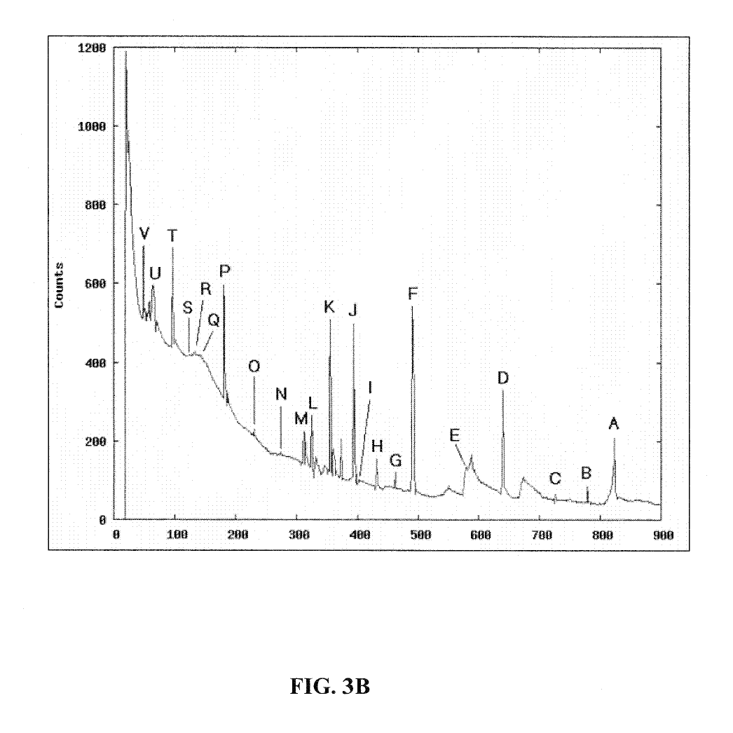

Using this procedure for WGPu spectra, ASEDRA can be applied to plutonium gamma rays from a sealed, tantalum-and-stainless-steel sealed PuBe source containing 16 grams of Weapons Grade Pu using a one-minute count as shown in FIGS. 2A-2B. FIGS. 2A-2B show WGPu gamma spectra from a 1 minute count of a PuBe Source. FIG. 2A shows the original NaI(T1) spectrum, and FIG. 2B shows a curve that indicates the denoised original spectrum (using a the robust adaptive chi-square technique, where the sharp peaks indicate unique photopeaks extracted from the spectrum by ASEDRA, rendered in 28 seconds of post processing. These results can be compared with what might be observed by a high resolution Ge system from, for example, a one-minute PuBe count. The data, shown in FIG. 3, was rendered for comparison, where photopeaks were aliased to the ASEDRA results. The ASEDRA results compare quite well to the photopeaks evidence from the Ge detector.

In alternative embodiments, the spectrum can be swept from low energies to high energies, or other selection protocols can be used.

FIGS. 3A-3B show GPu gamma spectra from a 1 minute count of PuBe source. FIG. 3A shows the ASEDRA denoised and processed spectrum, and FIG. 3B shows the germanium detector (denoised) spectrum from the same source. The peaks that appear to be aliased are labeled alphabetically.

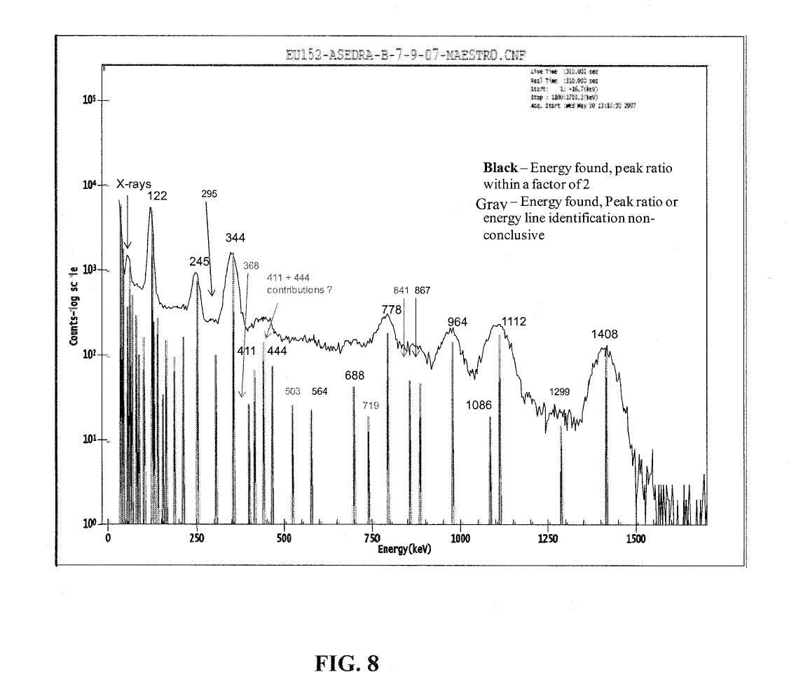

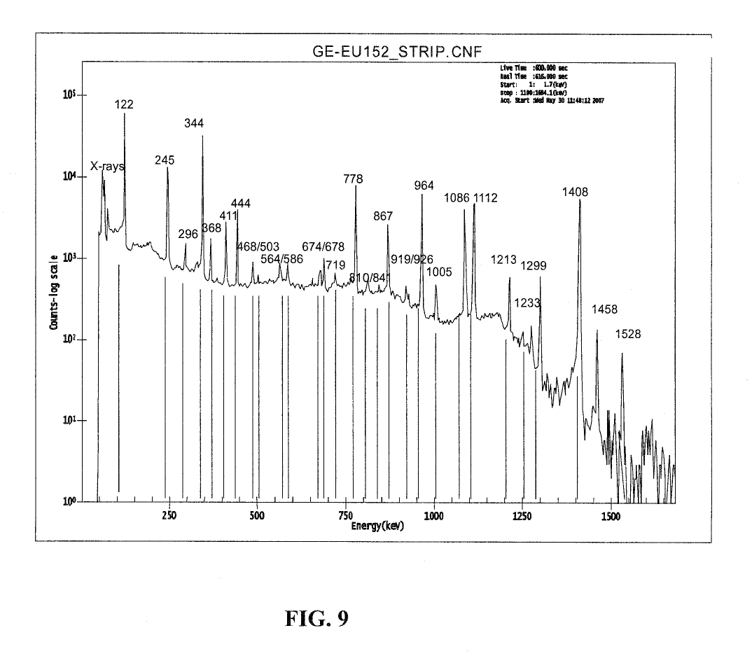

Side by side tests of a 2″×2″ NaI(T1) detector spectrum post-processing by ASEDRA compared directly with a germanium detector have demonstrated the methodology is highly accurate. For example, consider an ¹⁵²Eu source counted for 300 s with NaI(T1) (FIG. 8), compared directly against a 600 s count using a germanium detector in (FIG. 9). FIG. 8 shows an NaI(T1) spectrum with photopeak output from ASEDRA, Eu-152, 300 s count. FIG. 9 shows a Germanium detector with photopeak output, Eu-152, 600 s count. Post-processed ASEDRA gamma lines separated from the original spectrum are shown immediately below the original NaI(T1) spectrum in FIG. 8. Due to the large number of overlapping energy lines of ¹⁵²Eu NaI(T1) spectra within the energy range of 50 keV to 1500 keV (over 30 were identified from the HPGe spectra), the performance of ASEDRA with this source is a particularly challenging test.

Analysis of the ASEDRA results show identification of at least 15 lines from the ¹⁵²Eu spectra in the ASEDRA results from post-processing the NaI(T1) spectrum (indicated in FIG. 8), with relative ratios of yields of the major lines to better than a factor of two in most cases for ratios taken with the ¹⁵²Eu 344 keV peak.

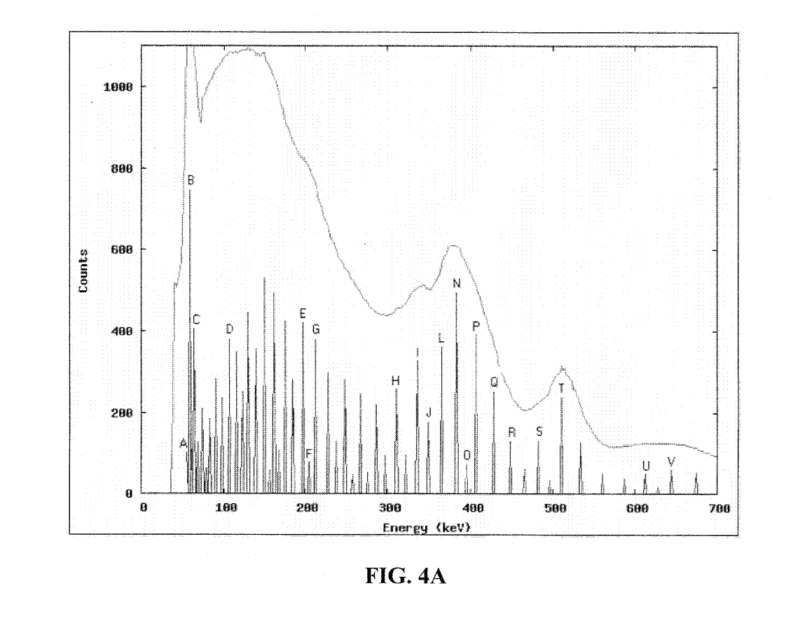

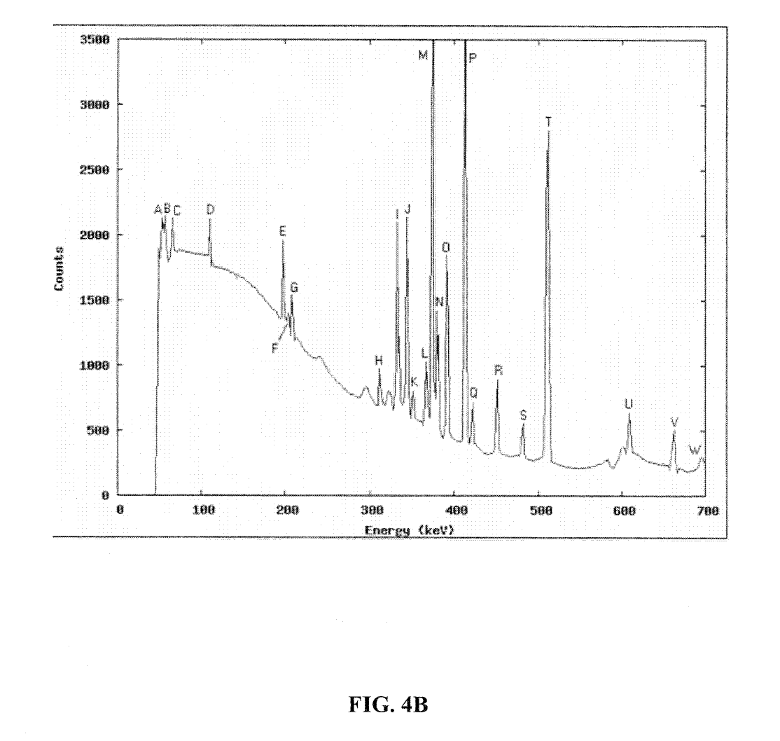

A second test using a 10 minute count of PuBe gammas can be carried out with detector calibration and source/geometry placement, as shown in FIGS. 4A-4B. FIGS. 4A-4B show a WGPu gamma spectra from a 10 minute count of PuBe Source. FIG. 4A shows the ASEDRA (denoised by ACHIP) processed spectrum, and FIG. 4B shows the germanium (denoised by ACHIP) detector spectrum from the same source. Both detectors were calibrated with a series of check sources and placed in the same geometric configuration relative to the PuBe Source. The peaks that correlate between the two spectra are labeled alphabetically. A large number of peaks identified by ASEDRA, validated with a highly calibrated Ge detector, show that ASEDRA was able to quickly (28 seconds using a standard laptop) extract many photopeaks directly attributable to WGPu.

The methodologies incorporated into ASEDRA can be useful for enhancing lanthanum bromide LaBr₃(Ce). LaBr₃(Ce) is a scintillator with great promise for room-temperature gamma-ray detection and isotope identification, as well as imaging applications, due to combined high efficiency and good energy resolution. It is 60% more efficient than NaI at 662 keV, with better energy resolution by a factor of two or more (less than 3% energy resolution is possible with LaBr₃ at 662 KeV compared to 7% with NaI [Saint Gobain; Knoll]. LaBr₃ also has excellent timing capabilities for room-temperature gamma-ray detectors, with a decay time of 16 ns as compared to 250 ns of NaI or 300 ns of BGO [Saint Gobain]. These properties make LaBr₃ a desirable material to work with both for real-time gamma-ray detection as well as higher energy Compton imaging applications.

However, self-activation gamma lines occur in the spectra of LaBr₃. One of the two primary contributors to LaBr₃ self-activation is alpha contamination, which has been identified with ²²⁷Ac and daughters [Kernan; Milbrath, et al], pulled out with the lanthanum during processing because of chemical similarity. The contamination by ²²⁷Ac and daughters has been dramatically reduced to an annoyance level by manufacturers and may be further minimized by using chemical methods. Natural lanthanum also contains ¹³⁹La (99.91%) and ¹³⁸La (0.09%); ¹³⁸La is the second major contributor to LaBr₃ self-activation, with a half life (t_{1/2}) of 1.05×10¹¹ years. ¹³⁸La is not easily reducible, and decays both by electron capture and β⁻ decay resulting in gamma rays at 789 keV and 1435 keV. A β⁻ energy spectrum is also visible in long backgrounds, and the X-ray following the electron capture may be seen alone and summed with the 1436 keV γ-ray.

In the past, work has been done to either characterize the LaBr₃ self-contamination, or use the resulting lines in a gain stabilization routine [Kernan; Milbrath, et al]. However, it is of interest in applications such as imaging and low statistics measurements to eliminate the self-activation lines. In an embodiment, the self-activation lines can be reduced, or eliminated, by applying the spectral de-noising routine and coincidence reduction methods to a LaBr₃ detector system.

Embodiments of the invention pertain to a method and apparatus for spectral deconvolution of detector spectra. In a specific embodiment, the method can be applied to sodium iodide scintillation detector spectra. An adaptive chi-processed (ACHIP) denoising technique can be used to remove the results of stochastic noise from low-count detector spectra. Photopeaks can be rapidly identified, starting at the high-energy end of the spectrum. The detector response functions can be estimated for photopeaks with a combination of Monte Carlo simulations and simple transformations.

Embodiments of the invention relate to a method and apparatus that can incorporate an advanced synthetically enhanced detector resolution algorithm (ASEDRA). The algorithm can utilize a method for identifying photopeaks, based on recognizing local maxima in a detector spectrum. For each identified photopeak, a corresponding detector response function is subtracted from the detector spectrum, revealing previously hidden photopeaks so that highly overlapping photopeaks can be separated. Despite its simplicity, embodiments of the subject method incorporating ASEDRA have demonstrated a capability for deconvolving intricate detector spectra.

Embodiments can use a combination of previously developed methodologies, novel processing schemes, and radiation simulation data, the advanced synthetically enhanced detector resolution algorithm (ASEDRA) to synthetically enhance the resolution of a collected spectrum. In a specific embodiment, the subject method synthetically enhances the resolution of a poor resolution spectrum collected from a sodium iodide (NaI) detector-photomultiplier system. In an embodiment, the algorithm can synthetically extract enhanced doublets from unresolved, low resolution peaks. The computer algorithm can be implemented as a spectral post-processing code, so as to rapidly process the collected spectrum and synthetically render photopeaks based on a specific set of parametric peak search criteria.

Embodiments of ASEDRA can utilize tools, including the adaptive chi-processed (ACHIP) denoising algorithm and a detector response function generator, in order to provide beneficial photopeak search techniques.

Embodiments of the advanced synthetically enhanced detector resolution algorithm (ASEDRA) can be applied with real-time applications. In addition to software execution time, it is important to remember that the time available for radiation measurement is also limited.

Time constraints often prevent the taking of thorough radiation measurements. In a portal screening system, short count times are preferred to reduce or avoid delays in traffic. When the number of counts per channel is too low, stochastic noise becomes problematic. Filtering white noise from spectral data, while preserving sharp peaks, is useful for visualization of noisy spectra, or as a preprocessing step for spectral analysis algorithms. Embodiments of the subject method can incorporate an algorithm that can address this noise reduction need while minimizing the degradation of sharp features of interest in the spectrum. This method can implement smoothing and denoising techniques for Monte Carlo simulated [6] and actual radiation detector spectral data. This method can implement an algorithm based on chi-squared analysis.

Embodiments of the invention can distinguish noisy regions, in which stochastic fluctuation dominates and smoothing is essential, from regions with sharp, statistically significant features, in which smoothing attempts may be destructive. A specific embodiment can make such a determination based on chi-squared analysis.

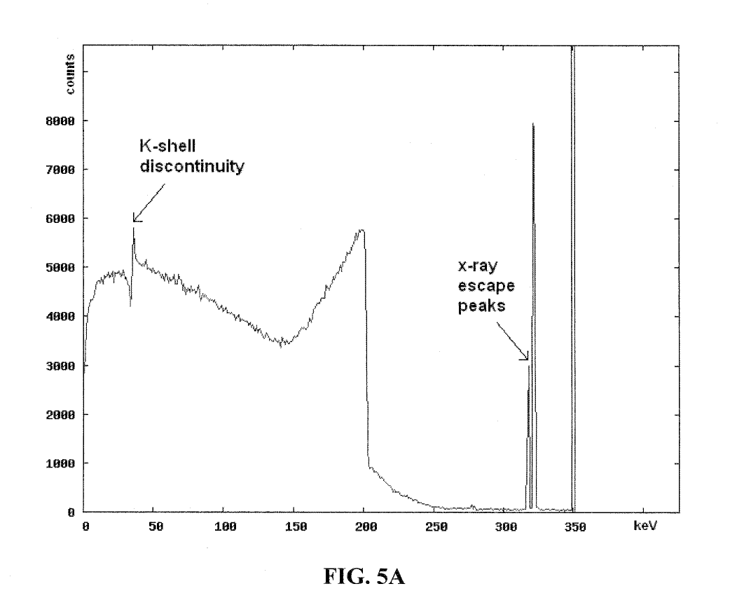

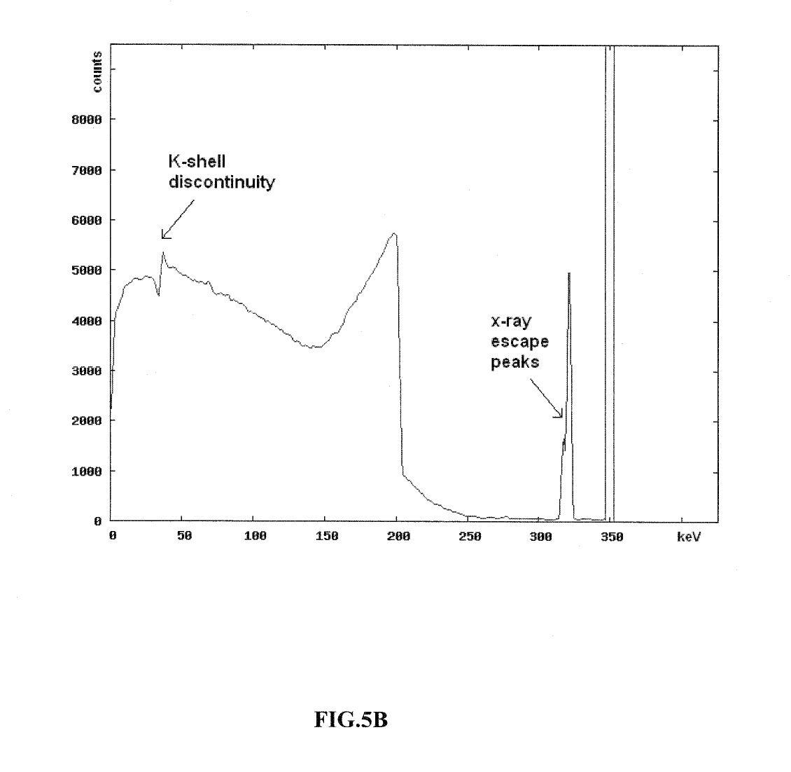

After applying weighted averaging to the Monte Carlo generated detector response function in FIG. 5A, the stochastic noise is significantly reduced. The two sharp features around 320 keV, however, can no longer be resolved. The K-shell discontinuity around 40 keV, while still visible, is broadened and reduced in prominence.

Chi-squared analysis is a standard technique for deteimining how well a given model fits a data set. In particular, chi-squared analysis can assist in determining whether there is a statistically significant difference in counts between two neighboring channels: A and B. N, in Equation 3-2, is the sum of n_{A} and n_{B}, the counts accumulated in channels A and B, respectively.

$${X}^{2} = \frac{{( {n}_{A} - N / 2 )}^{2}}{N / 2} + \frac{{( {n}_{B} - N / 2 )}^{2}}{N / 2} \qquad ( 3 \text{-} 2 )$$

X² is a measure of certainty that the difference between nA and nB is due to a difference in expected value, rather than the result of stochastic fluctuation. A X² value of 7.88, when there is one degree of freedom as in Equation 3-2, corresponds to a certainty of 99.5% [10], indicating that this difference in neighboring channels is a statistically significant feature. In the context of gamma detector spectra, such features should be preserved. For lower values of X², the difference is attributable to stochastic fluctuation and should be smoothed away. Chi-squared analysis is traditionally parameterized by a, which is the probability that the test incorrectly indicates a significant difference. In this case, a=1−0.995=0.005.

In a specific embodiment, a set of noise-dominated regions is identified, in which X²<7.88 for all adjacent channels. Further embodiments can use a different X² threshold value. The chi-processed denoising algorithm (CHIP) can perform smoothing only within these noise-dominated regions, thus increasing the likelihood that statistically significant features will be preserved.

In an embodiment, within each noise-dominated region, CHIP provides smoothing via a sequence of best-fit lines of the form in Equation 3-3.

F(x)=mx+b (3-3)

For a given channel xₒ, parameters m and b (representing slope and intercept) are chosen so that F(x) provides the best possible model for the five closest channels (excluding any channels outside the noise-dominated region). Further embodiments can use a different number of closest channels for this purpose. To determine how well a given model fits the measured data, chi-squared analysis, as in Equation 3-4, can be used.

$${X}^{2} = {\sum }_{i} \frac{{( {n}_{i} - E ( {n}_{i} ) )}^{2}}{E ( {n}_{i} )} = {\sum }_{i = - 2}^{2} \frac{{( f ( {x}_{0} + i ) - F ( {x}_{0} + i ) )}^{2}}{F ( {x}_{0} + i )} \\ {X}^{2} = {\sum }_{i = - 2}^{2} \frac{{( f ( {x}_{0} + i ) - m ( {x}_{0} - i ) - b )}^{2}}{m ( {x}_{0} + i ) + b} \qquad ( 3 \text{-} 4 )$$

By minimizing X², a model F(x) that matches, as well as possible, a neighborhood of five points around xₒ: {xₒ−2, xₒ−1, xₒ, xₒ+1, xₒ+2} can be identified. An embodiment can use a partitioned simplex search algorithm for determining parameters m and b that minimize Equation 7A over the domain spanning five points. That model can then be used to choose a new value at xₒ.

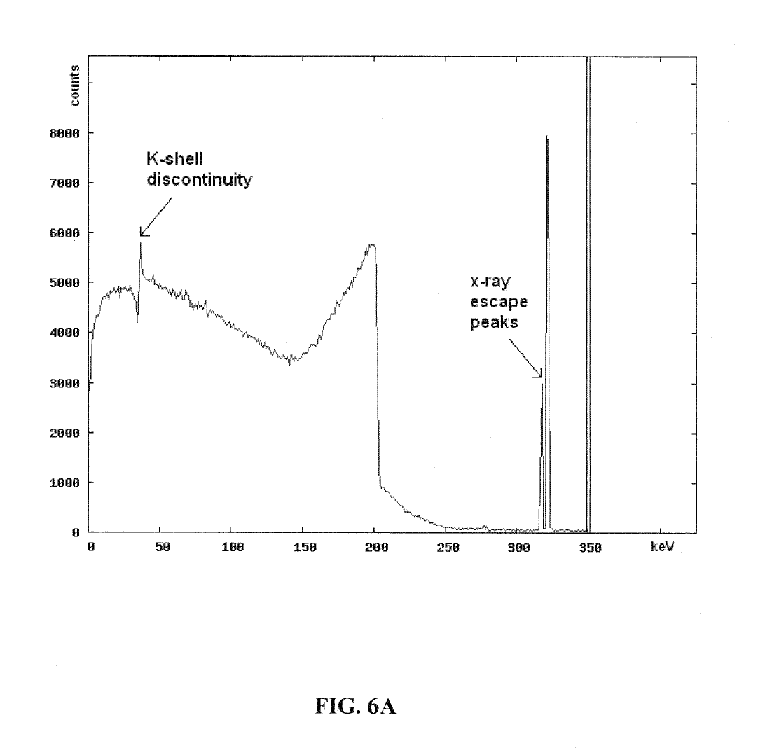

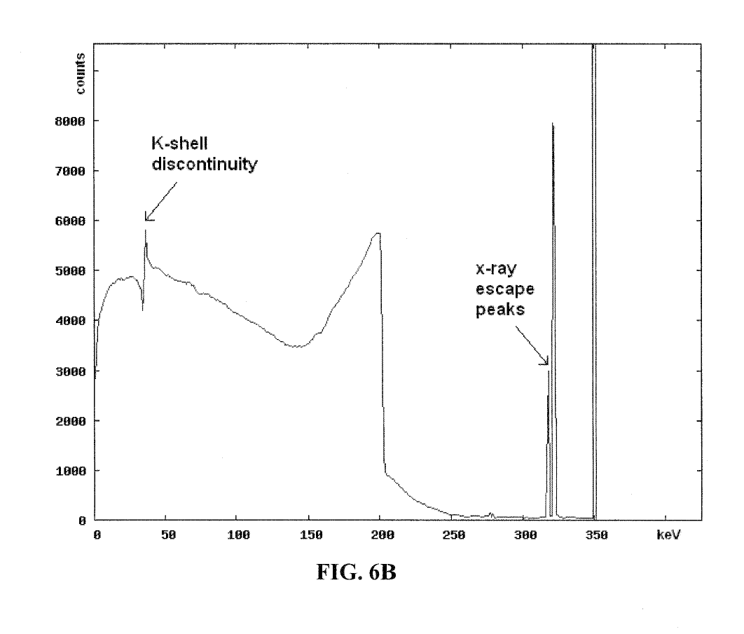

The CHIP algorithm performs much better than weighted averaging on the example shown in FIG. 5A. The effect of an embodiment of the CHIP algorithm applied to the MCNP generated response function of FIG. 5A, with 1.2×10⁹ histories, is shown in FIG. 6B. Compared with weighted averaging in FIG. 5B, CHIP provides similar smoothing quality in those areas that need it. The advantage of CHIP, however, is that it does not degrade the spectrum in those areas where smoothing is harmful. The two x-ray escape peaks around 320 keV, for example, are left untouched, as is the K-edge discontinuity around 40 keV.

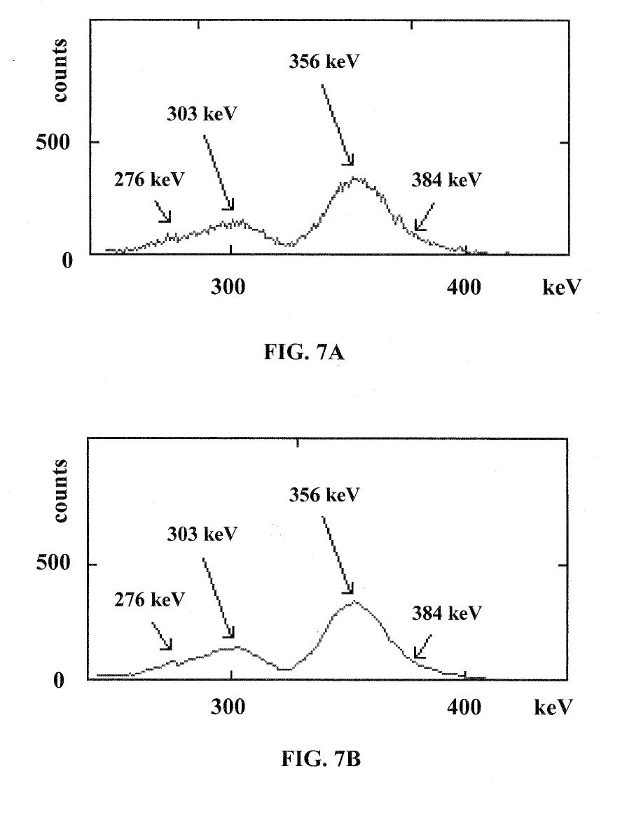

A second example, referring to FIG. 7A, shows an excerpt from a Ba-133 spectrum, collected with a sodium iodide scintillation detector.

An embodiment of the CHIP denoising algorithm provides significant reduction of stochastic fluctuation for the measured Ba-133 spectrum, shown in FIG. 7A, as shown in FIG. 7B, while still preserving significant features. The small full-energy photopeak at 276 keV, for example, remains visible while nearby stochastic noise is removed. Unfortunately, denoising is not sufficient to resolve the convoluted peak at 384 keV, which is roughly seven times smaller than the nearby peak at 356 keV.

These results clearly demonstrate that the CHIP algorithm, applied to radiation detector data, can significantly reduce stochastic noise in a gamma detector spectrum, while preserving statistically significant features.

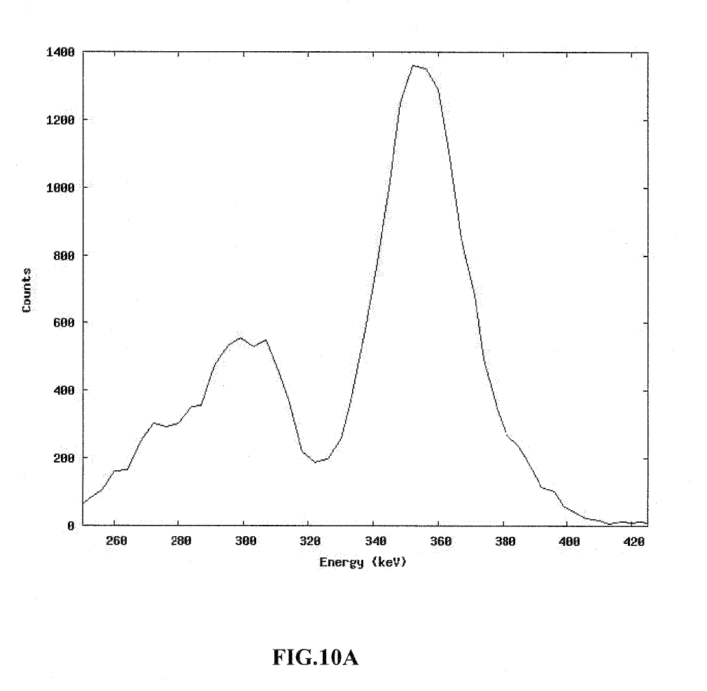

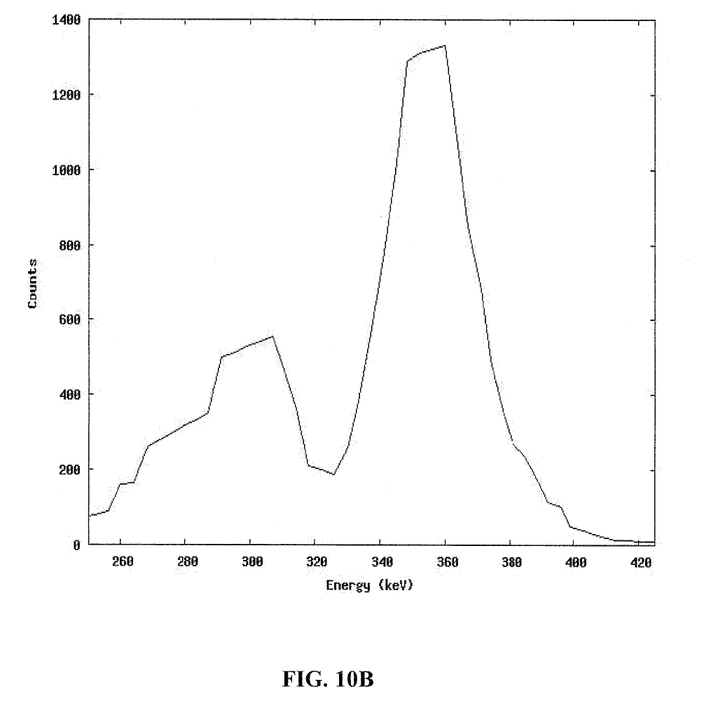

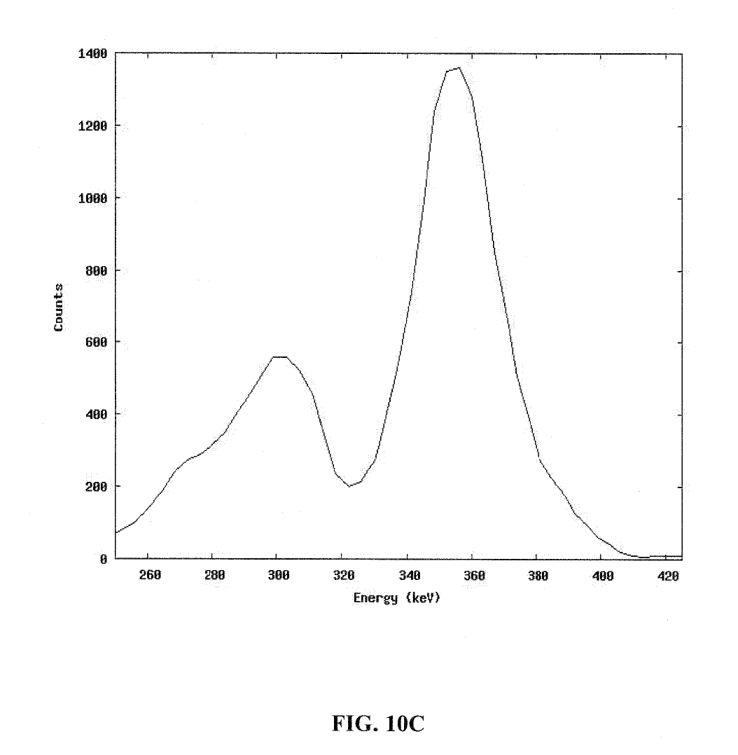

The stochastic noise is not completely removed in any of the examples discussed and, as shown in FIGS. 10A and 10B, where FIG. 10A shows an excerpt from a measured detector spectrum for Ba-33, and FIG. 10B shows the excerpt from FIG. 10A after application of an adaptive chi-processed denoising algorithm in accordance with the invention. Embodiments of the CHIP algorithm can even introduce defects into a spectrum.

The CHIP algorithm determines that stochastic noise is an issue in FIG. 10A, so that smoothing is needed. Unfortunately, the embodiment of CHIP smoothing used is based on linear fitting over a neighborhood of five channels. This does not work well in regions with significant curvature, as shown in FIG. 10B. FIG. 10B shows the result of applying the chi-processed denoising algorithm to the Ba-133 spectrum in FIG. 10A. The incorrect assumption that local linearity over a region of five channels is implied by local constancy over each pair of neighboring channels leads to a “chopping” defect. The problem is that the CHIP algorithm uses an assumption that locally constant, over a neighborhood of two channels, implies locally linear, over a larger neighborhood of five channels. Therefore, small noisy regions of a spectrum are linearized without regard for any curvature in the original measured spectrum.

Further embodiments can fit parabolas, which can better represent curved regions, rather than lines. Further, fitting over a larger number of points (rather than just five channels) can increase the degree of noise reduction. However, choosing too many points can cause problems when a parabola is unable to adequately represent the entire region.

A specific embodiment can utilize an adaptive chi-processed denoising (ACHIP) algorithm, which combines parabolic fitting with dynamic range selection.

Embodiments of the CHIP algorithm discussed above use a two-step process, in which it first determines whether smoothing is necessary in some region, and then performs the smoothing operation. Embodiments of the adaptive chi-processed denoising algorithm (ACHIP) follow a more sophisticated approach, in which the smoothing process is adapted to each situation. The ACHIP algorithm uses more channels. In a specific embodiment, the ACHIP algorithm uses as many channels as possible, increasing the power of the smoothing operation, within the constraint that the fitted model must match the measured data according to chi-squared analysis. ACHIP also fits parabolic models, rather than linear models, to increase the number of channels that can reasonably be used in regions with high curvature.

In accordance with an embodiment, in order to determine a new, denoised value for some channel xo, ACHIP starts by considering a neighborhood of three channels around xo. A parabolic model can be chosen to exactly match those three points. Additional channels are added one-by-one, as long as a parabolic model can be found that adequately represents the expanded range, according to a chi-squared test with a threshold, such as a 99.5% threshold. Parabolic models are selected by least-square fitting for the sake of faster calculation, as described above, but a model is rejected if chi-squared analysis shows with 99.5% certainty that the model does not adequately represent the experimental data. In other words, the ACHIP algorithm will tend to smooth away features unless there is 99.5% certainty that those features are not the result of stochastic noise. By choosing as many points as possible for each parabolic fitting, the effects of stochastic noise can be reduced and/or minimized.

In an embodiment, the process of adding additional channels can continue until it is no longer possible to further increase the size of the neighborhood while still passing the chi-squared test. This final model can then predict an appropriate denoised value for the channel of interest, xₒ.

The adaptive chi-processed (ACHIP) denoising algorithm can fit parabolic models to a set of measured data points. This fitting process can be the most computationally demanding step in the ACHIP algorithm, and fast execution is preferred to allow real-time denoising of field measurements.

Embodiments of the subject method can utilize a fast method for determining parabolic least-square fits. To fit a parabola over a set of N evenly separated channels, the measured data can be represented as \vec{m}=(m₁, m₂, . . . m_{N}). A parabola is any function of the form f(x)=c₀+c₁x+c₂x², so a set of vectors can be defined, {\vec{v₀}, \vec{v₁}, \vec{v₂}}, representing {1, x, x²}, as in Equation 3-5.

\vec{v₀}=(1, 1, . . . 1)

\vec{v₁}=(1, 2, . . . N)

\vec{v₂}=(1², 2², . . . N²) (3-5)

A parabola vector \vec{u} could then be defined as in Equation 3-6.

\vec{u}=c₀\vec{v₀}+c₁\vec{v₁}+c₂\vec{v₂} (3-6)

The goal is to choose the set of constants {c₀, c₁, c₂} so that \vec{u} and \vec{m} will be as close as possible according to the least-squares metric in Equation 3-7.

$${\sum }_{i = 1}^{N} {( {u}_{i} - {m}_{i} )}^{2} \qquad ( 3 \text{-} 7 )$$

It should be clear by inspection that this is equivalent to minimizing the Euclidean difference as shown in Equation 3-9 because, for x>0, \sqrt{x} is a strictly increasing function.

$$〈 \vec{x} , \vec{y} 〉 = {\sum }_{i = 1}^{N} {( {x}_{i} - {y}_{i} )}^{2} \qquad ( 3 \text{-} 8 )$$

Therefore, the dot product can be defined as in Equation 3-8 and the goal of least-squares fitting is equivalent to minimizing the length [11] of the difference between \vec{u} and \vec{m} as in Equation 3-9.

$$‖ \vec{u} - \vec{m} ‖ = \sqrt{〈 \vec{u} - \vec{m} , \vec{u} - \vec{m} 〉} = \sqrt{{\sum }_{i = 1}^{N} {( {u}_{i} - {m}_{i} )}^{2}} \qquad ( 3 \text{-} 9 )$$

Determining the value of \vec{u} that minimizes Equation 3-9 would be computationally easier if \vec{u} were expressed as a linear combination of orthonormal vectors. In fact, it is possible to choose a set of orthonormal vectors {\vec{w₀}, \vec{w₁}, \vec{w₂}} such that the set of all possible linear combinations of {\vec{v₀}, \vec{w₁}, \vec{w₂}} is equivalent to the set of all possible linear combinations of {\vec{v₀}, \vec{v₁}, \vec{v₂}}. Gram-Schmidt orthogonalization [12] is a standard technique for choosing a set of orthonormal vectors {\vec{w₀}, \vec{w₁}, \vec{w₂}} that meet that requirement, as shown in Equation 3-10, in which the dot product and length are defined as in Equations 3-8 and 3-9. An arbitrary parabola \vec{u} can then be represented as \vec{u}=d₀\vec{w}₀+d₁\vec{w}₁+d₂\vec{w}₂ for some set of constants {\vec{d₀}, \vec{d₁}, \vec{d₂}}.

$$\vec{{w}_{0}} = \frac{\vec{{v}_{0}}}{‖ \vec{{v}_{0}} ‖}$$

$$\vec{{x}_{1}} = \vec{{v}_{1}} - 〈 \vec{{v}_{1}} , \vec{{w}_{0}} 〉 \vec{{w}_{0}}$$

$$\vec{{w}_{1}} = \frac{\vec{{x}_{1}}}{‖ \vec{{x}_{1}} ‖}$$

$$\vec{{x}_{2}} = \vec{{v}_{2}} - 〈 \vec{{v}_{2}} , \vec{{w}_{0}} 〉 \vec{{w}_{0}} - 〈 \vec{{v}_{2}} , \vec{{w}_{1}} 〉 \vec{{w}_{1}}$$

$$\vec{{w}_{2}} = \frac{\vec{{x}_{2}}}{‖ \vec{{x}_{2}} ‖}$$

Once the orthonormal vectors {\vec{w₀}, \vec{w₁}, \vec{w₂}} are calculated, as described above, the optimal values {\vec{d₀}, \vec{d₁}, \vec{d₂}} are easily calculated by dᵢ=<\vec{m}, \vec{w}ᵢ>[13]. This method is fast because the orthonormal set {\vec{w₀}, \vec{w₁}, \vec{w₂}} depends only on the number of channels being considered, and can therefore be reused each time a least squares fitting is performed.

Additional increases in polynomial order for fitting can be utilized in denoising for detector spectra. Further embodiments for denoising detector spectra can also be applied to 2D and 3D data.

Embodiments of the adaptive chi-processed (ACHIP) denoising algorithm can greatly reduce the need for long measurement times by removing the effects of stochastic noise. A specific embodiment of the ACHIP algorithm can process a detector spectrum in less than a second.

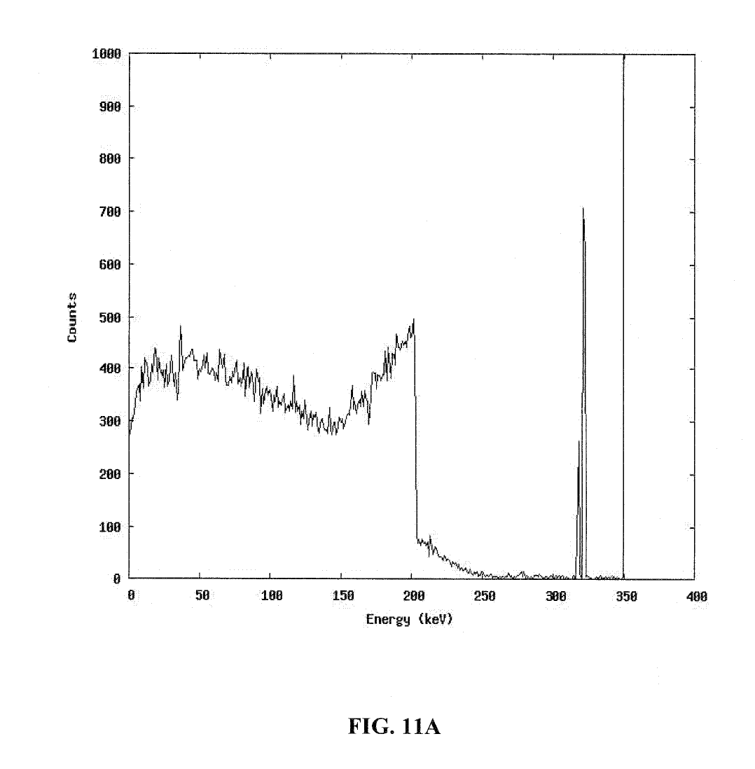

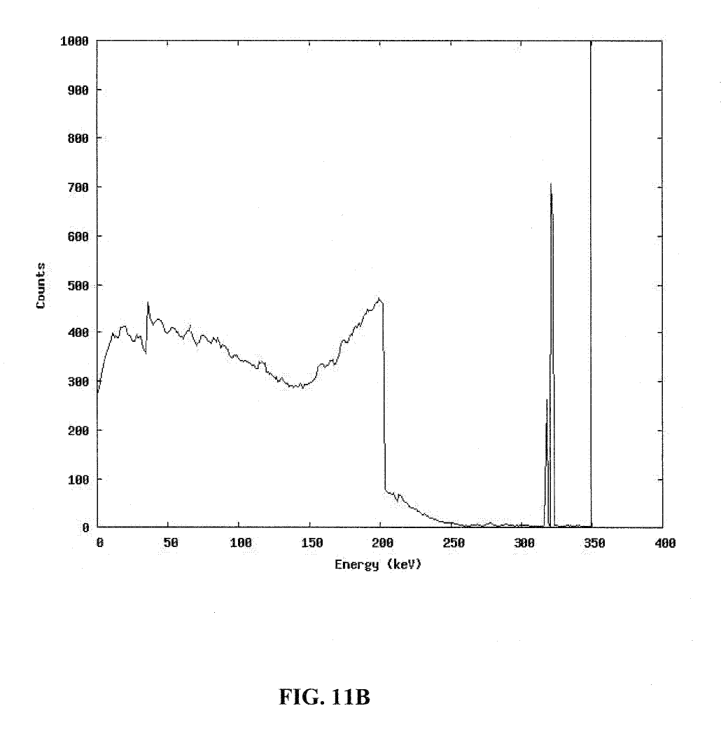

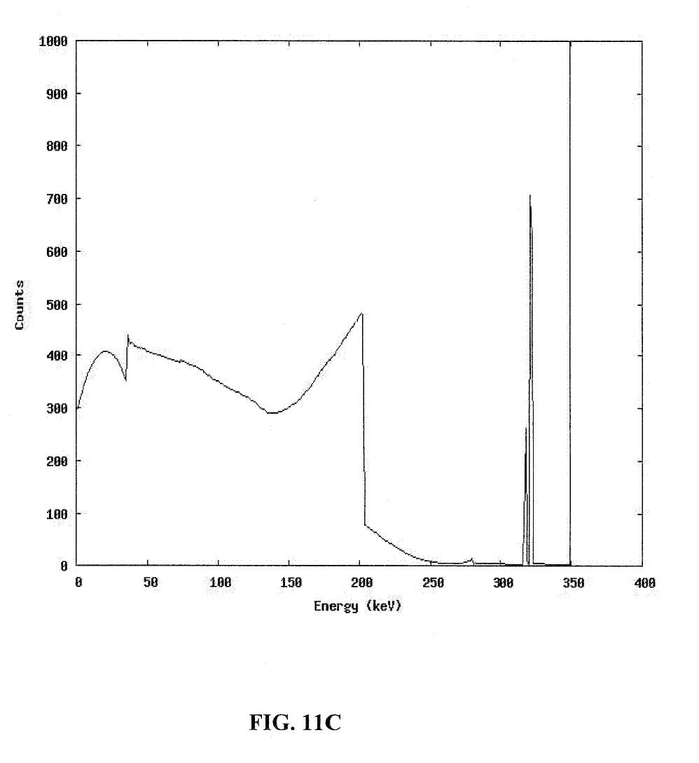

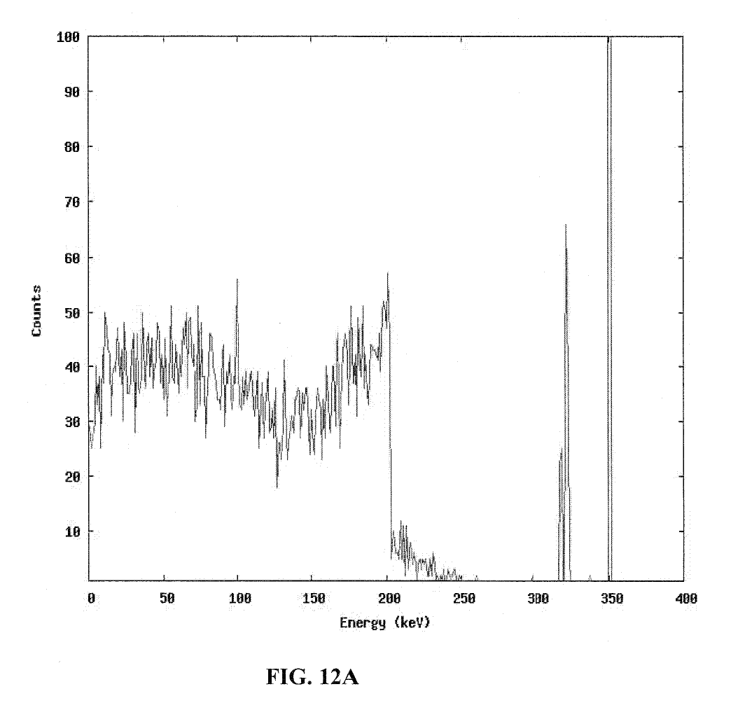

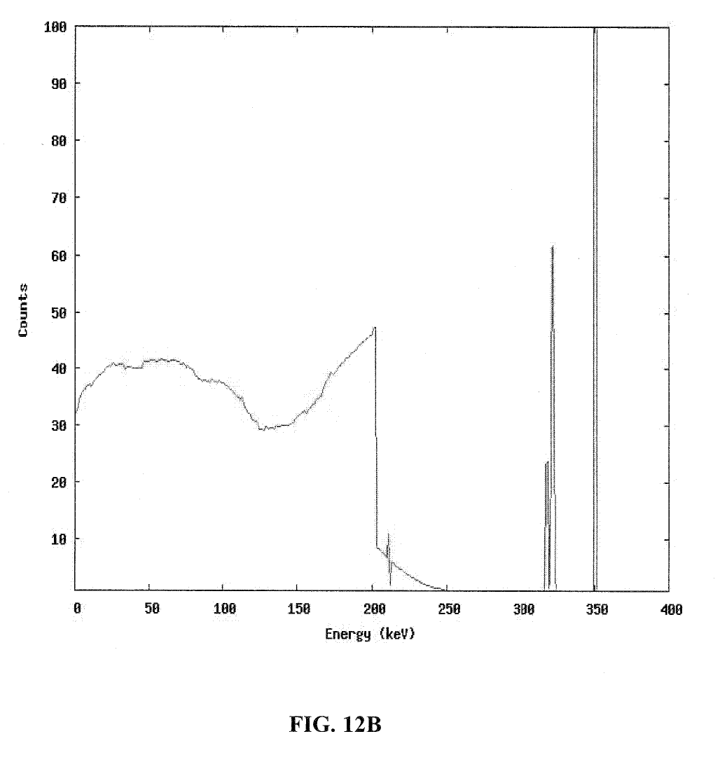

FIG. 10C shows the results from application of an adaptive chi-processed denoising algorithm removing noise from the spectrum in FIG. 10A, without introducing defects. This can be compared with FIG. 10B, in which chi-processed denoising algorithm actually made this spectrum worse, FIG. 11A shows a Monte Carlo generated detector response function for a 350 keV gamma source and a sodium iodide scintillator with 1.2×10⁸ histories (plotted as counts vs deposited γ-ray energy). The pulse height tallies appear differently from experimental spectra because electronic broadening is not simulated. FIG. 11B shows the Monte Carlo generated detector response function in FIG. 11A, after a chi-processed denoising algorithm removes some of the noise. FIG. 11C shows the results of the application of an adaptive chi-processed denoising algorithm to the Monte Carlo generated detector response function in FIG. 11A. This embodiment of ACHIP produces a much cleaner spectrum than the embodiment of CHIP shown in FIG. 11B, while still preserving real features. FIG. 12A shows a Monte Carlo generated detector response function for a 350 keV gamma source and a sodium iodide scintillator with 1.2×10⁷ histories (plotted as counts vs deposited γ-ray energy). Pulse height tallies appear differently from experimental spectra because electronic broadening is not simulated. FIG. 12B shows the results of the application of an adaptive chi-processed denoising algorithm the Monte Carlo generated detector response function in FIG. 12A. This is a particularly challenging spectrum, due to the low number of counts in many of the channels. Note that chi-squared analysis works better with at least 20 counts per channel.

Embodiments of the invention relate to generating synthetic photopeaks and spectra for a radiation spectrum. A specific embodiment generates synthetic photopeaks and spectra for a gamma ray detector. Such an embodiment will be described in more detail and is illustrative of the techniques involved. In order to deconvolute detector spectra into their component photopeaks, it is useful to fully characterize these photopeaks, as well as their associated effects such as compton edges, x-ray escape peaks, k-edges, and backscatter peaks. A method for generating full detector response functions, each of which represents the response of a gamma ray detector to a monoenergetic photon source is described herein. Such detector response functions can be combined to form complete detector spectra or used individually as part of a spectral deconvolution algorithm.

In order to determine how a detector will respond to a photon source, such as an x-ray source or gamma ray source, such as a radioactive isotope, the first step is to determine how much energy will be deposited in the detector by each source photon. The energy deposited can be determined from pulse height tallies in the Monte Carlo N-Particle Transport (MCNP) [6] radiation simulation program.

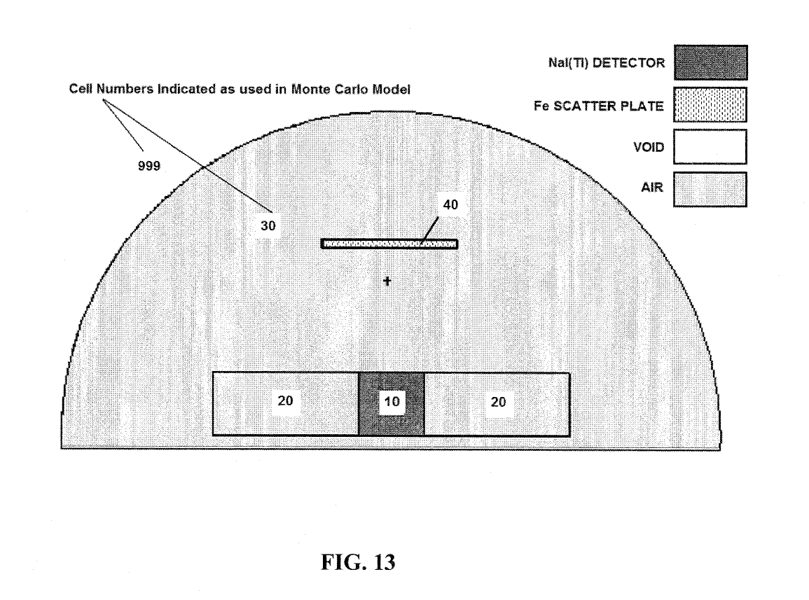

FIG. 13 shows the MCNP model corresponding to our NaI scintillation detector setup with scattering plate. Materials used include NaI detector crystal 10, Air 20, 30, iron plate or air 40, and a void 999. The sample is represented by a point source, 10.5 cm from the 5 cm square cylindrical NaI(T1) detector crystal. Simulations at a variety of source energies, as well as both with and without a 0.5 cm thick iron plate placed between the source and the detector were performed.

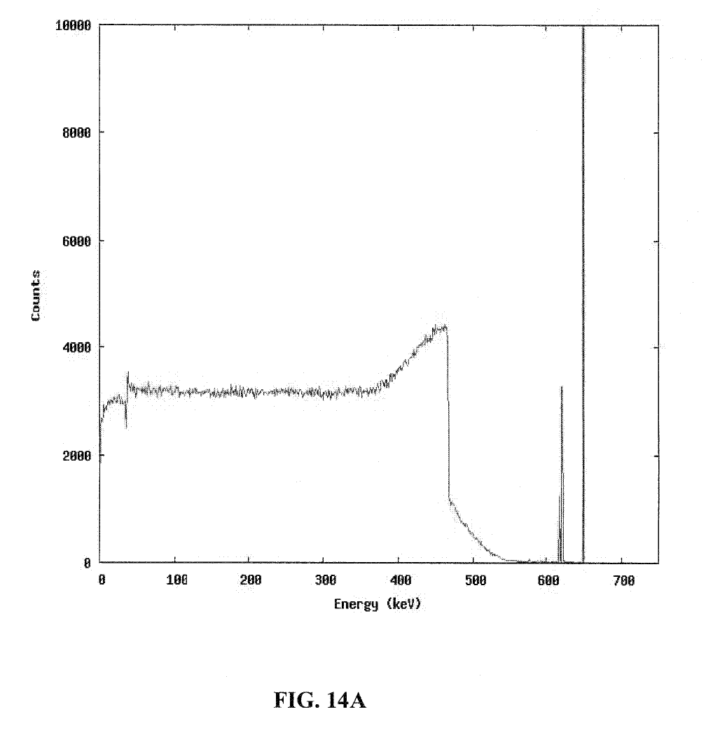

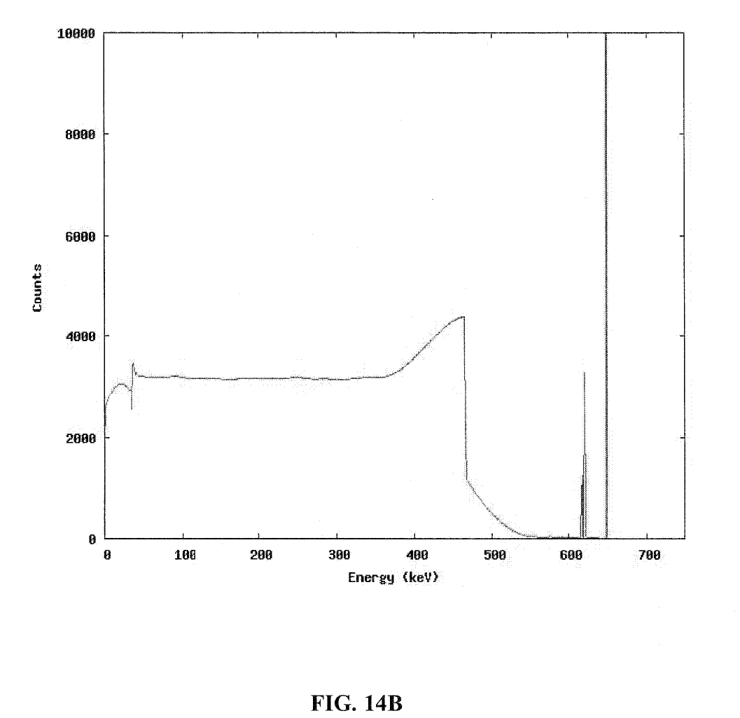

FIG. 14A shows a histogram of the amount of energy deposited in the detector crystal for each monte Carlo simulated 650 keV photon. FIG. 14A shows the Monte Carlo simulation of energy deposited per photon in a NaI(T1) scintillation detector from a 650 keV source. The full energy photopeak at 650 keV has a height of 1.45×10⁶ counts. A total of 1.2×10⁹ photons were simulated, many of which did not reach the detector. The iron plate was not included in this simulation. This plot has much sharper features than a real NaI scintillation detector spectrum because it does not include the effects of electronic broadening.

The simulation results in FIG. 14A required 1.2×10⁹ trials and about 10 hours of computer time. In order to simulate detector responses for radioactive isotopes, such results can be produced for a wide variety of source energies from 20 keV up to 3000 keV, leading to enormous amounts of computer time. Two techniques, denoising and interpolation, can be used to reduce the time requirements for radiation simulation. Denoising reduces the number of trials required for each simulation, and interpolation reduces the number of simulations required.

Like all Monte Carlo results, the data shown in FIG. 14A are random variables. The accuracy of these values can be improved by increasing the number of trials, but increasing the number of trials is computationally expensive. The denoising technique described above can provide similar results with much lower computational cost. FIG. 14B shows the results from applying an embodiment of an adaptive chi-processed (ACHIP) denoising algorithm to the MCNP pulse height tally of FIG. 14A. Only a few additional seconds of processing time was used by the adaptive chi-processed (ACHIP) denoising algorithm, compared with the ten hours it took to generate the original data in FIG. 14A.

In order to implement specific embodiments of the advanced synthetically enhanced detector response algorithm (ASEDRA), incorporating peak search capability, detector response functions for monoenergetic sources ranging from 20 keV to 3000 keV were generated. A specific embodiment provides the ability to choose source energies to within 1 keV. The sources can be simulated directly in MCNP. Another specific embodiment chooses source energies at 50 keV intervals, resulting in a factor of 50 reduction in computer time, and estimated response functions for intermediate energies by interpolation. Using inter-polation to reduce the computational cost of producing detector response functions is discussed further in section II.B of Meng and Ramsden [5], which in turn cites Kiziah and Lowell [14], both of which are incorporated by reference herein for their teachings on interpolation.

The accuracy of interpolation between response functions can be improved by transforming the response functions so that their features line up with features in the interpolated response function. Features to consider in the detector response functions can include one or more of the following: the photopeak, single and double escape peaks, the k-edge discontinuity, the backscatter peak, and the Compton edge. These features can change position as a function of source energy, as shown in Equation 4-1. It makes sense, then, to stretch each of the simulated response functions such that the known positions of such features line up with the known positions of the same features in the interpolated response function.

$${E}_{photopeak} = {E}_{source}$$

$${E}_{single \text{-} escape} = {E}_{source} - 511 keV ( if {E}_{source} > 1022 keV )$$

$${E}_{double \text{-} escape} = {E}_{source} - 1022 keV ( if {E}_{source} > 1022 keV )$$

$${E}_{backscatter} = \frac{511 keV}{2 + \frac{511 keV}{{E}_{source}}}$$

$${E}_{Compton} = {E}_{source} - {E}_{backscatter}$$

As an example, suppose that MCNP simulations have been performed for photon sources of 300 keV and 350 keV, yielding detector response functions ƒ₃₀₀ (E) and ƒ₃₅₀ (E), respectively. A simulation for a source of 310 keV is not available, but an estimate for ƒ₃₁₀ (145 keV) is needed. In an embodiment, the first step for estimating ƒ₃₁₀ (145 keV) is to characterize known features of the three response functions, as in Table 4-1.

TABLE 4-1
Detector response function features.

| Feature | f₃₀₀ | f₃₁₀ | f₃₅₀ |
|---|---|---|---|
| Photopeak | 300 | 310 | 350 |
| Single escape | — | — | — |
| Double escape | — | — | — |
| Compton edge | 162 | 170 | 202 |
| Backscatter peak | 138 | 140 | 148 |
| Zero | 0 | 0 | 0 |

On the ƒ₃₁₀ response function, 145 keV is between the backscatter peak at 140 keV and the Compton edge at 170 keV. More precisely, 145 keV is one-sixth of the way from the backscatter peak at 140 keV to the Compton edge at 170 keV. Similarly, 142 keV and 157 keV are one-sixth of the way from the backscatter peak to the Compton edge on the ƒ₃₀₀ and ƒ₃₅₀ response functions, respectively. Therefore, ƒ₃₁₀ (145 keV) can be estimated by linear interpolation between ƒ₃₀₀ (142 keV) and ƒ₃₅₀ (157 keV) as in Equation 4-2.

$$\begin{matrix}{f}_{310} ( 145 keV ) = ( \frac{{f}_{350} ( 157 keV ) - {f}_{300} ( 142 keV )}{350 keV - 300 keV} ) ( \begin{matrix}310 keV - \\ 300 keV\end{matrix} ) + \\ {f}_{300} ( 142 keV )\end{matrix}$$

An embodiment of ASEDRA incorporates an interpolation method that is a simplification of the method described in the previous paragraph and in Equation 4-2. This simplification can leads to a reduction in interpolation accuracy, but is more easily implemented and will likely run faster. Instead of noting, for the f310 response function, that that 145 keV is one-sixth of the way from the backscatter peak at 140 keV to the Compton edge at 170 keV, this embodiment of ASEDRA notes that 145 keV is 25 keV less than the Compton edge at 170 keV. Similarly, 137 keV and 177 keV are 25 keV less than the ƒ₃₀₀ and ƒ₃₅₀ Compton edges, respectively. Therefore, ƒ₃₁₀ (145 keV) can be estimated by linear interpolation between ƒ₃₀₀ (137 keV) and ƒ₃₅₀ (177 keV) as in Equation 4-3.

$$\begin{matrix}{f}_{310} ( 145 keV ) = ( \frac{{f}_{350} ( 177 keV ) - {f}_{300} ( 137 keV )}{350 keV - 300 keV} ) ( \begin{matrix}310 keV - \\ 300 keV\end{matrix} ) + \\ {f}_{300} ( 137 keV )\end{matrix}$$

This simpler interpolation method gives similar results to the earlier, more accurate interpolation method of Equation 4-2 when estimating the value for an energy which is close to a higher-energy feature. In the example, however, the value of ƒ₃₁₀ is estimated at 145 keV, which is very close to a lower-energy feature, the backscatter peak at 140 keV. Note that Equation 4-3 suggests that ƒ₃₁₀ (145 keV), which is between the backscatter peak and the Compton edge, is similar to ƒ₃₀₀ (137 keV), which is at a lower energy than the backscatter peak.

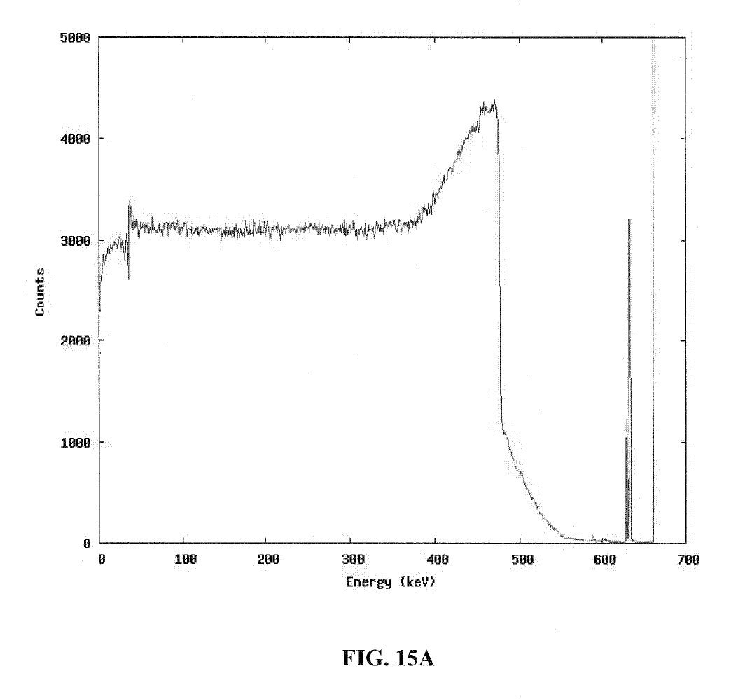

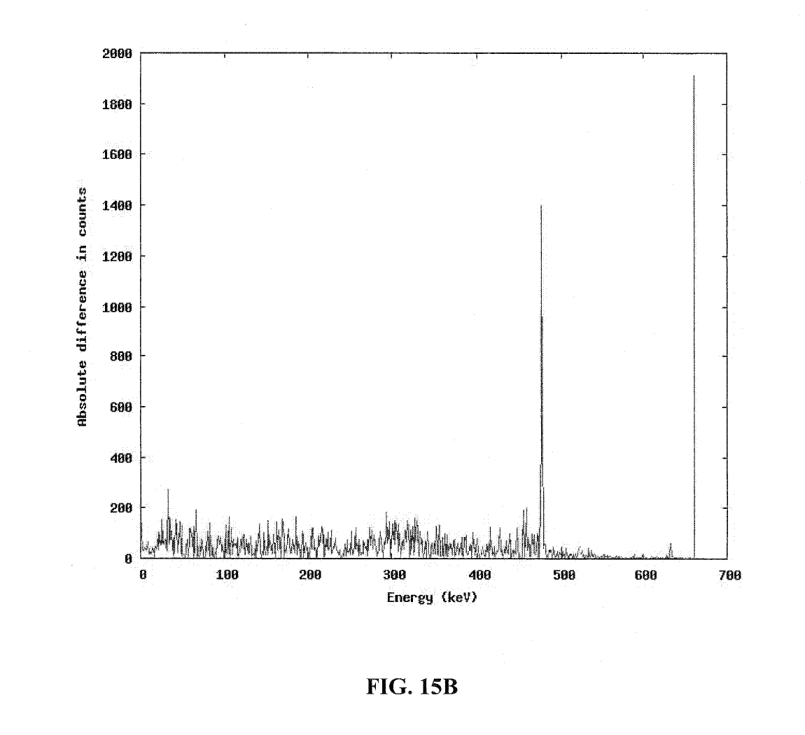

An embodiment of the simpler interpolation method of Equation 4-3 works well for the 662 keV response function shown in FIG. 15A, which shows an interpolated response function for a monoenergetic 662 keV source with a 1.4 million count photopeak. FIG. 15B shows the absolute interpolation error between the interpolated response function of FIG. 15A and a direct MCNP simulation for the same energy. Note that the largest absolute errors occur around sharp features in the spectrum: the photopeak, the x-ray escape peaks, and the Compton edge. The Compton edge in the interpolated spectrum is shifted by 1 keV in the high-energy direction because the interpolation method does not guarantee synchronization on the high-energy side of a feature. The detector has a FWHM of around 40 keV at this energy, so a large error in one channel near the Compton edge only has around a 1% effect on any channel after electronic broadening is considered. The error of 2000 counts at the photopeak is negligible compared to the 1.4 million counts in the photopeak. The Compton continuum has a far more significant error of around 3%, which can be attributed to nonlinearity in the NaI cross sections.

Other interpolation algorithms can be used in accordance with the invention, where some alternative interpolation algorithms may reduce interpolation error, such as with more sophisticated algorithms. In addition, significant reduction of interpolation error can be achieved by simulation of more source energies. Further embodiments can perform direct simulation of “interesting” source energies, such as the photopeak energies for nuclides of interest, to supplement the equally spaced source energies that have already been simulated. Another approach is to perform simulations at a much larger number of source energies, but with fewer histories per simulation, and deal with the resulting stochastic noise by applying a 2-D denoising algorithm to the entire library of detector response functions. This can increase accuracy by eliminating the need for interpolation.

The effect of electronic broadening on detector response functions can be approximated by a Gaussian transformation. The Gaussian distribution is defined in Equation 4-4. The Gaussian transformation is defined in Equation 4-5 and transforms counts C_{old} as a function of energy in a pulse heigh tally to counts C_{new}, as a function of energy in a realistic detector response function.

$$G ( x ; μ , σ ) = \frac{1}{σ \sqrt{2 π}} {e}^{- \frac{{( x - μ )}^{2}}{2 {σ}^{2}}} , where σ = FWHM / 2.35$$

$${C}_{new} ( x ) = {\sum }_{i} {C}_{old} ( i ) G ( x , i , {σ}_{i} )$$

In order to simulate a real detector with Equation 4-5, full-width half-max values for that detector are needed. Table 4-2 shows estimated full-width half-max values for photopeaks in several experimental spectra, including Cs-137, Co-60, and Ba-133. FWHM values for other energies can be estimated by linear interpolation between values in Table 4-2. Table 4-2. Detector resolution (full-width half-max) calibration data.

TABLE 4-2
Detector resolution (full-width half-max) calibration data.

| Energy (keV) | Width (keV) |
|---|---|
| 50.0 | 7 |
| 81.0 | 9 |
| 302.9 | 28 |
| 356.0 | 32 |
| 448.0 | 42 |
| 661.7 | 45 |
| 1173.2 | 68 |
| 1332.5 | 70 |

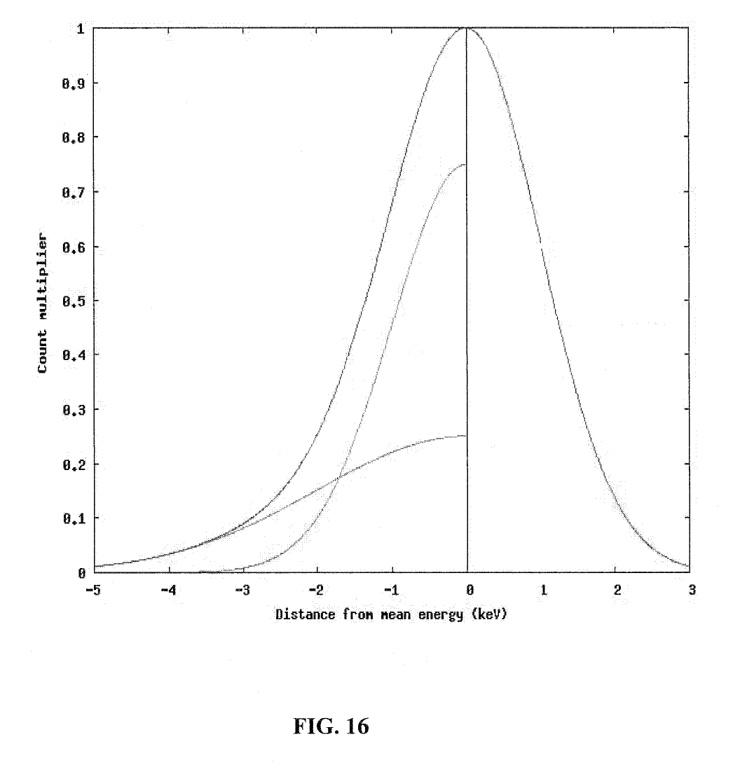

The Gaussian transformation described in Equation 4-5 works very well at energies greater than around 200 keV. At lower energies, however, photopeaks are noticeably skewed in the low-energy direction. A more complicated transformation, described in Equation 4-6 and illustrated in FIG. 16, compensates for such low-energy tailing with two additional parameters, Rₜₐᵢₗ and sₜₐᵢₗ (=FWHMₜₐᵢₗ/2.35), which control the prominance and length of the low-energy tail. Referring to FIG. 16, the right side is a Gaussian with standard deviation s, and the left side is the sum of two Gaussians with standard deviations s and s tail. The tailing ratio Rtail in this case is 0.25, meaning that the Gaussian with standard deviation s tail makes up one-quarter of the total height at the center.

$${C}_{new} ( x ) = {\sum }_{i} {C}_{old} ( i ) \{ \begin{matrix}G ( x ; i , {σ}_{i} ) ( 1 - {R}_{tail} ) + G ( x ; i , {σ}_{tail} ) {R}_{tail} , & if x < i \\ G ( x ; i , {σ}_{i} ) , & otherwise\end{matrix}$$

For a specific detector used during experiments discussed herein detector, Rₜₐᵢₗ is 0.25 and FWHMₜₐᵢₗ is 23 keV. After applying a transformation for electronic broadening, the detector response functions can be used individually or combined to simulate complete detector spectra for any incident gamma-ray spectrum.

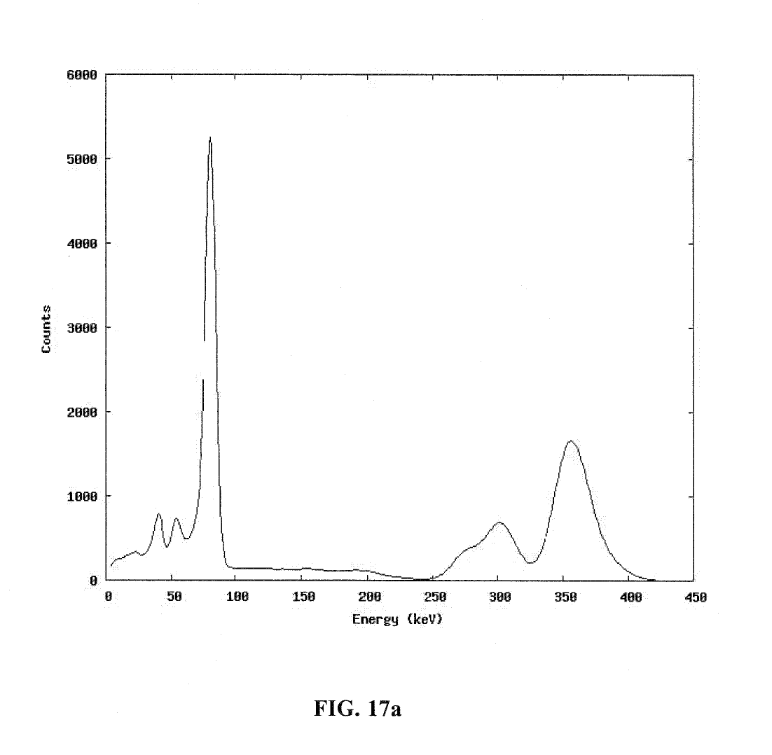

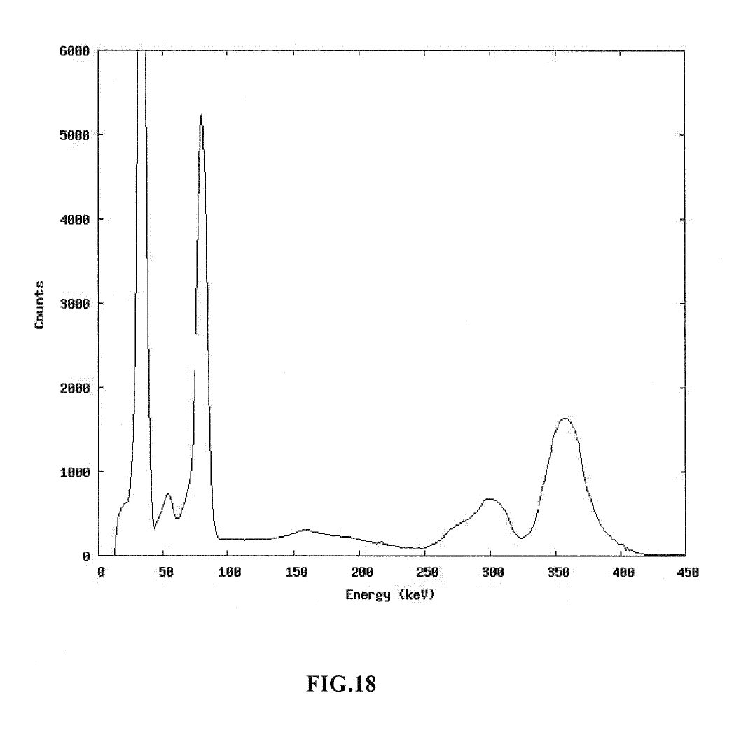

The detector response functions created after applying a transformation for electronic broadening can be combined to simulate complete detector spectra for any gamma source. Such spectra can be compared with experimental detector spectra to validate the detector response function generation technique. Spectra for isotopes that are not available can also be simulated to create a library of spectra. FIG. 17 shows a simulated detector spectrum for Ba-133, combining detector response functions for eight emission energies. For comparison, FIG. 18 shows a real measured detector spectrum for Ba-133 obtained with a 5 cm×5 cm square cylindrical NaI detector.

There are two significant differences between the simulated detector response in FIG. 17 and the measured detector response in FIG. 18. The measured detector response has a very large peak at 30 keV, while the simulated detector response has a much smaller peak at the same position. The measured detector response also has a small, broad peak at 160 keV.

Synthetically generated detector response functions can be used with embodiments of an Advanced Synthetically Enhanced Detector Resolution Algorithm (ASEDRA). Synthetically generated response functions for monoenergetic sources can be used as part of the peak search algorithm, allowing ASEDRA to strip away all of the secondary features associated with each identified photopeak. Synthetically generated response functions for complete nuclides can be used as sample data against which to test the algorithm.

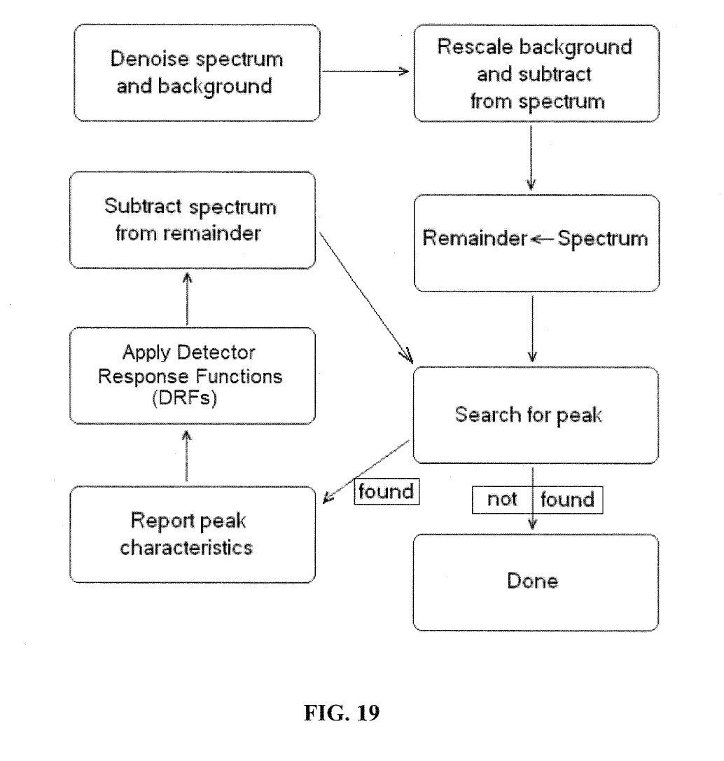

An embodiment of the invention relates to an advanced synthetically enhanced detector response algorithm (ASEDRA) that incorporates removing stochastic noise from spectra, simulation of monoenergetic detector response functions, and simulation of complete detector spectra for peak searching. Embodiments of ASEDRA can break the problem of spectral deconvolution into smaller problems and solve each problem individually, as shown in FIG. 19, which shows a flow chart for an embodiment of ASEDRA. First, the adaptive chi-processed (ACHIP) denoising algorithm is applied to both measured spectra: the sample spectrum and the background spectrum. Then, the background spectrum is subtracted from the sample spectrum. Finally, the problem of deconvolving photo-peaks from the sample is solved by a recursive algorithm that finds and strips away one photopeak at a time.

Background spectra usually have higher counting times than sample spectra, so the number of counts in a background spectrum are scaled down accordingly before background subtraction. The resealing and subtraction can be performed as described by Equation 5-1. The significance factor should ordinarily be set to 1.0, but may be increased to account for uncertainty in the background spectrum due to environmental changes. The channel index is represented by i.

(Sample_{new})ᵢ=(Sample_{old})ᵢ−(Background)ᵢ(SignificanceFactor)·Timeₛₐₘₚₗₑ/Time_{background}

A copy of the sample spectrum is created to represent the portion of the sample spectrum that has not yet been attributed to incident radiation; that copy is called the remainder.

The ASEDRA algorithm searches for a photopeak. An embodiment can start searching for a photopeak at the high energy end of the remainder spectrum. An embodiment of ASEDRA can identify, as a photopeak, the first channel to meet two criteria. The criterion is that the remainder has more counts at that channel than at any other channel within a distance of half of the full-width half-max. The second criterion is that the number of counts in the remainder at that channel is greater than T_{abs}+Sᵢ·Tᵣₑₗ/100, where T_{abs} is the absolute threshold, Sᵢ is the counts in the sample spectrum for that channel, and Tᵣₑₗ is the relative threshold.

If no peak is found, then the ASEDRA algorithm terminates. Otherwise, if a peak is found, its position and height is characterized. The position is the channel that met the two described criteria. The height of the photopeak is the number of counts in the remainder at that channel. After the photopeak is characterized, a detector response function for that peak is generated and subtracted from the remainder spectrum. Then the peak search starts over with the new remainder.

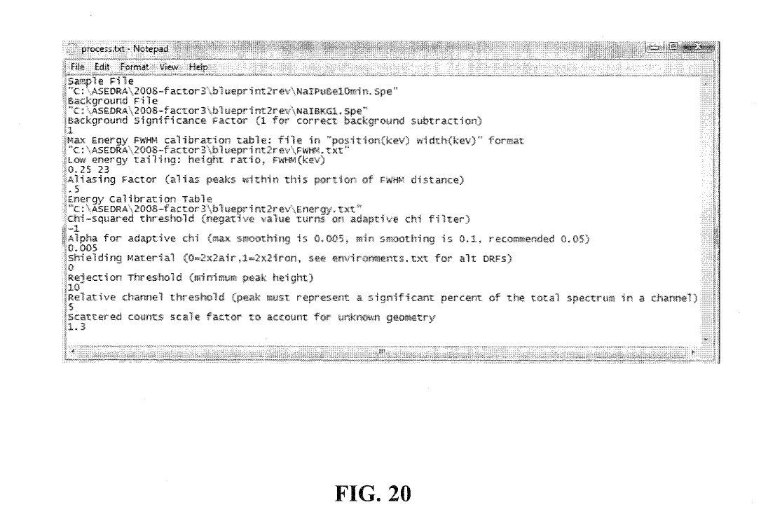

A specific embodiment of the ASEDRA program uses five input files: settings, sample spectrum, background spectrum, resolution calibration, and energy calibration. The settings file is always called “process.txt.” An example of a “process.txt” settings file is shown in FIG. 20.

The first two settings in “process.txt” are pathnames for the sample and background spectra. These two files use the Maestro file format to represent count times, counts as a function of channel, and other information related to measured detector spectra.

The third setting in “process.txt” is the background significance factor, a floating-point scale factor, which is used in Equation 5-1. The background significance factor is ordinarily set to 1.0, but can be adjusted to compensate for changes in background radiation levels. In this case, a setting of 0.0 completely turns off background subtraction.

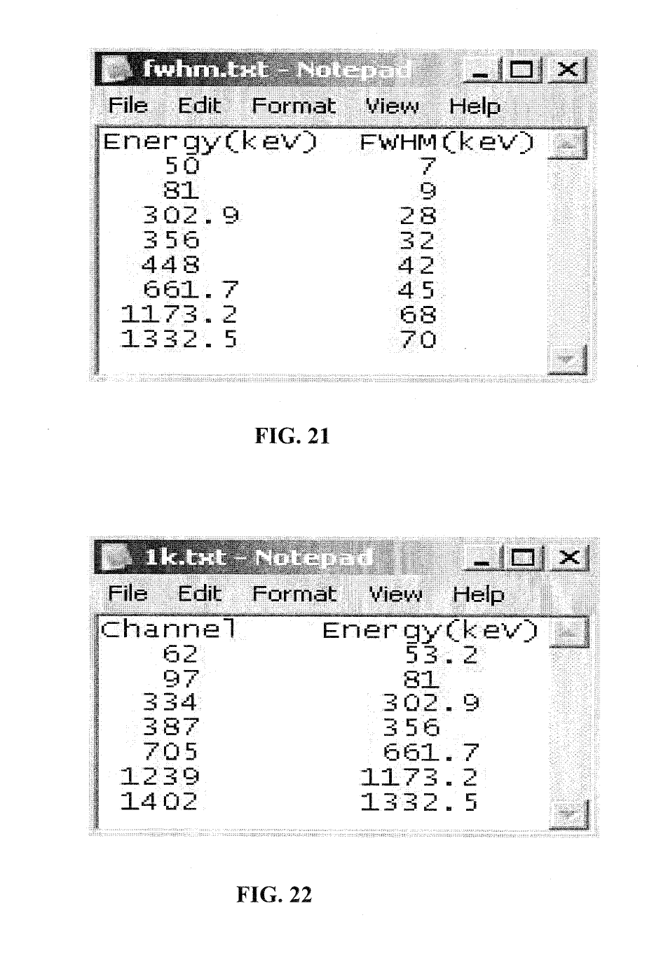

The fourth setting in “process.txt” is the pathname for the resolution calibration, which in this case is set to “fwhm.txt.” An example resolution calibration file, shown in FIG. 21, has two columns representing energy and full-width half-max. This file provides resolution information at various energies, and ASEDRA fills in the gaps by linear interpolation between adjacent points.

The fifth setting in “process.txt” is a pair of tailing parameters, Rₜₐᵢₗ and FWHMₜₐᵢₗ, that are described herein.

The sixth setting in “process.txt” is the pathname for the energy calibration, which in this case is set to “1k.txt.” An example energy calibration file, shown in FIG. 22, has two columns representing channel and energy. This file indicates the energy, in keV, associated with various channels, and the embodiment of ASEDRA being implemented fills in the gaps by linear interpolation between adjacent points.

The seventh setting in “process.txt” controls denoising. A positive value becomes the chi-squared threshold described herein and turns on the CHIP denoising algorithm A value of 0 completely turns off denoising, and a negative value turns on the ACHIP denoising algorithm, which is described herein. If the ACHIP algorithm is turned on, the eighth setting controls the value of a, which is the probability for any given channel that stochastic noise will be treated as a real feature. Smaller values of a allow more denoising, but may also lead to real features being smoothed away. Note that the certainty described herein is equal to 1−a.

The ninth setting in “process.txt” indicates the material for a shield placed between the sample and detector. For this embodiment of ASEDRA, (0) indicates air and (1) indicates iron. Additional Monte Carlo N-particle (MCNP) simulations can be performed to produce input to be used for other material types.

The tenth and eleventh settings in “process.txt” are the absolute (T_{abs}) and relative (Tᵣₑₗ) thresholds that were described as part of the peak search algorithm. Specific embodiments of ASEDRA can ignore any peaks shorter than the absolute threshold or shorter than the total spectrum multiplied by the relative threshold (as a percent).

Sometimes, actual environmental conditions are different than those that were used in the MCNP simulations. The final setting, a scattered count scale factor provides a way to adjust the number of non-photopeak counts in generated detector response functions to account for scattering in the environment. A negative setting tells ASEDRA to perform the adjustment automatically. The value of 1 can turn off this feature.

### Example 1

The following illustration shows an approximation of an actual ASEDRA analysis for a synthetically generated Ba-133 spectrum and demonstrates the details of how a specific embodiment of the ASEDRA algorithm works. This analysis used the input files presented in FIGS. 20, 21, and 23, in which both denoising and background subtraction are turned off. Actual ASEDRA results are shown in later examples.

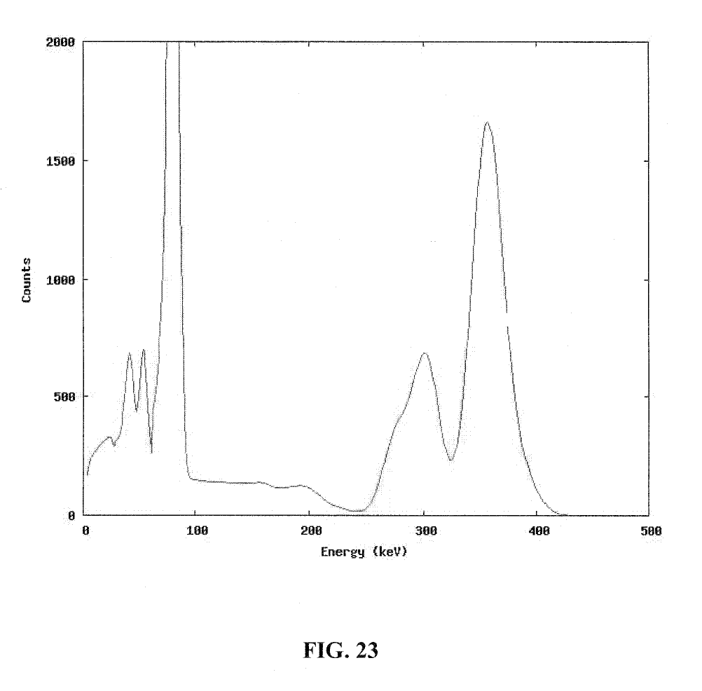

The original measured spectrum is shown in FIG. 23, which shows a synthetically generated Ba-133 sample spectrum, and starts out equal to the remainder spectrum. There are eight local maxima points on the spectrum. Of those local maxima, the highest energy is at 356 keV. The height of the remainder spectrum at that point is 1650 counts, so the first identified peak is characterized as having a photopeak energy of 356 keV and a peak height of 1650 counts.

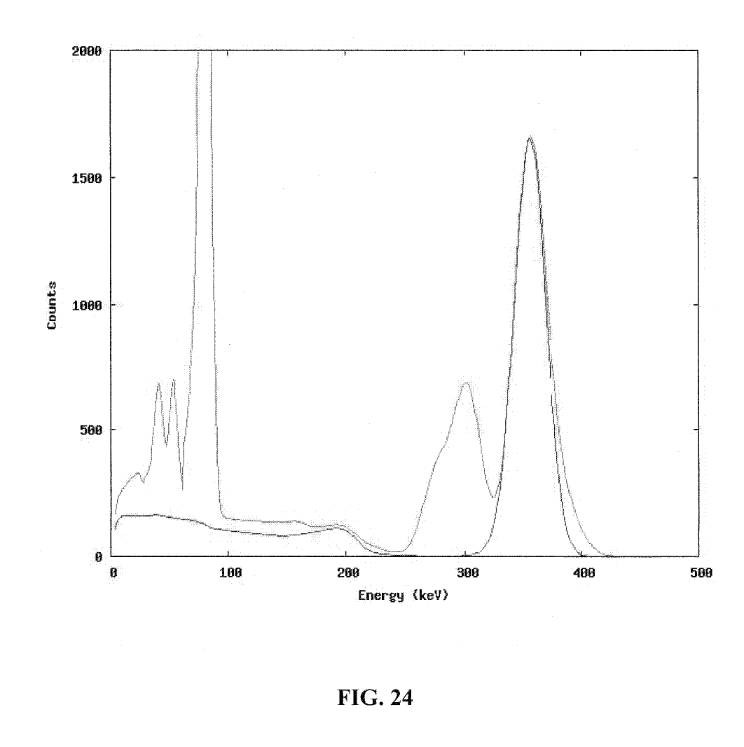

The detector response function for the first identified photopeak is shown in FIG. 24. Referring to FIG. 24, the remainder spectrum is shown in blue and is identical to the original sample spectrum. The first identified peak is shown in red. Note that the local maximum near 200 keV in the original measured spectrum is due to the Compton edge of this 356 keV photopeak.

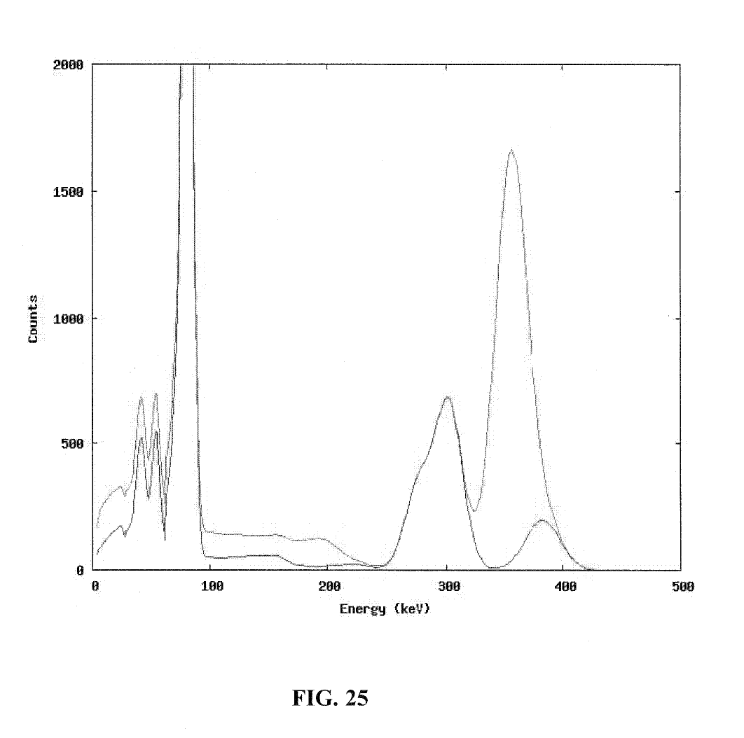

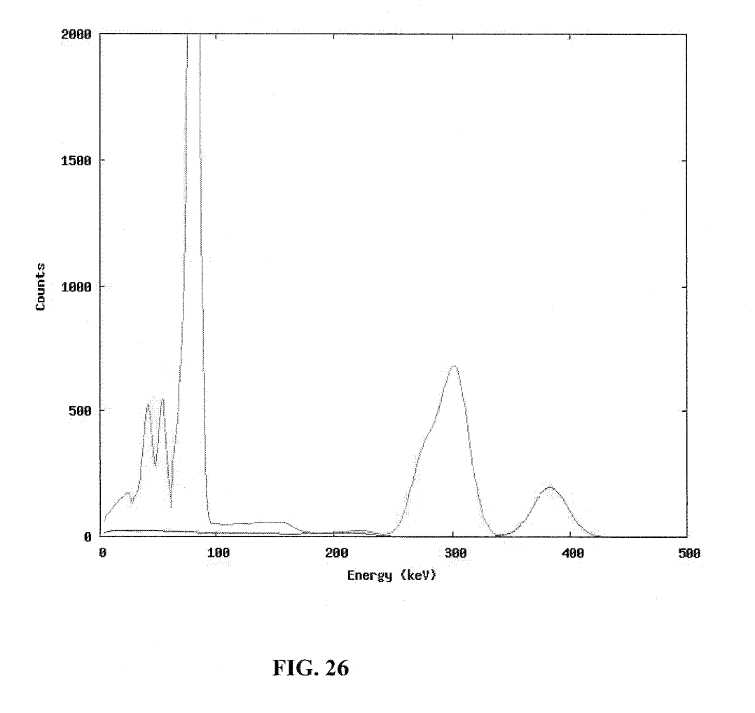

The 356 keV photopeak is subtracted from the remainder spectrum, yielding a new remainder spectrum that is shown in FIG. 25. Referring to FIG. 25, the original sample spectrum is shown in blue, and the remainder spectrum, after subtracting the first identified peak, is shown in red. The highest-energy local maximum in the remainder is at 384 keV. The remainder has 196 counts at that energy, so a second peak is identified with an energy of 384 keV and a height of 196 counts, as shown in FIG. 26. Referring to FIG. 26, the remainder spectrum is shown in blue, and the second identified peak is shown in red.

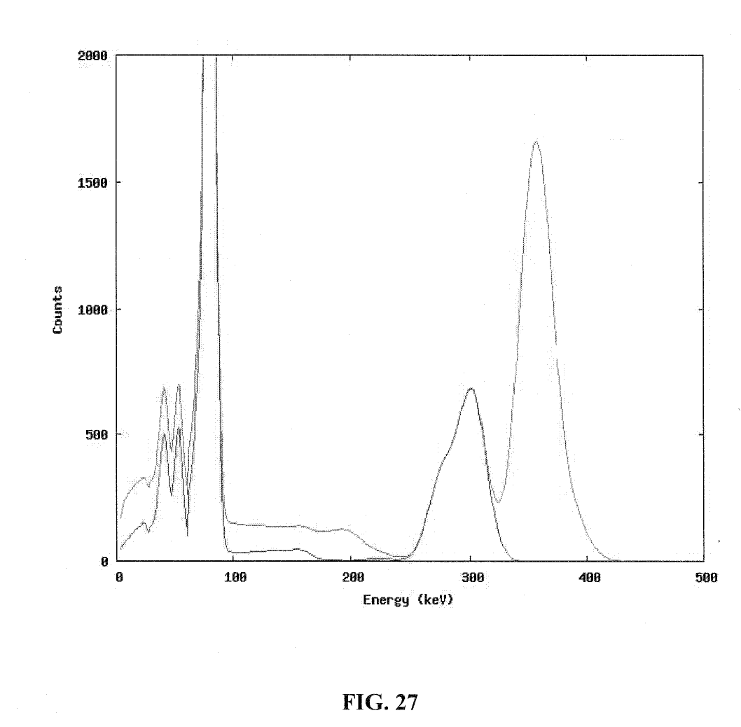

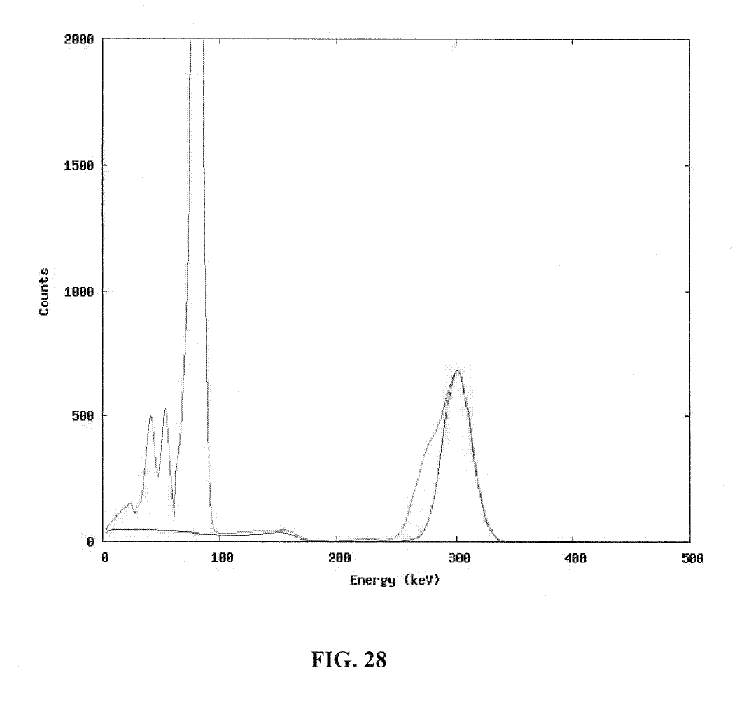

The 384 keV photopeak is subtracted from the remainder spectrum, yielding a new remainder spectrum that is shown in FIG. 27. Referring to FIG. 27, the original sample spectrum is shown in blue, and the remainder spectrum, after subtracting the first two identified peaks, is shown in red. The highest-energy local maximum in the remainder is at 301 keV. The remainder has 681 counts at that energy, so a third peak is identified with an energy of 301 keV and a height of 681 counts, as shown in FIG. 28. Referring to FIG. 28, the remainder spectrum is shown in blue, and the third identified peak is shown in red.

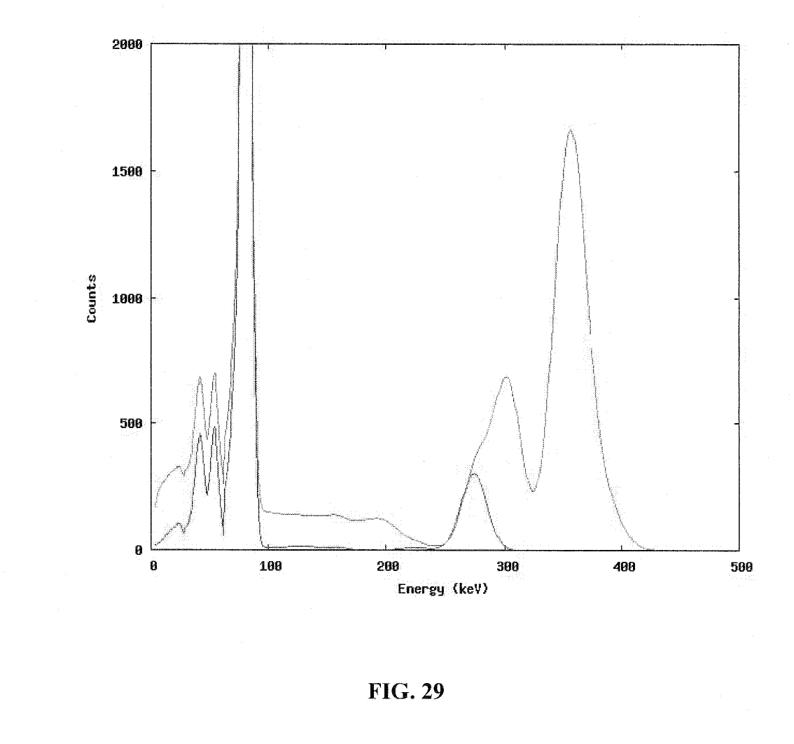

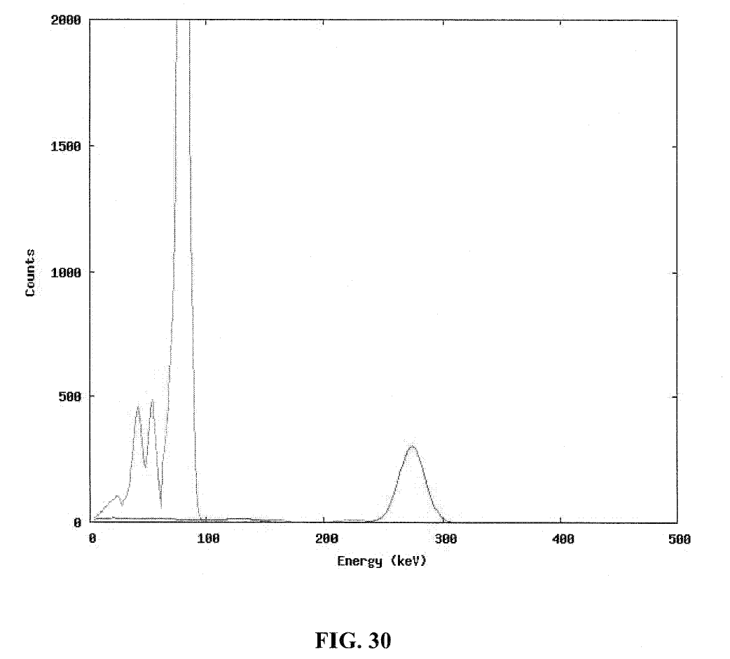

The 301 keV photopeak is subtracted from the remainder spectrum, yielding a new remainder spectrum that is shown in FIG. 29. Referring to FIG. 29, the original sample spectrum is shown in blue, and the remainder spectrum, after subtracting the first three identified peaks, is shown in red. The highest-energy local maximum in the remainder is at 275 keV. The threshold is 46.6 counts, ten counts plus 10% of the 366 counts at 275 keV in the original measured spectrum. The remainder has 301 counts at 275 keV, which is higher than the threshold value of 46.6 counts, so a fourth peak is identified with an energy of 275 keV and a height of 301 counts, as shown in FIG. 30. Referring to FIG. 30, the remainder spectrum is shown in blue, and the fourth identified peak is shown in red.

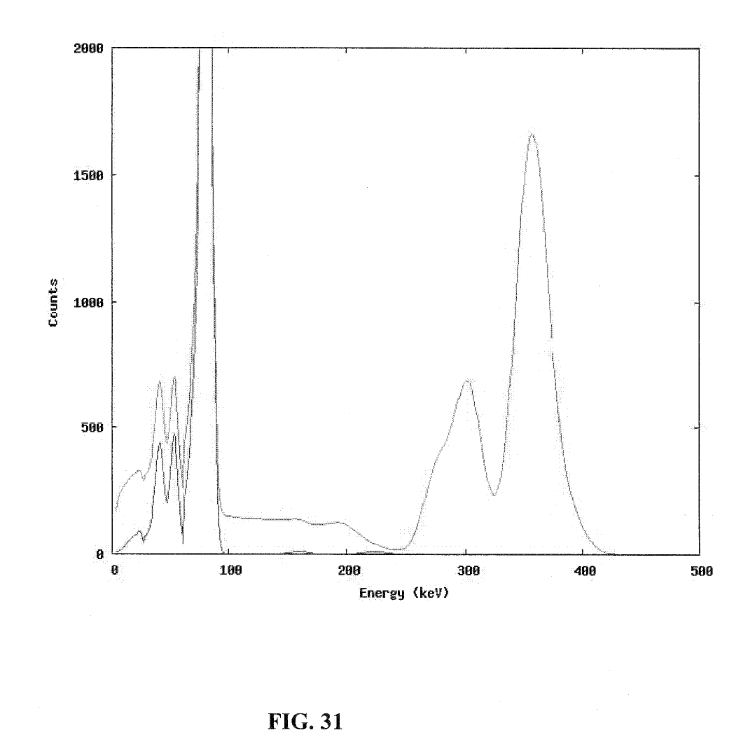

The 275 keV photopeak is subtracted from the remainder spectrum, yielding a new remainder spectrum that is shown in FIG. 31. Referring to FIG. 31, the original sample spectrum is shown in blue, and the remainder spectrum, after subtracting the first four identified peaks, is shown in red. The highest-energy local maximum in the remainder is at 223 keV. The threshold is 14 counts, ten counts plus 10% of the 40 counts at 223 keV in the original measured spectrum. The remainder has ten counts at 223 keV, which is lower than the threshold value of 14 counts, so this local maximum is not identified as a photopeak.

The next highest-energy local maximum in the remainder is at 161 keV. The threshold is 23.6 counts, ten counts plus 10% of the 136 counts at 161 keV in the original measured spectrum. The remainder has ten counts at 161 keV, which is lower than the threshold value of 23.6 counts, so this local maximum is not identified as a photopeak.

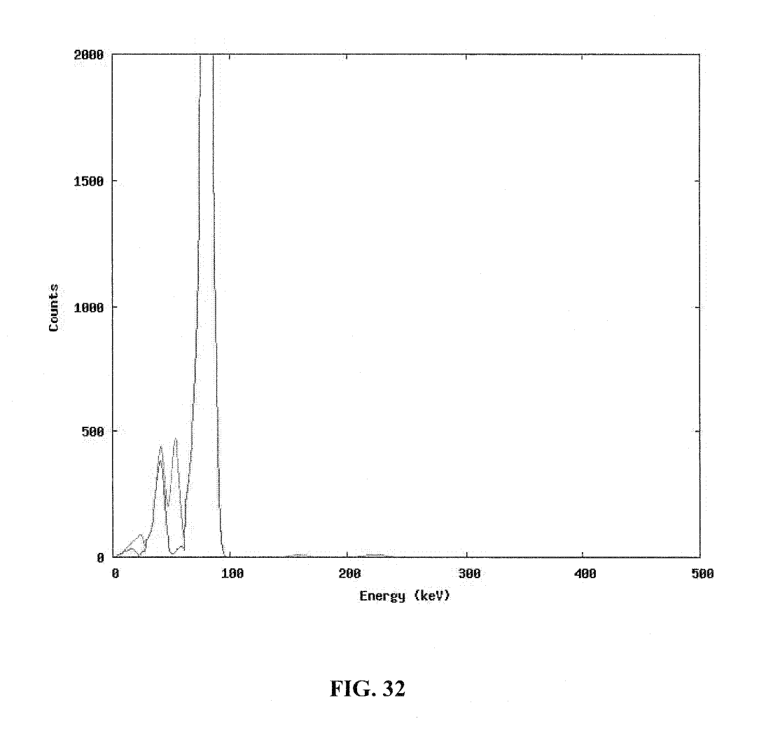

The next highest-energy local maximum in the remainder is at 81 keV. The threshold is 538 counts, ten counts plus 10% of the 5280 counts at 81 keV in the original measured spectrum. The remainder has 5100 counts at 81 keV, which is higher than the threshold value of 538 counts, so a fifth peak is identified with an energy of 81 keV and a height of 5100 counts, as shown in FIG. 32. Referring to FIG. 32, the remainder spectrum is shown in blue, and the fifth identified peak is shown in red.

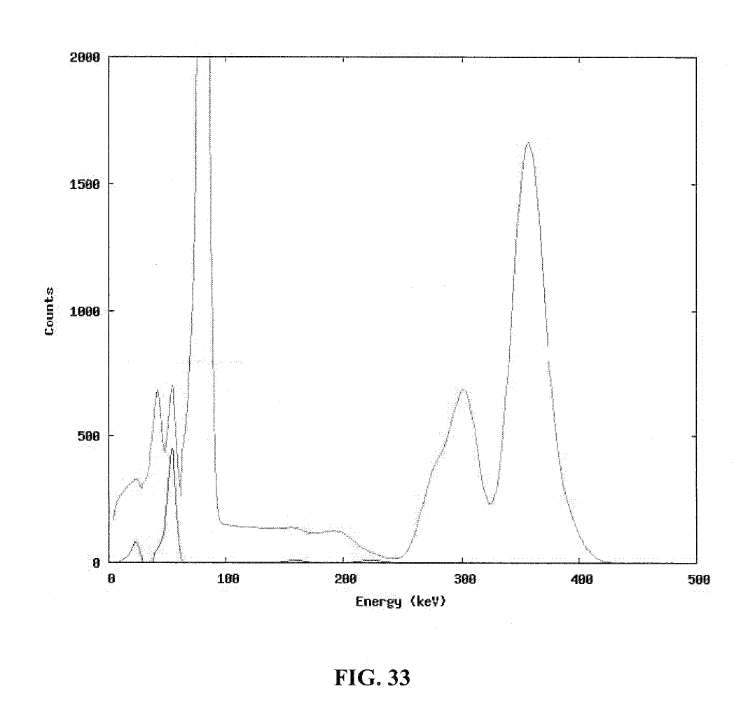

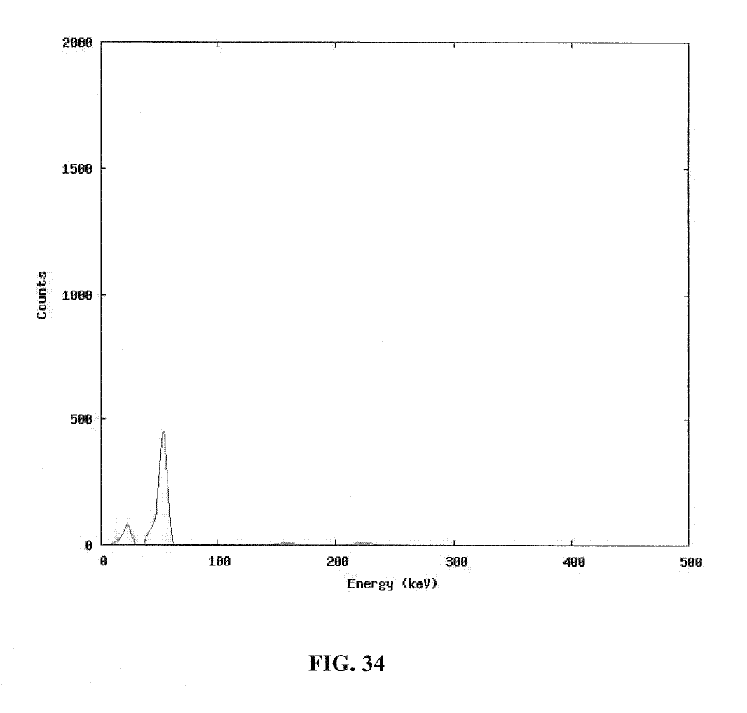

The 81 keV photopeak is subtracted from the remainder spectrum, yielding a new remainder spectrum that is shown in FIG. 33. Referring to FIG. 33, the original sample spectrum is shown in blue, and the remainder spectrum, after subtracting the first five identified peaks, is shown in red. The highest-energy local maxima in the remainder are at 161 keV and 223 keV, at which the remainder heights of ten counts and ten counts are lower than the threshold values of 23.6 counts and 14 counts. The next highest-energy local maximum in the remainder is at 53 keV. The threshold is 79.9 counts, ten counts plus 10% of the 699 counts at 53 keV in the original measured spectrum. The remainder has 450 counts at 53 keV, which is higher than the threshold value of 79.9 counts, so a sixth peak is identified with an energy of 53 keV and a height of 450 counts, as shown in FIG. 34. Referring to FIG. 34, the remainder spectrum is shown in blue, and the sixth identified peak is shown in red.

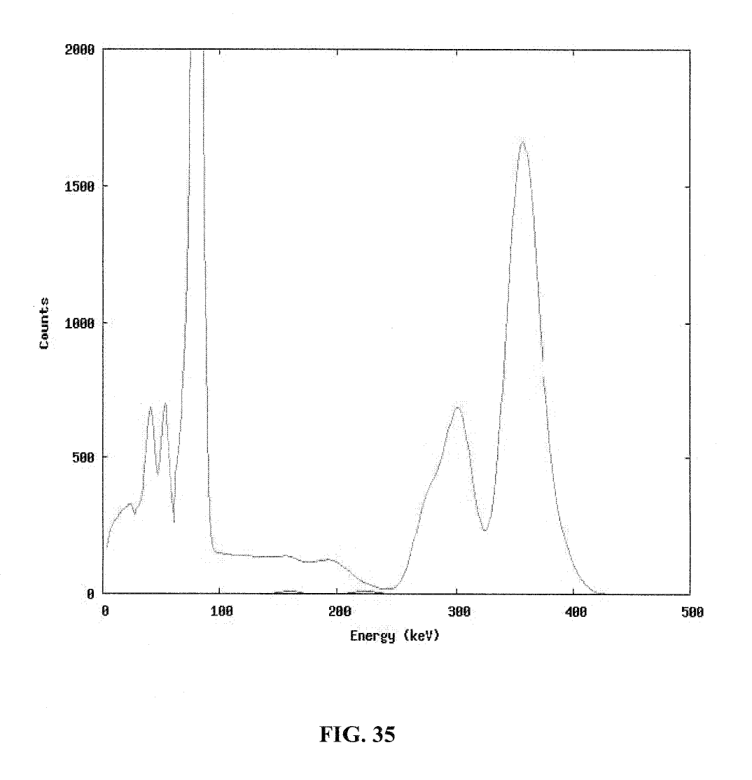

The 53 keV photopeak is subtracted from the remainder spectrum, yielding a new remainder spectrum that is shown in FIG. 35. Referring to FIG. 35, the original sample spectrum is shown in blue, and the he remainder spectrum, after subtracting all six identified peaks, is shown in red. No additional peaks can be identified because the remaining peaks at 161 keV and 223 keV are below the threshold for peak identification. There are two local maxima in the remainder at 161 keV and 223 keV, at which the remainder heights of ten counts and ten counts are lower than the threshold values of 23.6 counts and 14 counts. Therefore, the ASEDRA algorithm can not find any additional photopeaks.

This example describes how a specific embodiment of the ASEDRA algorithm works, bringing together capabilities such as denoising and response function generation for the purpose of spectral deconvolution. The following three examples show how that algorithm performs on a variety of example spectra.

A variety of factors can complicate analysis of experimental detector responses: background radiation, stochastic noise, uncertainties in the detector responses for monoenergetic components, variability in scatter or shielding from the surrounding environment, and uncertainty in the sample composition. One or more of these complicating factors can be removed by testing the advanced synthetically enhanced detector resolution algorithm (ASEDRA) against simulated detector responses, as described herein, so that any error is attributable solely to the peak search algorithm. Such complicating factors can be brought back into the picture so that ASEDRA's overall performance can be analyzed to determine which complicating factors have the greatest impact on ASEDRA's performance.

### Example 2

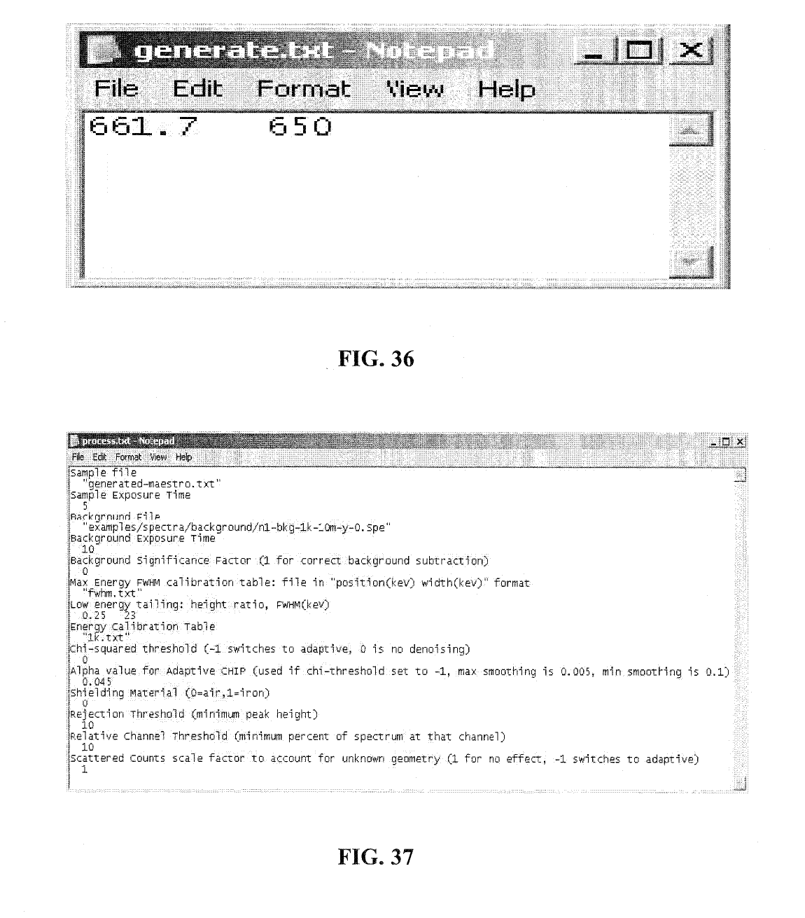

Cesium-137, or Cs-137, provides a very simple example for peak search because it has only one visible photopeak. A Cs-137 detector spectrum can be simulated with the spectral generator described herein used to produce the simulated detector response of FIG. 17, and the sample description in FIG. 6-1, which indicates that there is a single peak at 661.7 keV with a height of 650 counts. Referring to FIG. 36, with respect to the input file for generating a simulated Cs-137 detector response function, the first column lists the energies, in keV, of the photopeaks, and the second column lists the photopeak heights in counts.

The process.txt input file providing input settings for simulated Cs-137 for this example, as shown in FIG. 37, provides information about the sample and the detector, indicates where other input files can be found, and allows some tuning of ASEDRA's behavior. Each of the input parameters found in process.txt is described herein. In this case, the background significance factor is set to 0 so that the background file will be ignored. This setting makes sense for a synthetically simulated spectrum, for which there is no background. In this example, the chi-squared threshold is set to 0, which turns off denoising, because the spectra in this section have no stochastic noise.

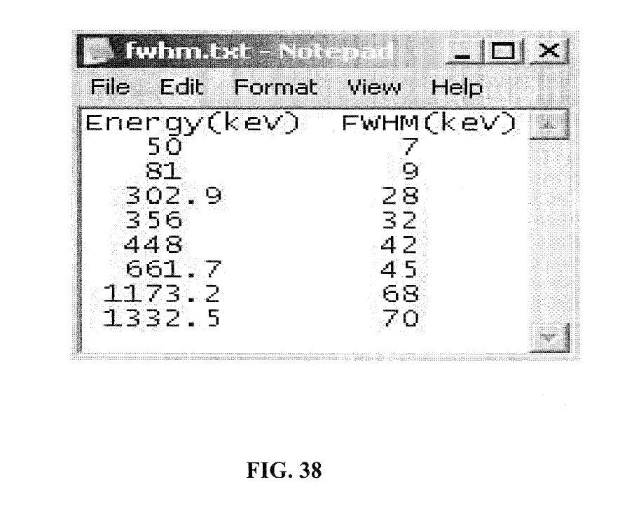

Resolution for a particular detector varies as a function of energy. The full-width half-max calibration function, measured in keV and provided as a function of energy (keV), is defined in the file fwhm.txt, as indicated by process.txt. The FWHM calibration file is shown in FIG. 38, which provides detector resolution calibration data.

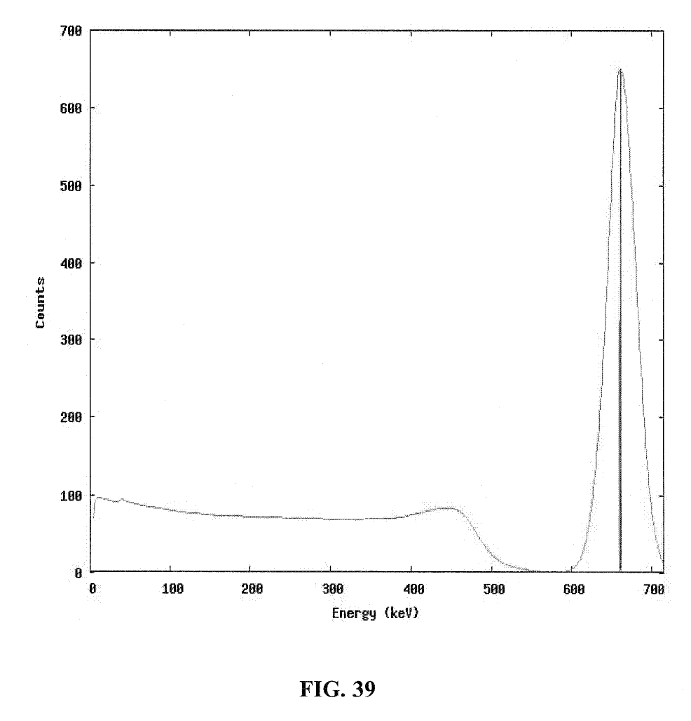

The spectral deconvolution process for the simulated Cs-137 spectrum in FIG. 39 has only a few simple steps. Advanced synthetically enhanced detector resolution algorithm (ASEDRA) results overlaid on the original simulated Cs-137 detector response function. The simulated response function is shown in red. ASEDRA found only one peak, at 661 keV, which is shown as a red line whose height indicates the height of the identified photopeak. First, ASEDRA scans the spectrum, starting at the high energy end, searching for a channel that meets the following conditions: more counts than any other channel within one FWHM, more counts than the rejection threshold, and more counts than the relative channel threshold times the number of counts in the original spectrum at that channel divided by one hundred. The first channel to meet all three of these conditions is at 662 keV, and ASEDRA reports a photopeak at that location with a height equal to the counts per channel at the photopeak's centroid. Next, ASEDRA creates a matching 662 keV detector response function as in described herein and subtracts that detector response function from the spectrum. Peak search is repeated on the remainder, but this time no channels match the conditions for finding a photopeak. Accordingly, the peak search is complete.

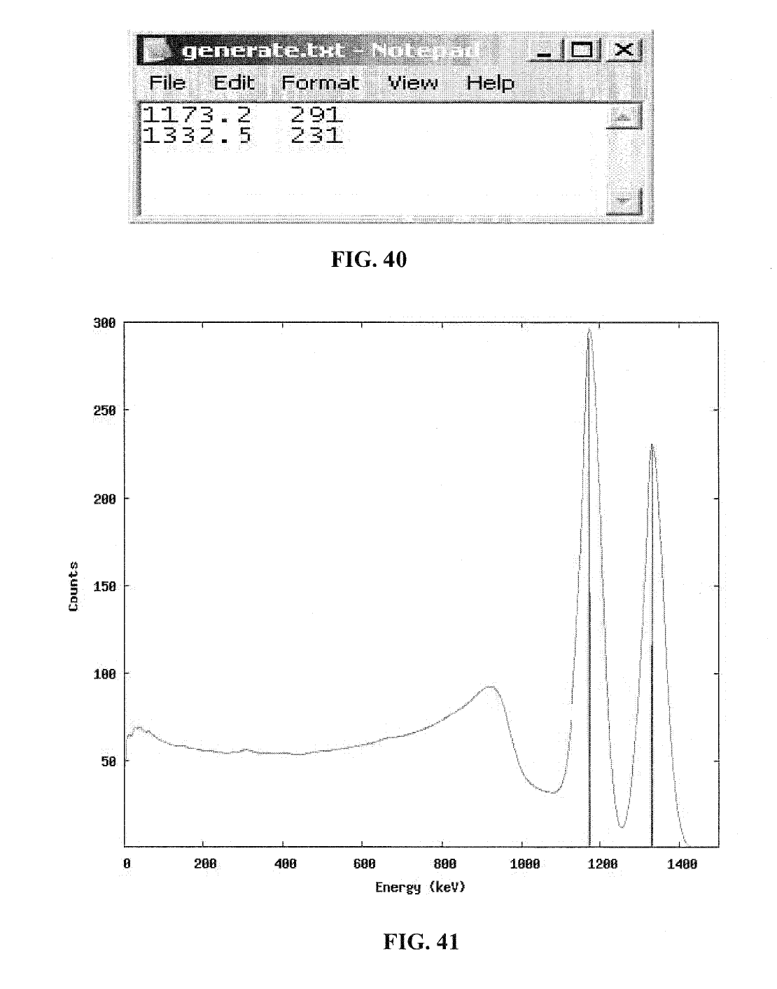

Cobalt-60, or Co-60, has two photopeaks at 1173 keV and 1332 keV, as shown in FIG. 40. FIG. 40 shows the input file for generating a simulated Co-60 detector response function. The first column lists the energies, in keV, of the photopeaks. The second column lists the photopeak heights in counts. After the first peak at 1332 keV is found and subtracted from the spectrum (ASEDRA starts at the high energy end), the peak search continues on the remainder. Next, ASEDRA finds the 1173 keV photopeak and subtracts it as well. Finally, the remainder contains no channels which meet the conditions for identifying a photopeak, and the deconvolution process is complete. The results are shown in FIG. 41, where the advanced synthetically enhanced detector resolution algorithm (ASEDRA) results overlaid on the original simulated Co-60 detector response function. ASEDRA found both peaks: 1173 keV and 1332 keV.

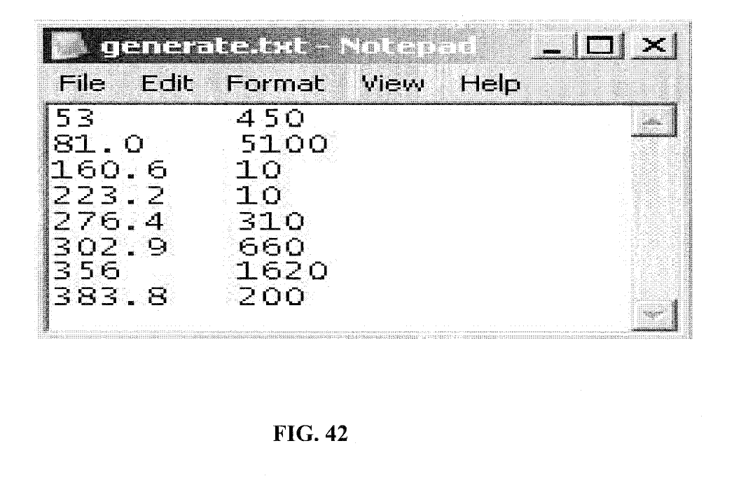

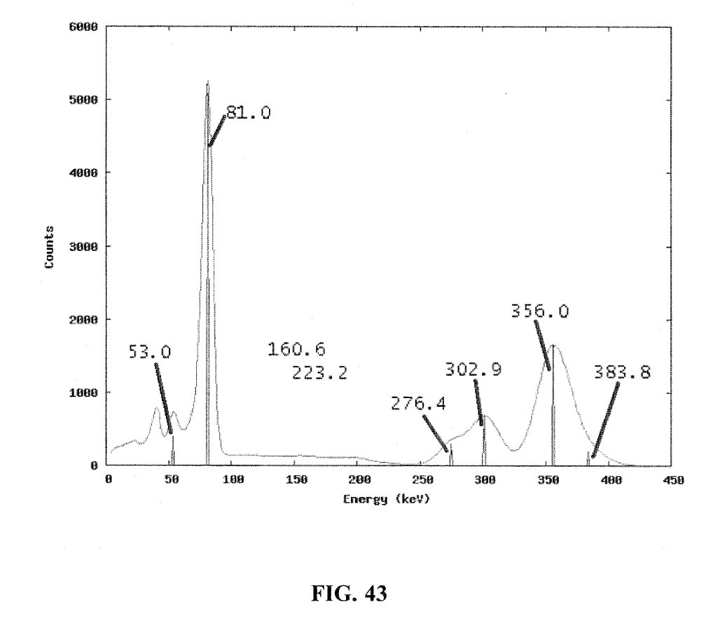

Barium-133, or Ba-133, presents a more interesting case study: six photopeaks, some of which are overlapping. FIG. 42 shows the input file for generating a simulated Ba-133 detector response function. The first column lists the energies, in keV, of the photopeaks. The second column lists the photopeak heights in counts. The two highest energy peaks are at 356 keV and 384 keV. Note in FIG. 43 that these two peaks are overlapping. Referring to FIG. 43, the advanced synthetically enhanced detector resolution algorithm (ASEDRA) results are overlaid on the original simulated Ba-133 detector response function. ASEDRA found all of the photopeaks, including the overlapping peaks at 276/303 keV and 356/384 keV. Although the highest energy photopeak is at 384 keV, the photopeak at 356 keV is found first. After the 356 keV peak is found and stripped away, the 384 keV peak is exposed and can be found next.

These examples show that, given ideal conditions, the ASEDRA algorithm performs very well. Complications are added gradually in the following examples, demonstrating how ASEDRA copes with each challenge.

Advanced synthetically enhanced detector resolution algorithm (ASEDRA) performed very well with simulated spectra in Examples 2-4. Next, ASEDRA's response to noise by adding stochastic noise to the example spectra is discussed.

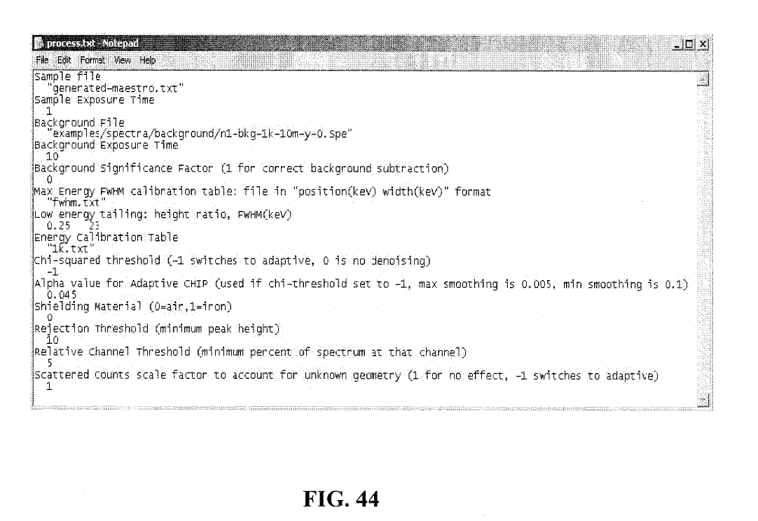

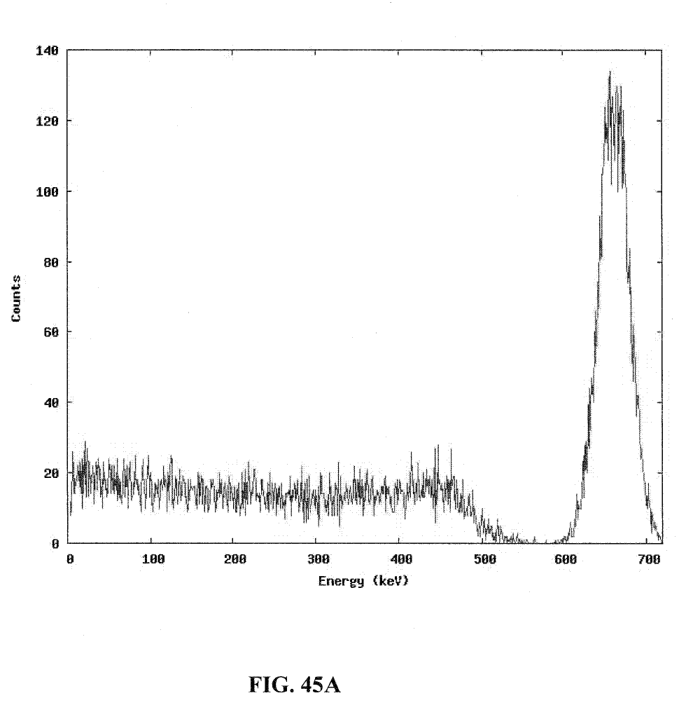

The process.txt file in FIG. 44 is changed only slightly from the previous examples. Adaptive chi-processed (ACHIP) denoising is turned on by setting the chi-squared threshold to −1. The alpha(a) parameter indicates the relative importance of removing noise and preserving real features. Further discussion of a can be found herein.

Referring to FIG. 44, adaptive denoising is turned on by setting the chi-squared threshold to −1. All other settings are identical to the settings in the previous examples.

Counts in each channel of the example spectra from the previous examples are randomly shifted according to a Poisson probability distribution. Ideally, the ACHIP denoising algorithm should completely remove the effects of that noise. Preferably, ASEDRA can cope with the difference of the ACHIP algorithm performance from ideal.

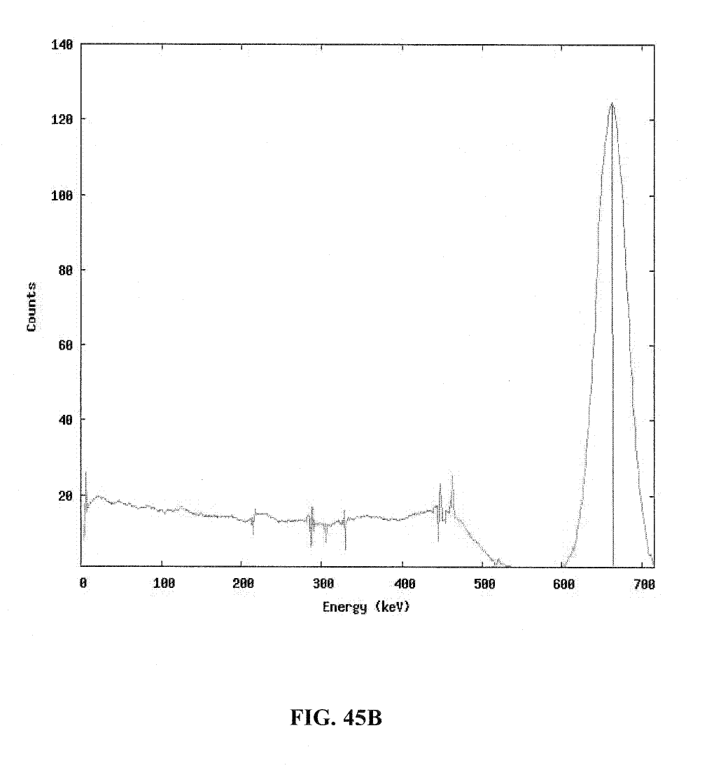

The Cs-137 response function, with Poisson noise added, is shown in FIG. 45A, where the response function is simulated in about one minute. The results of denoising, followed by spectral deconvolution, are shown in FIG. 45B. Referring to FIG. 45B, the advanced synthetically enhanced detector resolution algorithm (ASEDRA) results are overlaid on the denoised version of the simulated Cs-137 detector response function in FIG. 45A. ASEDRA found the only photopeak at 661 keV. ACHIP denoising removed most of the stochastic noise, and ASEDRA correctly identified the photopeak at 661 keV.

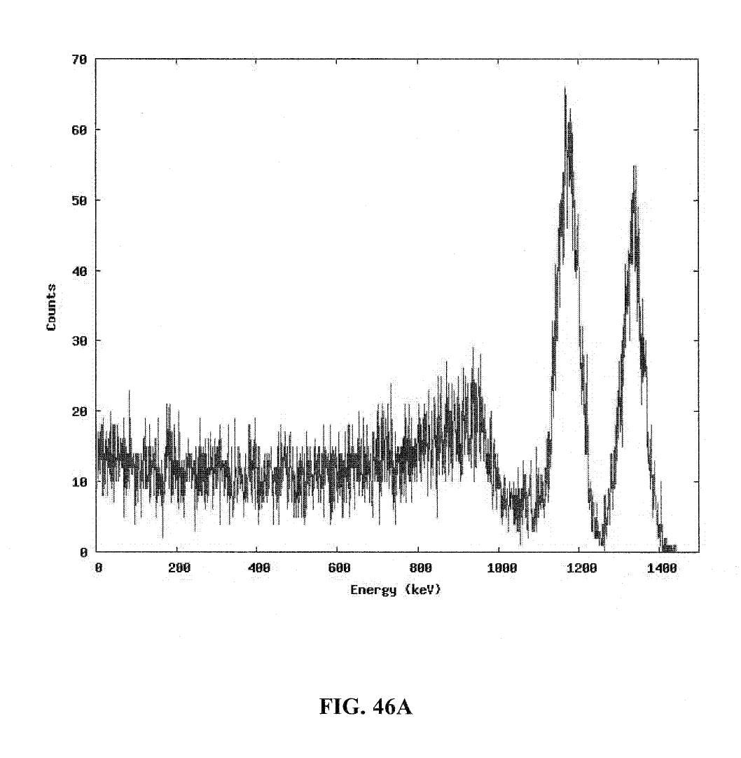

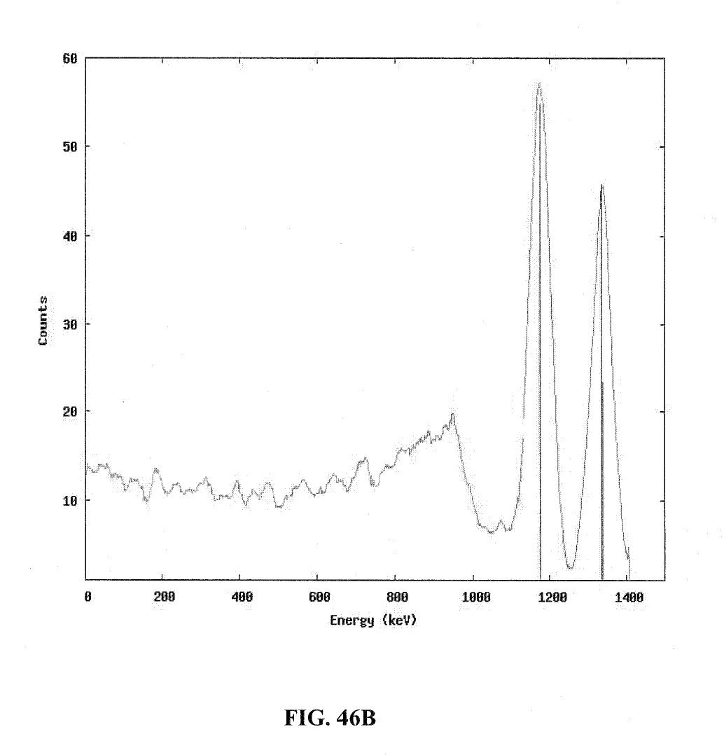

The Co-60 response function, with Poisson noise added, is shown in FIG. 46A, where the response function is simulated in about one minute. The results of denoising, followed by spectral deconvolution, are shown in FIG. 46B. Referring to FIG. 46B, the advanced synthetically enhanced detector resolution algorithm (ASEDRA) results are overlaid on the denoised version of the simulated Co-60 detector response function in FIG. 46A. ASEDRA found both photopeaks at 1176 keV and 1336 keV. ACHIP denoising removed most of the stochastic noise, and ASEDRA correctly identified both of the photopeaks.

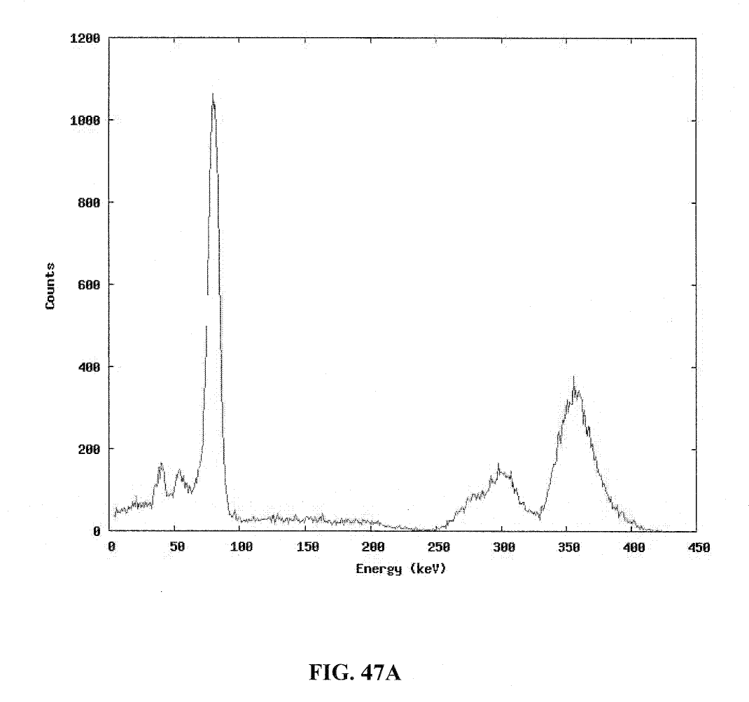

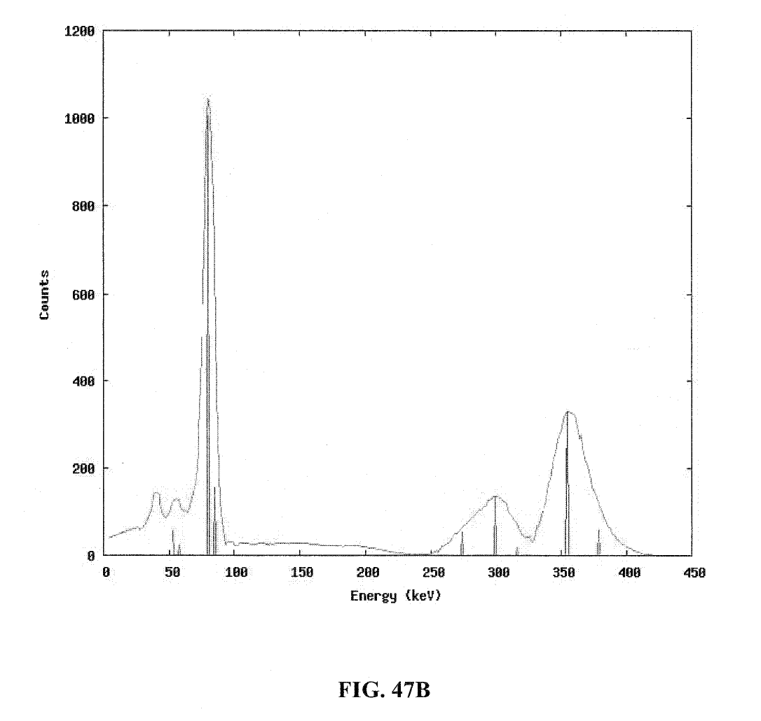

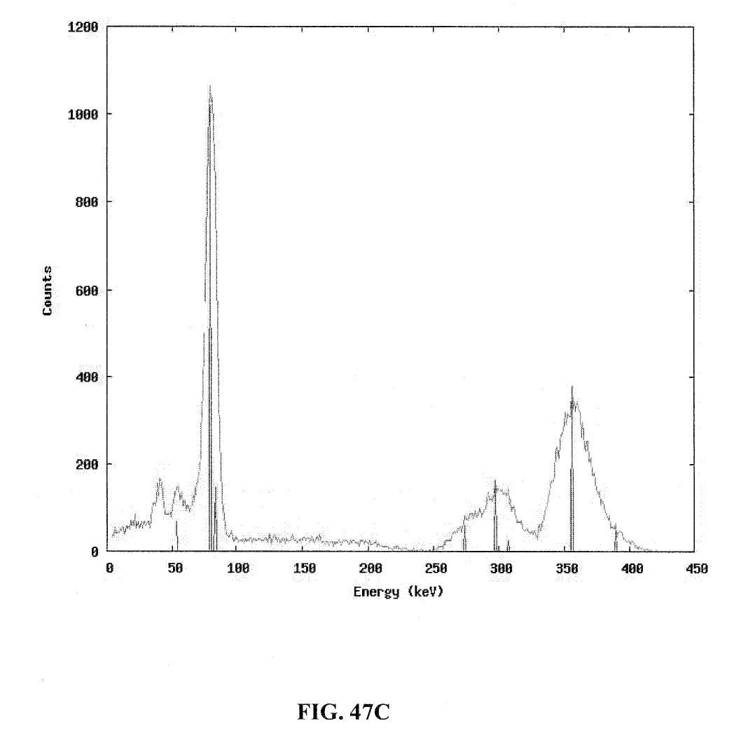

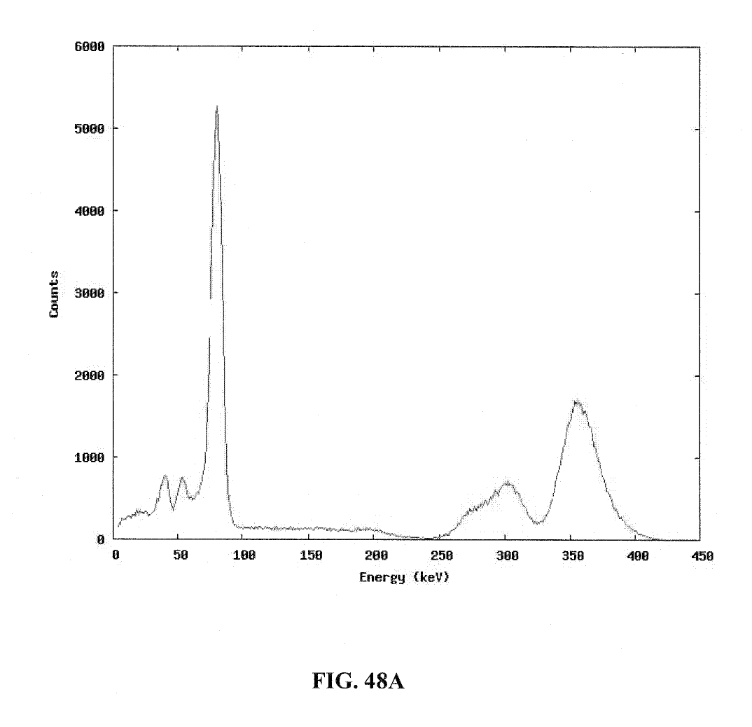

ASEDRA performed well with the noisy Cs-137 and Co-60 spectra, but the Ba-133 spectra is far more difficult. FIG. 47A shows the noisy Ba-133 spectrum with Poisson noise, where the response function was simulated in about one minute, and the stochastic noise makes the overlapping peaks even less distinguishable. FIG. 47B shows that the first two photopeaks at 356 keV and 384 keV are correctly identified. Referring to FIG. 47B, the advanced synthetically enhanced detector resolution algorithm results overlaid on the denoised version of the simulated, one-minute Ba-133 detector response function in FIG. 47A. The next photopeak to be identified is at 303 keV, but its position is incorrectly characterized as 299 keV, leading to a slightly incorrect subtraction of the 303 keV response function. That difference leaves some counts in the remainder at 316 keV, which are incorrectly identified as a photopeak. The results are similar in FIG. 47C, for which denoising was not used. Referring to FIG. 47C, the advanced synthetically enhanced detector resolution algorithm results for the simulated, one-minute Ba-133 detector response function in FIG. 47A are shown. Denoising was not used for these results.

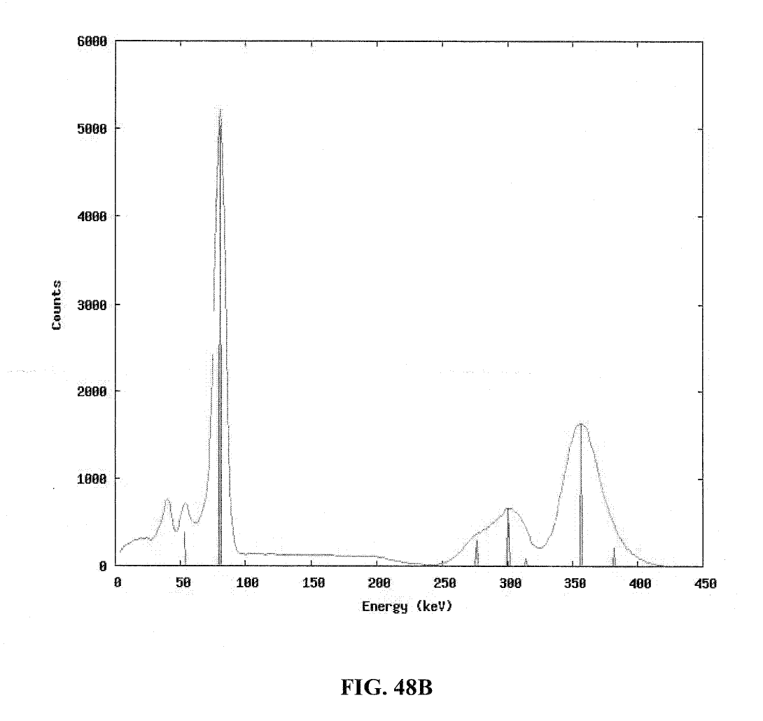

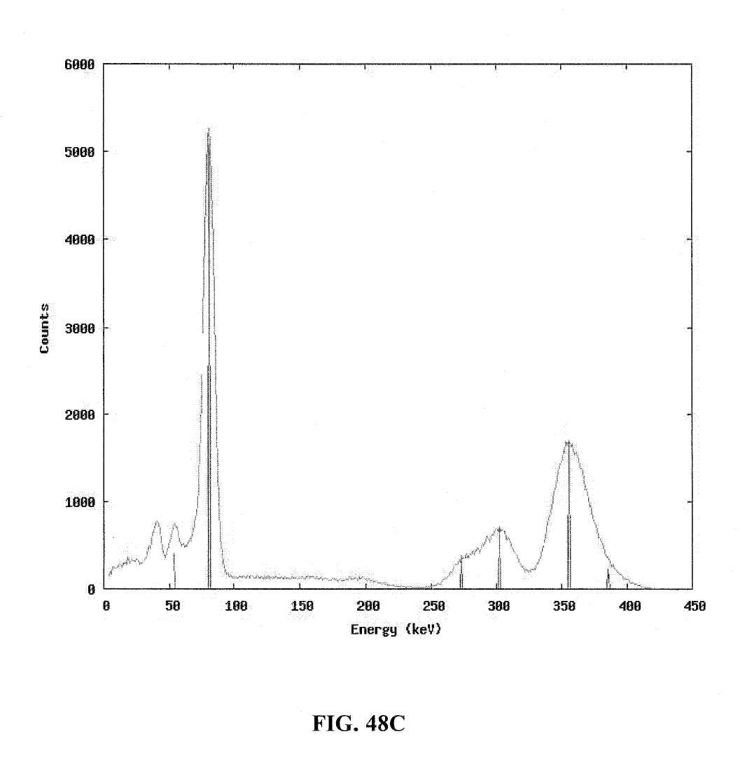

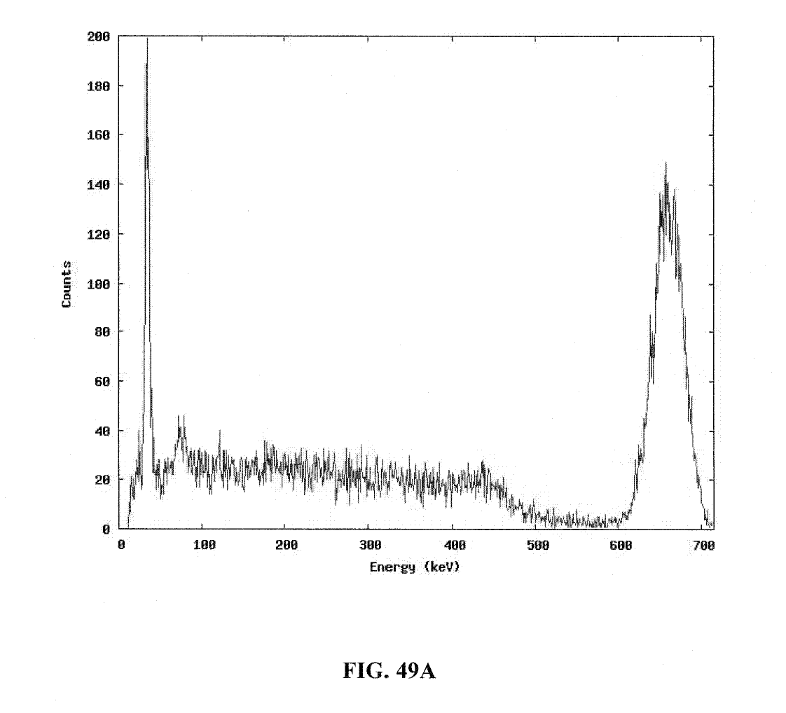

ASEDRA's performance with the five-minute simulated Ba-133 spectrum with Poisson noise is shown in FIG. 48A, which has less stochastic noise.

The ASEDRA results on a five-minute Ba-133 spectrum are similar to the results for a one-minute spectrum, as shown in FIG. 48B. Referring to FIG. 48B, results for an embodiment of the advanced synthetically enhanced detector resolution algorithm are overlaid on the denoised version of the simulated Ba-133 detector response function in FIG. 48A. The results for analyzing the same spectrum without denoising are shown in FIG. 48C. Without denoising, the 303 keV photopeak is correctly characterized, and no false photopeak is identified at 316 keV. In this case, denoising actually makes the situation worse. One explanation is that the photopeaks at 276 keV and 303 keV form a shape that is not well modelled by a set of parabolas. A further embodiment can incorporate a denoising tool that uses higher order polynomials.

### Example 3

Previous examples used idealized examples for demonstrating how the advanced synthetically enhanced detector resolution algorithm (ASEDRA) performs spectral deconvolution. A variety of additional complications arise in real laboratory conditions, such as changes in the background radiation, scattered radiation from nearby objects in the lab, and uncertainty in the energy and full-width half-max (FWHM) calibration curves. This example includes laboratory measurements, with a 5 cm square cylindrical NaI detector, of samples that are similar to the previous examples. Additionally, a plutonium beryllium source is included to show ASEDRA's performance on a highly convoluted detector spectrum.

Energy calibration becomes more significant when real detectors are used. Table 8-1 shows the energy calibration data for this example.

TABLE 8-1
Energy calibration data

| Channel | Energy (keV) |
|---|---|
| 62 | 53.2 |
| 97 | 81.0 |
| 334 | 302.9 |
| 387 | 356.0 |
| 705 | 661.7 |
| 1239 | 1173.2 |
| 1402 | 1332.5 |

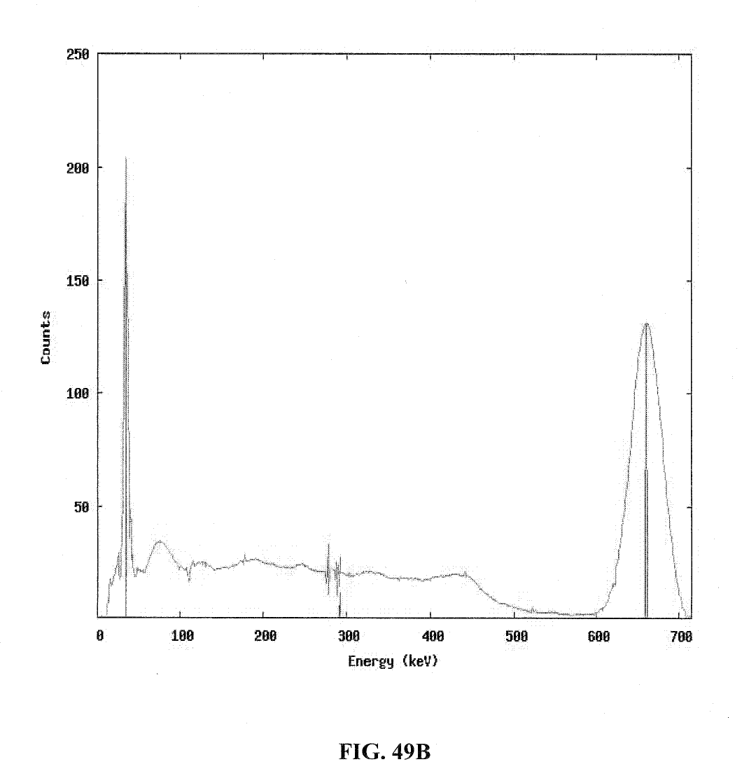

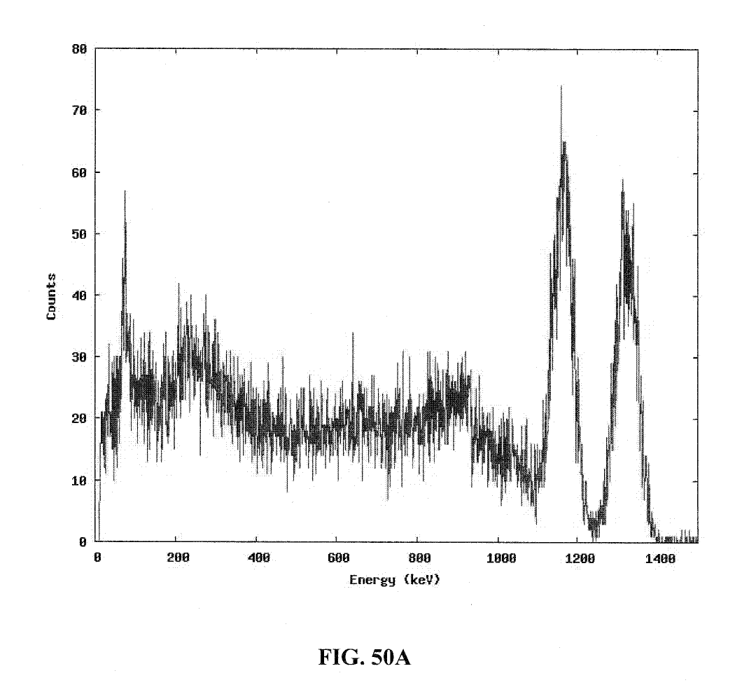

A measured Cs-137 spectrum is shown in FIG. 49A, and the corresponding ASEDRA results are shown in FIG. 49B, which shows advanced synthetically enhanced detector resolution algorithm (ASEDRA) results overlaid on the denoised version of the measured, one-minute Cs-137 detector response function in FIG. 49A. ASEDRA found the only photopeak at 661 keV. The additional peak at 290 keV is only two counts above the rejection threshold and is not real. ASEDRA finds the 662 keV photopeak, as before, but it also finds an additional features at 292 keV. The additional feature at 292 keV has a height of only 12 counts, only two counts above the threshold for rejection.

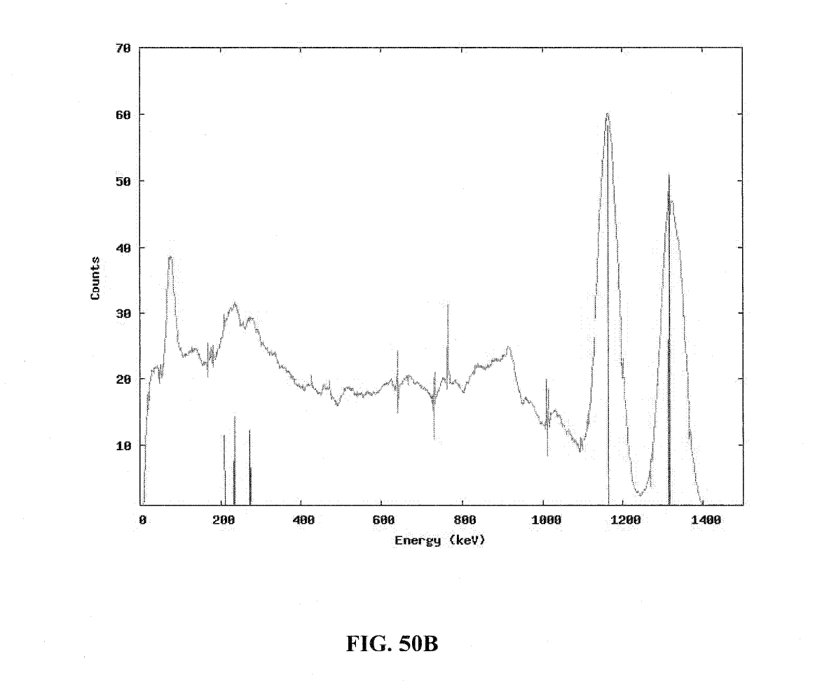

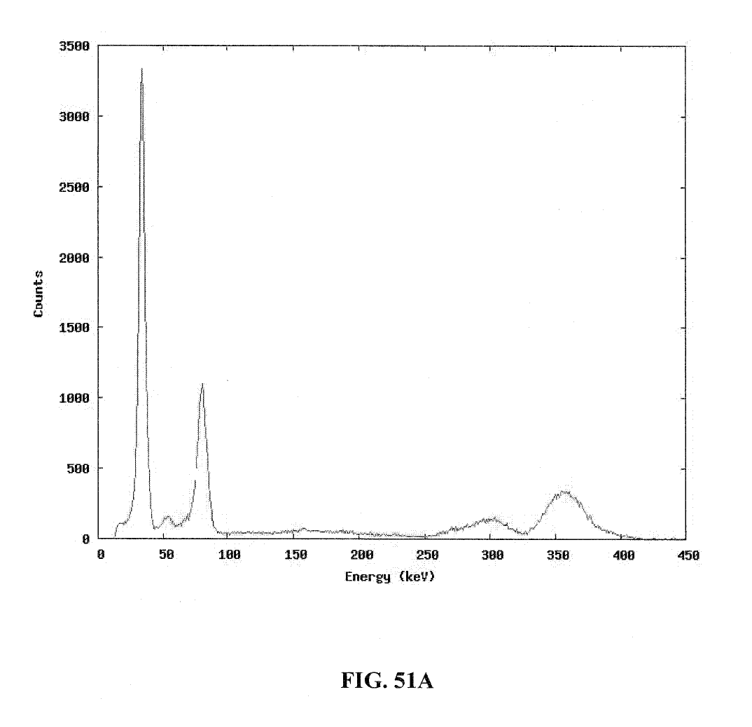

A measured Co-60 spectrum is shown in FIG. 50A. Unlike the simulated spectra in the previous examples, the measured Co-60 spectrum has a broad peak between 200 keV and 350 keV. FIG. 50B shows the advanced synthetically enhanced detector resolution algorithm (ASEDRA) results overlaid on the denoised version of the measured, one-minute Co-60 detector response function in FIG. 50A. ASEDRA found both primary photopeaks at 1176 keV and 1336 keV. The additional three photopeaks between 200 keV and 300 keV are unidentified, but this spectrum clearly contains more features than can be explained by Co-60 alone. The ASEDRA results in FIG. 50B show three features in this region: 208 keV, 233 keV, and 272 keV. These features may be the result of scattering from objects that were not included in the MCNP simulations. Each of these three features has a height of less than 15 counts.

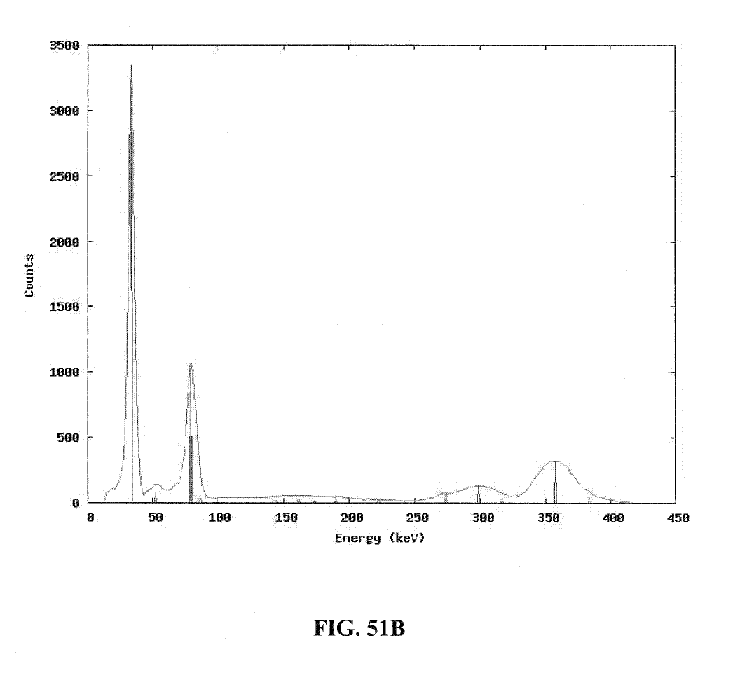

A measured Ba-133 spectrum is shown in FIG. 51A, and the corresponding ASEDRA results are shown in FIG. 51B, where the advanced synthetically enhanced detector resolution algorithm (ASEDRA) results overlaid on the denoised version of the measured, one-minute Ba-133 detector response function in FIG. 51A. ASEDRA correctly extracted the overlapping photopeaks at 356 keV and 384 keV. ASEDRA incorrectly indicated that the 303 keV photopeak was at 298 keV. Incorrect subtraction of the 303 keV photopeak led to a false positive at 316 keV, but the 276 keV photopeak was still correctly identified. ASEDRA incorrectly characterizes the 303 keV photopeak as having a position of 299 keV, as in the previous example, and, consequently, identifies an additional false photopeak at 316 keV. ASEDRA also identifies six very small features between 100 keV and 250 keV. The source of these additional features is not known.

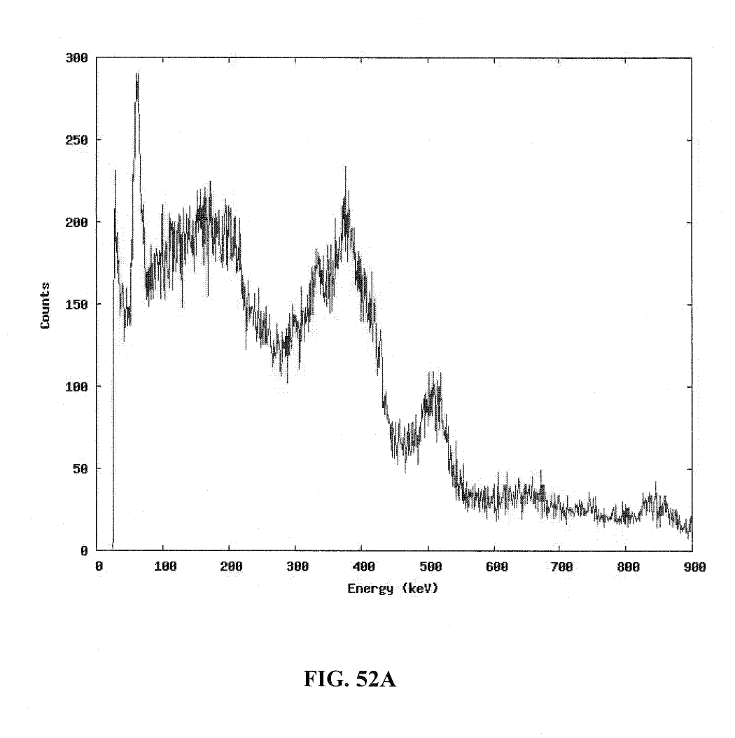

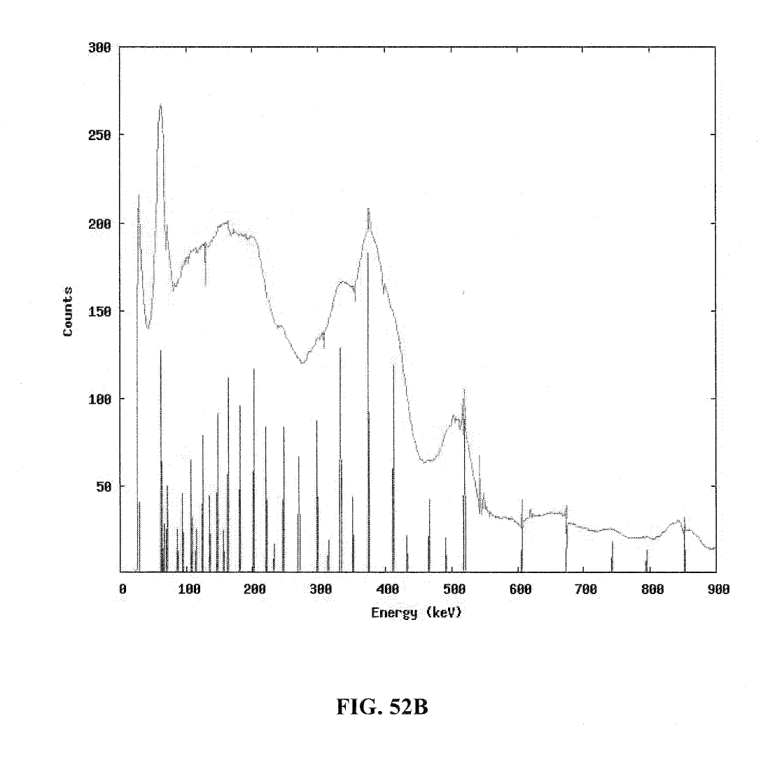

Detector spectra in previous examples came from well known sources to facilitate evaluation of ASEDRA's performance. An additional detector spectrum, using a plutonium beryllium source, is shown in FIG. 52A, and the corresponding ASEDRA results are shown in FIG. 52B, where the advanced synthetically enhanced detector resolution algorithm results overlaid on the denoised version of the measured, one-minute PuBe detector response function in FIG. 52A. The exact composition of the Plutonium Beryllium (PuBe) source and its radiation spectrum are topics of current investigation, so ASEDRA's results are compared with a high-purity Germanium spectrum for the same sample in FIGS. 3A-3B, where the advanced synthetically enhanced detector resolution algorithm results from FIG. 52B are compared with a denoised, higher resolution (Germanium), but uncalibrated spectrum for the same sample. Labels are provided to indicate peaks that appear to match between the two spectra.

Without proper energy calibration for the Germanium detector, it is difficult to determine how closely the ASEDRA results match the Germanium results. However, the similarities shown in FIGS. 3A-3B are very encouraging.

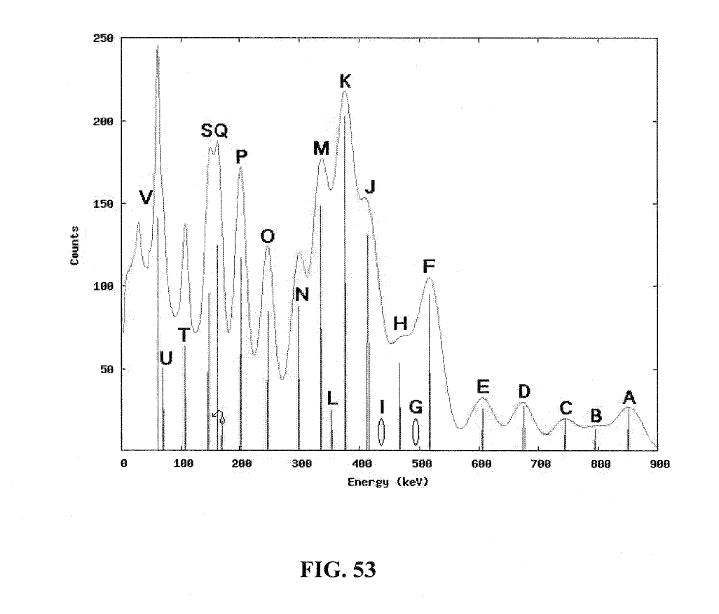

A plutonium beryllium spectrum was simulated that includes only the labeled photopeaks in FIGS. 3A-3B, which match photopeaks in the HPGe detector spectrum. The simulated plutonium beryllium spectrum with no stochastic noise and associated ASEDRA results are shown in FIG. 53, from which two very interesting conclusions can be drawn.

First, the simulated plutonium beryllium spectrum in FIG. 53 has noticeable gaps compared to the measured spectrum in FIGS. 52B and 53. This shows that there are additional photopeaks, not visible in the HPGe spectrum, which have a significant effect on the NaI spectrum. At least some of the extra peaks in FIG. 53, which do not match HPGe peaks, must be real photopeaks that were identified by ASEDRA. This means that ASEDRA can deconvolve photopeaks from a low-resolution NaI detector that are not visible on a high-resolution HPGe detector.

Second, ASEDRA results show very high reliability. In a highly convoluted detector spectrum with twenty-two photopeaks, ASEDRA correctly identified all but three photopeaks with no false positives.

Actual operating conditions (e.g., geometry, Compton effects, and solid angle) will often not precisely match the Monte Carlo simulated geometry originally used for deriving detector response functions. Additional objects, such as a floor or table, may also significantly increase the scattered counts associated with a full energy photopeak. In a specific embodiment, a “scattered counts scale factor” can be used to indicate the degree to which scattered counts in the Monte Carlo-generated detector response functions should be “scaled up” to account for relative changes in the environment. A value of 2, for example, would double the amount of scattered counts, while a value of 1 would have no impact. In an embodiment, this value can be set to −1 for adaptive scaling. Used in conjunction with peak aliasing, use of a scattered counts scale factor can be effective.

A peak aliasing factor can enable a sweeping of the entire synthetic peak output, aliasing peaks that are too close to dominant peaks, so that minor incidental peaks are eliminated and attributed through summation into an adjacent ‘locally dominant’ peak. If set to a positive real value, the peak aliasing factor defines the number of FWHM widths (at a particular energy) considered surrounding above or below prominent peaks. In an embodiment, nominal value for this parameter is ˜0.5. Note this peak aliasing factor can be disabled if using a ‘−1’ setting. The peak aliasing factor can be used to prevent ‘false echos’ of synthetic peaks surrounding a real peak feature. In developmental tests, this peak aliasing factor feature added significant robustness to ASEDRA, since this feature makes the peaks identified more accurate and less sensitive to selection of a ‘precise’ DRF.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

Abelquist, et al., Radiological Surveys for Controlling Release of Solid Material, U.S. Nucl. Reg. Comm. (2002)
Agresti, A., Categorical Data Analysis. Wiley (1990)
Cajipe, V. B., R. Calderwood, M. Clajus, B. Grattan, S. Hayakawa, R. Jayaraman, T. O. Turner and O. Yossifor, “Multi-Energy X-ray Imaging with Linear CZT Pixel Arrays and Integrated Electronics”, 14th Intl. Workshop on Room-Temperature Semiconductor X-Ray and Gamma-Ray Detectors, Rome, Italy, Oct. 18-22, 2004.
Cajipe, V. B., R. Calderwood, M. Clajus, S. Hayakawa, T. O. Turner and S. Yin. “Integrated Readout Electronics Enabling Advanced Applications of Position-Sensitive Solid-State Radiation Detectors”, 14th Intl. Workshop on Room-Temperature Semiconductor X-Ray and Gamma-Ray Detectors, Rome, Italy, Oct. 18-22, 2004.
Cochran, W. 10, 417-451 (1954)
Friedberg et al. Definitions of Length and Euclidean Length. Linear Algebra, 3^{rd} ed. Prentice Hall (1997)
Friedberg et al. Proposition 6.6 and Corollary. Linear Algebra, 3^{rd} ed. Prentice Hall (1997)
Friedberg et al. Theorem 6.4. Linear Algebra, 3^{rd} ed. Prentice Hall (1997)
Gogolak Shebell Coleman Abelquist, Bower and Powers, Radiological Surveys for Controlling Release of Solid Materials, U.S. Nuclear Regulatory Commission, Washington, D.C., July 2002.
Kernan, W., “Self-Activity in Lanthanum Halides”, IEEE Nuclear Science Symposium Conference Record, 2, pp. 1002-1005, 2004.
Kiziah, R. R., and J. R. Lowell, Nucl. Instrum. Meth., pp. 305-1, Vol. 92 (1991)
Knoll, G. F., Radiation Detection and Measurement, 3^{rd} ed., John Wiley and Sons, New York, 2000
LaVigne, E., G. Sjoden, J. Baciak, and R. Detwiler, ASEDRA—Advanced Synthetically Enhanced Detector Resolution Algorithm, a code package for post processing enhancement of detector spectra, FINDS Institute, Nuclear and Radiological Engineering Department, University of Florida, 2007.
LaVigne, E., G. Sjoden, and J. Baciak, “Chi-Square Based Selective Data Smoothing for Detector Spectra,” Radiation Shielding and Protection Division 14^{th} Biennial Topical Meeting, abstract, Carlsbad, N. Mex., pp. 217-218, 2006.
LaVigne, E., G. Sjoden, and J. Baciak, “A Method for Stochastic Noise Reduction by Chi-Squared Analysis,” Transactions of the American Nuclear Society, Vol 95, p. 516-518, November 2006.
Lehner, C. E., H. Zhong, F. Zang, “4p Compton Imaging Using a 3-D Position-Sensitive CdZnTe Detector Via Weighted List-Mode Maximum Likelihood”, IEEE Trans. Nucl. Sci., vol. 51, pp. 1618-1624, 2004.
Likar and Vidmar, “A peak-search method based on spectrum convolution,” Journal of Physics D: Applied Physics, vol. 36, pp. 1903-1909, 2003.
Maestro. Ortec. 801 South Illinois Avenue, Oak Ridge, Tenn. 37830. (2005)
MCNP5: A General Monte Carlo N-Particle Transport Code. Los Alamos National Laboratory. LA-UR-03-1987 (2003)
Meng, L. J., and D. Ramsden, “An inter-comparison of three spectral deconvolution algorithms for gamma ray spectroscopy,” IEEE Transactions on Nuclear Science, vol. 47, no. 4, Aug. 2000.
Milbrath, B., et al., “Characterization of Alpha Contamination in Lanthanum Trichloride Scintillators using Coincidence Measurements”, Nuclear Instruments and Methods in Physics Research A., A547 (2005) p504.
Mitchell, D. J., Sodium Iodide Detector Analysis Software (SIDAS), Sandia National Laboratory, Albuquerque, N. Mex., June 1986.
Ortec, 801 South Illinois Avenue, Oak Ridge, Tennessee 37830.
Saint Gobain Detectors B380 Product Data Sheet http://www.detectors.saint-gobain.com
United States Department of Homeland Security, “Success of radiation portal monitor program remains undiminished,” U.S. Customs and Border Protection Today, vol. 4, no. 5, May 2006.
Wackerly et al. Mathematical Statistics with Applications, 5^{th} ed. Wadsworth Publishing Company. 732-733 (1996)

1. A method of processing a detector spectrum, comprising:
a. identifying a photopeak in a detector spectrum;
b. subtracting a detector response function corresponding to the identified photopeak from the detector spectrum, wherein subtracting the detector response function corresponding to the identified photopeak from the detector spectrum produces a remainder detector spectrum.

2. The method according to claim 1, wherein the detector spectrum is a measured detector spectrum minus a background spectrum, wherein prior to identifying the photopeak, further comprising:
c. denoising the background spectrum.

3. The method according to claim 2, wherein prior to identifying the photopeak, further comprising:
d. denoising the measured detector spectrum.

4. The method according to claim 1, wherein identifying the photopeak comprises sweeping the detector spectrum to identify the photopeak in the detector spectrum.

5. The method according to claim 1, further comprising:
e. repeating a and b on the remainder detector spectrum.

6. The method according to claim 5, further comprising:
f. repeating e until no valid photopeak is identified.

7. The method according to claim 1, wherein prior to identifying the photopeak, further comprising:
d. denoising the detector spectrum.

8. The method according to claim 7, further comprising:
e. repeating a and b on the remainder detector spectrum.

9. The method according to claim 8, further comprising:
f. repeating e until no valid photopeak is identified.

10. The method according to claim 4, wherein sweeping the detector spectrum comprises sweeping the detector spectrum from high energies to low energies.

11. The method according to claim 4, wherein sweeping the detector spectrum comprises sweeping the detector spectrum from low energies to high energies.

12. The method according to claim 10, wherein prior to sweeping the detector spectrum from high energies to low energies, further comprising accounting for low energy tailing.

13. The method according to claim 7, wherein denoising the background of the detector spectrum and denoising the detector spectrum comprises:
denoising the detector spectrum via an adaptive chi-square technique.

14. The method according to claim 1, wherein the detector spectrum is a NaI detector spectrum.

15. The method according to claim 1, wherein the detector spectrum is a LaBr₃(Ce) detector spectrum.

16. The method according to claim 1, wherein the detector spectrum is a CsI detector spectrum.

17. The method according to claim 1, wherein the detector spectrum is a semiconductor generated detector spectrum.

18. The method according to claim 1, wherein the detector spectrum is a scintillation detector spectrum.

19. The method according to claim 1, wherein the detector spectrum is a radiation detector spectrum.

20. The method according to claim 1, wherein identifying a photopeak comprises recognizing a local maxima in the detector spectrum.

21. The method according to claim 1, wherein the detector response functions are estimated for the identified photopeak via a radiation transport simulation.

22. The method according to claim 21, wherein the radiation transport simulation is a Monte Carlo simulation.

23. The method according to claim 13, wherein a chi-squared analysis is performed on each of a plurality of regions of the detector spectrum to produce a chi-squared value, X², for each region, where a value of X² below a threshold indicates a region dominated by noise, wherein denoising of the detector spectrum comprises denoising the regions having a X² value below the threshold.

24. The method according to claim 23, wherein denoising the regions having a X² value below the threshold comprises fitting spectrum data to a least squares fit of at least a second order.

25. The method according to claim 24, wherein the least squares fit of at least a second order is a parabolic least squares fit.

26. The method according to claim 24, wherein fitting to the least squares fit uses an adaptive number of surrounding channel data.

27. The method according to claim 26, wherein the adaptive number of surrounding channel data is the largest number of surrounding channel data that meets a constraint that the least squares fit of the data is satisfied according to the chi-squared analysis.

28. The method according to claim 1, wherein the detector response function corresponding to the identified photopeak is created by:
determining how much energy is deposited in each of plurality of channels in the detector by each of a plurality of monoenergetic photon sources interacting with the detector to generate a set of detector response functions for the detector; and
estimating the detector response function by interpolating between the set of detector response functions.

29. The method according to claim 1, further comprising:
correlating the identified photopeak with a corresponding gamma-ray source.

30. The method according to claim 1, further comprising:
correlating the identified photopeak with a corresponding nuclide.

31. A method of generating a set of detector response functions for a detector, comprising:
determining how much energy is deposited in each of a plurality of channels in the detector by each of a plurality of monoenergetic photon sources interacting with the detector; and
generating a set of detector response functions based on how much energy is deposited in each of the plurality of channels.

32. The method according to claim 31, wherein the set of detector response functions is for a radiation detector.

33. The method according to claim 31, wherein the set of detector response functions is for a gamma-ray detector.

34. The method according to claim 31, wherein at least one of the plurality of photon sources is a radioactive isotope.

35. The method according to claim 31, wherein determining how much energy is deposited in each of a plurality of channels in the detector comprises determining pulse height tallies for each channel via a simulation program.

36. The method according to claim 35, wherein the Monte Carlo simulation program is the Monte Carlo N-particle (MCNP) Transport radiation simulation program.

37. The method according to claim 31, further comprising estimating detector response functions for energies between the plurality of energies by interpolation.

38. The method of claim 1, further comprising receiving the detector spectrum from a detector.

39. The method of claim 38, wherein the detector is a gamma-ray detector.

40. The method of claim 38, wherein the detector is a scintillation detector.

41. The method of claim 38, wherein the detector is a room temperature detector.

42. The method of claim 14, further comprising presenting the identified photopeak.

43. The method of claim 16, further comprising presenting the identified photopeak.

44. The method of claim 18, further comprising presenting the identified photopeak.

45. The method of claim 42, wherein the identified photopeak is presented to a nuclide identification tool.

46. The method of claim 6, wherein the identified photopeaks are presented to a nuclide identification tool.

47. A system for nuclear monitoring, comprising:
a spectral post-processing tool, wherein the spectral post-processing tool:
a. identifies a photopeak in a detector spectrum; and
b. subtracts a detector response function corresponding to the identified photopeak from the detector spectrum, wherein subtracting the detector response function corresponding to the identified photopeak from the detector spectrum produces a remainder detector spectrum.

48. The system of claim 47, wherein the spectral post-processing tool receives the detector spectrum from a detector, wherein the detector receives radiation and creates the detector spectrum therefrom.

49. The system of claim 48, further comprising a nuclide identification tool, wherein the nuclide identification tool correlates a nuclide with the identified photopeak.

50. The system of claim 48, wherein the spectral post-processing tool repeats a and b on the remainder spectrum at least one time to:
identify a corresponding at least one additional identified photopeak; and
update the remainder spectrum,
such that the spectral post-processing tool recursively identifies a set of identified photopeaks comprising the identified photopeak and each of the at least one additional identified photopeak.

51. The system of claim 50, wherein the spectral post-processing tool denoises the detector spectrum before identifying the photopeak in the detector spectrum.

52. The system of claim 50, further comprising:
one or more chips having code embodied thereon for performing the functions of the spectral post-processing tool; and
one or more communicably connected computers configured to execute the code on the one or more chips, wherein the detector is communicably connected to at least one of the one or more communicably connected computers.

53. The system of claim 50, further comprising the detector, wherein the spectral post-processing tool is incorporated into the detector.

54. The system of claim 50, further comprising a nuclide identification tool, wherein the nuclide identification tool generates a set of one or more nuclides, wherein each of the set of one or more nuclides correlates to one or more of the set of identified photopeaks.

55. The system of claim 54, further comprising:
one or more chips having code embodied thereon for performing the functions of the spectral post-processing tool and the nuclide identification tool; and
one or more communicably connected computers configured to execute the code on the one or more chips, wherein the detector is communicably connected to at least one of the one or more communicably connected computers.

56. The system of claim 54, further comprising the detector, wherein the spectral post-processing tool and the nuclide identification tool are incorporated into the detector.

57. The system of claims 54, further comprising an output interface wherein the output interface, presents information regarding the set of one or more nuclides.

58. The system of claims 54, wherein the spectral post-processing tool repeats a and b on the remainder spectrum until no valid photopeak is identified.
